(19) United States
(12) Patent Application Publication
(10) Pub. No.: US 2011/0081018 A1
(43) Pub. Date: Apr. 7, 2011

(54) Obfuscating reception of communiqué affiliated with a source entity

(75) Inventors: Alexander J. Cohen, Mill Valley, CA (US); Edward K.Y. Jung, Bellevue, WA (US); Royce A. Levien, Lexington, MA (US); Robert W. Lord, Seattle, WA (US); Mark A. Malamud, Seattle, WA (US); William H. Mangione-Smith, Kirkland, WA (US); John D. Rinaldo, JR., Bellevue, WA (US); Clarence T. Tegreene, Bellevue, WA (US)

(73) Assignee: Searete LLC, a limited liability corporation of the State of Delaware

(21) Appl. No.: 12/804,765

(22) Filed: Jul. 27, 2010

Related U.S. Application Data
(63) Continuation-in-part of application No. 12/228,664, filed on Aug. 14, 2008.
Application No. 12/228,664 is a continuation-in-part of application No. 12/228,873, filed on Aug. 15, 2008.
Application No. 12/228,873 is a continuation-in-part of application No. 12/287,268, filed on Oct. 7, 2008.
Application No. 12/287,268 is a continuation-in-part of application No. 12/454,113, filed on May 12, 2009.
Application No. 12/454,113 is a continuation-in-part of application No. 12/799,794, filed on Apr. 29, 2010.
Application No. 12/799,794 is a continuation-in-part of application No. 12/802,139, filed on May 27, 2010.
Application No. 12/802,139 is a continuation-in-part of application No. 12/802,136, filed on May 28, 2010.
Application No. 12/802,136 is a continuation-in-part of application No. 12/802,863, filed on Jun. 14, 2010.
Application No. 12/802,863 is a continuation-in-part of application No. 12/802,922, filed on Jun. 15, 2010.

(51) Int. Cl. H04L 9/00

(52) U.S. Cl. 380/255

(57) ABSTRACT

A computationally implemented method includes, but is not limited to: receiving a communiqué that is affiliated with a source entity and that is directed to a receiving user; and presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity. In addition to the foregoing, other method aspects are described in the claims, drawings, and text forming a part of the present disclosure.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/228,664, entitled SYSTEM AND METHOD FOR TRANSMITTING ILLUSORY IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Aug. 14, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/228,873, entitled SYSTEM AND METHOD FOR TRANSMITTING ILLUSORY AND NON-ILLUSORY IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Aug. 15, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/287,268, entitled SYSTEM AND METHOD FOR TRANSMITTING ILLUSORY IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Oct. 7, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/454,113, entitled SYSTEM AND METHOD FOR MODIFYING ILLUSORY USER IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed May 12, 2009, which is currently co pending, or is an application of which a currently co-pending application is entitled to the benefit of the filing date.

For purposes of the USPTO extra-statutory requirements, the present application constitutes a continuation-in-part of U.S. patent application Ser. No. 12/799,794, entitled SYSTEM AND METHOD FOR CONDITIONALLY TRANSMITTING ONE OR MORE LOCUM TENENTES, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Apr. 29, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,139, entitled OBFUSCATING IDENTITY OF A SOURCE ENTITY AFFILIATED WITH A COMMUNIQUÉ IN ACCORDANCE WITH CONDITIONAL DIRECTIVE PROVIDED BY A RECEIVING ENTITY, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed May 27, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,136, entitled OBFUSCATING IDENTITY OF A SOURCE ENTITY AFFILIATED WITH A COMMUNIQUÉ IN ACCORDANCE WITH CONDITIONAL DIRECTIVE PROVIDED BY A RECEIVING ENTITY, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed May 28, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,863, entitled OBFUSCATING IDENTITY OF A SOURCE ENTITY AFFILIATED WITH A COMMUNIQUÉ DIRECTED TO A RECEIVING USER AND IN ACCORDANCE WITH CONDITIONAL DIRECTIVE PROVIDED BY THE RECEIVING USER, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Jun. 14, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,922, entitled OBFUSCATING IDENTITY OF A SOURCE ENTITY AFFILIATED WITH A COMMUNIQUÉ DIRECTED TO A RECEIVING USER AND IN ACCORDANCE WITH CONDITIONAL DIRECTIVE PROVIDED BY THE RECEIVING USER, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Jun. 15, 2010, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

### SUMMARY

A computationally implemented method includes, but is not limited to receiving a communiqué that is affiliated with a source entity and that is directed to a receiving user; and presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A computationally implemented system includes, but is not limited to: means for receiving a communiqué that is affiliated with a source entity and that is directed to a receiving user; and means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity. In addition to the foregoing, other system aspects are described in the claims, drawings, and text forming a part of the present disclosure.

A computationally implemented system includes, but is not limited to: circuitry for receiving a communiqué that is affiliated with a source entity and that is directed to a receiving user; and circuitry for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity. In addition to the foregoing, other system aspects are described in the claims, drawings, and text forming a part of the present disclosure.

A computer program product including a signal-bearing medium bearing one or more instructions for receiving a communiqué that is affiliated with a source entity and that is directed to a receiving user; and one or more instructions for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity. In addition to the foregoing, other computer program product aspects are described in the claims, drawings, and text forming a part of the present disclosure.

A method for obfuscating reception of a communiqué that is affiliated with a particular source entity and that is directed to a receiving user, the obfuscation of the reception of the communiqué being in accordance with one or more conditional directives of the receiving user, the method includes receiving a communiqué that is affiliated with a source entity and that is directed to a receiving user; and presenting, using one or more processors, a covert indicator that covertly indicates reception of the communiqué, the presenting of the covert indicator being in accordance with one or more conditional directives of the receiving user to conditionally obfuscate the reception of the communiqué affiliated with the source entity, the presenting of the covert indicator being in lieu of presenting indication of the reception of the communiqué.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1a and 1b show a high-level block diagram of a receiving device 10 operating in a network environment.

FIG. 2a shows another perspective of the communiqué receiving module 102 of the receiving device 10 of FIGS. 1a and 1b.

FIGS. 2b and 2c show another perspective of the covert indicator presenting module 104 of the receiving device 10 of FIGS. 1a and 1b.

FIG. 2d shows another perspective of the conditional directive receiving module 106 of the receiving device 10 of FIGS. 1a and 1b.

FIG. 2e shows another perspective of the communiqué presenting module 110 of the receiving device 10 of FIGS. 1a and 1b.

FIG. 2f shows another perspective of the memory 140 of the receiving device 10 of FIGS. 1a and 1b.

FIG. 3 is a high-level logic flowchart of a process.

FIG. 4a is a high-level logic flowchart of a process depicting alternate implementations of the communiqué receiving operation 302 of FIG. 3.

FIG. 4b is a high-level logic flowchart of a process depicting alternate implementations of the communiqué receiving operation 302 of FIG. 3.

FIG. 4c is a high-level logic flowchart of a process depicting alternate implementations of the communiqué receiving operation 302 of FIG. 3.

FIG. 4d is a high-level logic flowchart of a process depicting alternate implementations of the communiqué receiving operation 302 of FIG. 3.

FIG. 4e is a high-level logic flowchart of a process depicting alternate implementations of the communiqué receiving operation 302 of FIG. 3.

FIG. 5a is a high-level logic flowchart of a process depicting alternate implementations of the covert indicator presenting operation 304 of FIG. 3.

FIG. 5b is a high-level logic flowchart of a process depicting alternate implementations of the covert indicator presenting operation 304 of FIG. 3.

FIG. 5c is a high-level logic flowchart of a process depicting alternate implementations of the covert indicator presenting operation 304 of FIG. 3.

FIG. 5d is a high-level logic flowchart of a process depicting alternate implementations of the covert indicator presenting operation 304 of FIG. 3.

FIG. 5e is a high-level logic flowchart of a process depicting alternate implementations of the covert indicator presenting operation 304 of FIG. 3.

FIG. 5f is a high-level logic flowchart of a process depicting alternate implementations of the covert indicator presenting operation 304 of FIG. 3.

FIG. 5g is a high-level logic flowchart of a process depicting alternate implementations of the covert indicator presenting operation 304 of FIG. 3.

FIG. 5h is a high-level logic flowchart of a process depicting alternate implementations of the covert indicator presenting operation 304 of FIG. 3.

FIG. 5i is a high-level logic flowchart of a process depicting alternate implementations of the covert indicator presenting operation 304 of FIG. 3.

FIG. 5j is a high-level logic flowchart of a process depicting alternate implementations of the covert indicator presenting operation 304 of FIG. 3.

FIG. 6 is another high-level logic flowchart of another process.

FIG. 7 is a high-level logic flowchart of a process depicting alternate implementations of the communiqué presenting operation 674 of FIG. 6.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In recent years, the computing/communication industry has enjoyed dramatic technological advancement and spectacular commercial popularity, providing numerous benefits for those who choose to enjoy the fruits of technological developments in the computing/communication sectors. For example, with the rapid development of personal communication devices such as cellular telephones, personal digital assistants (PDAs), Smartphones, laptop computers, desktop computers, and so forth, users of such devices are now able to maintain 24/7 connectivity with other users at relatively low costs. Such connectivity may be via a variety of communication channels including, for example, telephone calls, emails, Voice over Internet Protocol (VoIP) calls, text messaging (e.g., short message service or SMS, or multimedia messaging service or MMS), instant messaging (IM), and so forth. Unfortunately, in addition to providing significant benefits to users, users of such technologies must also deal with a whole new slate of issues and problems that have also arisen with these new technologies.

For example, users of such personal communication devices (e.g., cellular telephones, Smartphones, laptop and desktop computers, and so forth) face a number of privacy and security issues. One such issue that has surfaced with respect to users of personal communication devices is that communiqués (e.g., electronic communications including, for example, telephone calls, VoIP, emails, text messages, IMs, and so forth) received through these personal communication devices are often easily accessible by those other than the primary users (e.g., owners) of such devices. As a result, highly sensitive communiqués (e.g., confidential personal or business communiqués) that are directed to the primary users of such devices may often be accessed by others potentially causing embarrassing if not devastating consequences.

For example, it was extensively reported recently that a well-known and well-admired professional athlete was discovered having an extramarital affair by his spouse. It was widely reported that the spouse discovered this affair when she found a voice message from her husband's mistress on her husband's cellular telephone. Because the husband (i.e., famous professional athlete) in that incident had not erased or was not able to hide or disguise the voice message from his mistress, the husband had to endure significant public humiliation and substantial financial loss due to loss of commercial endorsement income.

Of course the need for maintaining communication or communiqué secrecy is not just limited to personal situations, but may also be necessary in professional/business context. For example, it may be inappropriate for a person to receive certain sensitive communiqués from particular parties (e.g., communiqués from certain clients or competitors, or communiqués from a particular website or business) while at work or while at other locations (e.g., when meeting with clients).

According to various embodiments, methods, systems, and computer program products are provided for obfuscating reception of a communiqué that is affiliated with a particular source user and that is directed to a receiving user, the reception of the communiqué being based on one or more conditional directives provided by the receiving user. More particularly, the methods, systems, and computer program products may be designed to receive a communiqué that is affiliated with a particular source entity and that is directed to a particular receiving user; and to present, in lieu of presenting any indication of reception of the communiqué, a covert indicator that covertly indicates reception of the communiqué, the presenting of the covert indicator being in accordance with one or more conditional directives of the receiving user to.

For purposes of the following description, a “communiqué” may be in reference to any one of a variety of electronic communication means including, for example, a telephone call, an email message, a text message (e.g., short message service “SMS” or multimedia messaging service “MMS”), an instant message (IM), a Voice over Internet Protocol (VoIP) call, a voice message, a video message, and so forth. In some embodiments, a “communiqué” as described herein, is in reference to any type of communiqué related to “push” technology (in which the communiqué is pushed to the end user device rather than being stored on the network) rather than pull technology (e.g., such as in the case of certain types of email services that may store emails at a server or a network cloud).

As will be further described herein, a “source entity” may be in reference to any entity that may be the original or an intermediate source for a communiqué. In some cases, a source entity may include, for example, a source user who may be a human or robotic user and/or a source user device such as a cellular telephone, Smartphone, laptop or desktop computer, and so forth. In some cases, a source entity may be an organization such as a business or a trade or interest group. In some instances, a source entity may be a website.

A “receiving user” may be a human or robotic user that is designated to receive one or more communiqués. In some cases where the receiving user is a robotic user, the robotic user may be a network device such as a network server for, for example, a voicemail service, a text messaging service, or a web-based application service. In some cases, a receiving user may receive one or more communiqués through a “receiving device.” A receiving device may be any type of computing/communication device including, for example, a cellular telephone, a Smartphone, a personal digital assistant (PDA), a landline telephone, a laptop or desktop computer, a tablet computer, a workstation, and so forth.

A “conditional directive,” as will be discussed herein, relates to a command or instruction to execute one or more actions when one or more conditions have occurred and/or detected. Thus, for purposes of this description, a conditional directive may identify the one or more actions that are to be executed in order to achieve a particular result (e.g., obfuscate reception of a communiqué affiliated with a particular source entity) and/or identify the necessary (e.g., requisite) conditions that may trigger the one or more actions to be executed. For example, a conditional directive may be a command to intercept (e.g., seize) a communiqué when it is determined that the communiqué is affiliated with a particular source entity and is directed to a particular receiving user and to present, in lieu of presenting any indication of reception of the communiqué, a covert indicator that covertly (e.g., indirectly) indicates the reception of the communiqué.

A “covert indicator,” as will be described herein, may be in reference to any indicator that may covertly or indirectly indicate reception of a communiqué that is affiliated with a particular source entity and that is directed to a particular receiving user. Such a covert indicator may only alert certain entities, such as the receiving user who the communiqué is directed to and who may have actually provided the covert indicator itself through conditional directives, as to the reception of the communiqué that is affiliated with the particular source entity. From another perspective, a covert indicator may not, at least, directly indicate the reception of the communiqué that it is covertly indicating, the communiqué itself, the source entity affiliated with received communiqué, the relationship between the source entity and the received communiqué, and/or any other aspect of the communiqué and/or the source entity that would alert a third party regarding the reception of the communiqué, the particular source entity affiliated with the communiqué, and/or the relationship between the communiqué and the particular source entity. As will be further described herein, a covert indicator may come in a variety of forms. For example, depending on the particular circumstances (e.g., type of receiving device presenting the overt indicator as well as the type of communiqué being covertly indicated), a covert indicator may be a covert audio indicator, a covert visual indicator, a covert vibrating indicator, or any combination thereof.

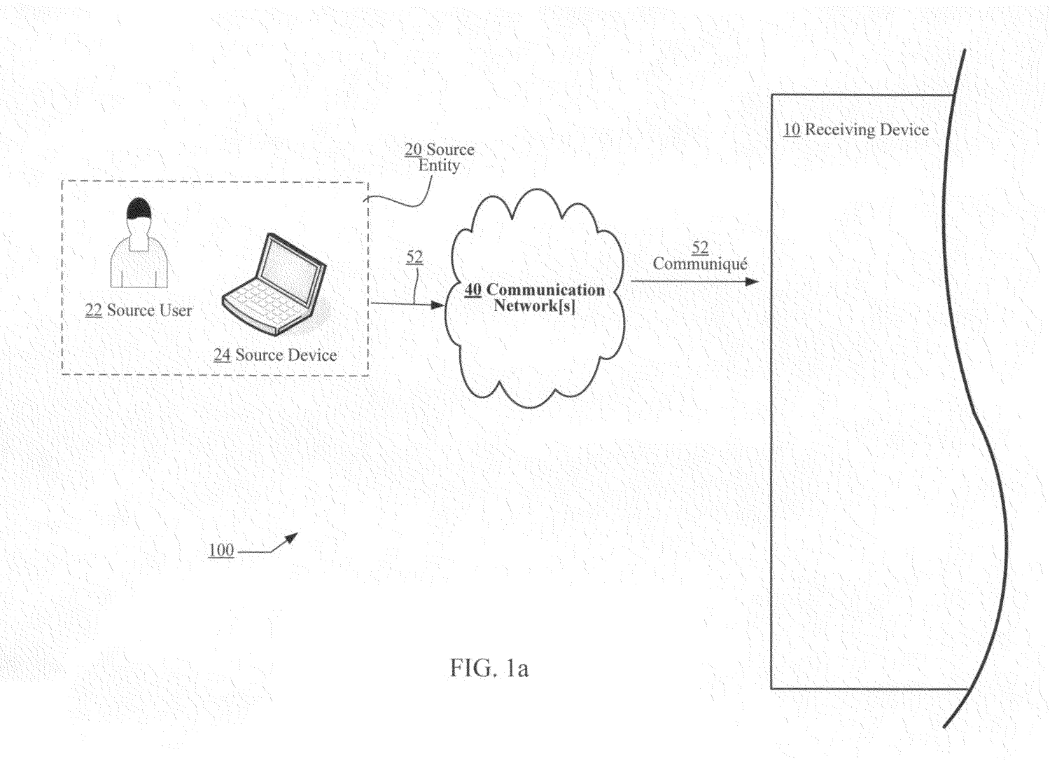

Turning now to FIGS. 1a, and 1b illustrating an example environment 100 in which the methods, systems, circuitry, and computer program products in accordance with various embodiments may be implemented by a receiving device 10. Among other things, the methods, systems, circuitry, and computer program products implemented by the receiving device 10 may be designed to receive one or more conditional directives 50 from a receiving user 32, the one or more conditional directives 50 delineating (e.g., indicating or defining) one or more conditions for obfuscating reception of a communiqué 52 that is affiliated with a particular source entity 20 and that is directed to the receiving user 32. In some embodiments, the one or more conditional directives 50 may also define how the reception of the communiqué 52 may be obfuscated from one or more third parties while still covertly indicating the reception of the communiqué 52 to particular entities such as the receiving user 32.

In particular, the methods, systems, circuitry, and computer program products, when implemented by the receiving device 10, may be particularly designed to obfuscate the reception of a communiqué 52 that is determined to be affiliated with a particular source entity 20 and directed to a particular receiving user 32 by at least presenting, in lieu of presenting indication of reception of the communiqué 52, a covert indicator 54 that covertly indicates reception of the communiqué 52, the presenting of the covert indicator 54 being in accordance with the one or more conditional directives 50 of the receiving user 32. In some cases, the methods, systems, circuitry, and computer program products, when implemented by the receiving device 10, may be further designed to store the communiqué 52 and upon detecting occurrence of one or more triggering events presenting the communiqué 52 in accordance with the one or more conditional directives 50.

The receiving device 10 implementing the methods, systems, circuitry, and computer program products may be a computing/communication device capable of receiving/transmitting electronic communiqués (e.g., emails, text messages, instant messages (IM), telephone calls, Voice over Internet Protocol (VoIP), voice messages, video messages or calls, and so forth. In some embodiments, the receiving device 10 may be, for example, a cellular telephone, a Smartphone, a personal digital assistant (PDA), a landline telephone, a laptop or desktop computer, a tablet computer, a workstation, and so forth. The receiving device 10 may be designed to communicate via one or more communication networks 40. The one or more communication networks 40 may include one or more of a local area network (LAN), metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, a Client/Server network, a virtual private network (VPN), and so forth.

When a conventional computing/communication device (e.g., a cellular telephone, a Smartphone, a laptop, etc.) receives a communiqué 52, an indication that indicates the reception of the communiqué 52 is typically initially presented to the device user via a user interface 120. There are at least three conventional ways to indicate whether a particular communiqué 52 has been received depending upon the type of communiqué 52 (e.g., telephone call, email, IM, etc.) is being received and/or the type of computing/communication device (e.g., a cellular telephone, a Smartphone, a laptop computer, etc.) is receiving the communiqué 52. For example, in some cases, such as in the case where the received communiqué 52 is an instant message (IM), the presentation of the received communiqué 52 itself becomes the indication (i.e., indication of reception of the communiqué 52) by being directly presented (e.g., the IM is displayed through a display monitor). In other cases, such as in the case where the received communiqué 52 is an email, the reception of the received communiqué 52 may be indicated by a listing of the received communiqué 52 on, for example, a list of received emails. Such a listing will typically indicate certain basic information (e.g., sender identifier, date/time received, subject heading, etc.) related to the received communiqué 52 without fully revealing the entire message content of the communiqué 52. In still other cases, where the received communiqué 52 is an incoming telephone call, and the computing/communication device is a cellular telephone or a Smartphone, the indication that a communiqué 52 has been received will typically be in the form of a ring, a vibration, and/or textual/symbolic display that is displayed on a display screen.

Thus, in order to obfuscate the reception of a communiqué 52 that is affiliated with a particular source entity 20 and that is directed to a particular receiving user 32, the methods, systems, circuitry, and computer program products, in accordance with various embodiments, may be designed to present, in lieu of presenting any indication of reception of the communiqué 52, a covert indicator 54 that covertly indicates reception of the communiqué 52, the presenting of the covert indicator 54 being in accordance with one or more conditional directives 50 of the receiving user 32 to conditionally obfuscate the reception of the communiqué 52 determined to be affiliated with the source entity 20. For these embodiments, the covert indicator 54 that may be presented may covertly indicate the reception of the communiqué 52 to only particular entities such as, for example, the receiving user 32 or other parties that the receiving user 32 may have confided in regarding the meaning of the covert indicator 54.

In various embodiments, the covert indicator 54 that may be presented may not at least directly indicate the reception of the communiqué 52, the communiqué 52 itself, the subject heading of the communiqué 52 (if there is such a heading such as in the case of an email), any representation (e.g., identifier, name, telephone number, email address, image, and so forth) associated with a source entity 20 that is affiliated with the communiqué 52, or other aspects of the communiqué 52 or the source entity 20 that may be used by a third party to surmise the reception of the communiqué 52, the identity of the source entity 20, and/or the relationship between the communiqué 52 and the source entity 20. As will be further described herein, a variety of covert indicators 54 may be presented in order to covertly indicate the reception of the communiqué 52. In some embodiments, for example, the covert indicator 54 may be a covert audio indicator that may be audioally presented while in other embodiments, the covert indicator 54 may be a covert display or visual indicator that may be visually presented. In still other embodiments, the covert indicator 54 may be a covert vibration indicator that may be generated. In still other embodiments, the covert indicator 54 that is presented may be any combination of a covert audio indicator, a covert visual indicator, and/or a covert vibration indicator.

Referring back to FIGS. 1a and 1b, and as briefly described above, a receiving user 32 may be a human user or robotic user (e.g., a server for an answering service). In various embodiments, a source entity 20 may comprise of a human or robotic source user 22 and/or a source user device 24 (e.g., a laptop computer, a desktop computer, a workstation, a Smartphone, a cellular telephone, a personal digital assistant (PDA), or other computing/communication devices). In some embodiments, and from another perspective, the source entity 20 may be a website or an organization such as a business, a social group, a trade/technical group, or an interest group.

In some cases, the receiving device 10 may be designed to receive one or more conditional directives 50 from a receiving user 32 through a user interface 120. In various embodiments, the user interface 120, which may also be used to present communiqués 52 as well as to present covert indicators 54, may comprise of a display system 121 (e.g., a display monitor such as a touch screen and one or more input devices including, for example, a keypad or keyboard, a mouse, and so forth), an audio system 122 (e.g., one or more audio speakers and one or more input devices including, for example, a microphone), and/or a vibrating system 123 (e.g., many of today's mobile communication devices such as cellular telephones and Smartphones currently include a vibration system for generating vibrations in order to, for example, alert an end user to an incoming communiqué 52 such as a telephone call).

Among other things, the one or more conditional directives 50, which may or may not be directly provided by the receiving user 32, may identify the specific conditions that must occur in order to cause the receiving device 10 that is executing the one or more conditional directives 50 to obfuscate reception of a communiqué 52 that is affiliated with a particular source entity 20 and that is directed to a particular receiving user 32. Many types of “requisite” conditions (e.g., conditions that must occur for the receiving device 10 to obfuscate the reception of a communiqué 52 that is affiliated with a particular source entity 20 and that is directed to a particular receiving user 32) may be identified by the one or more conditional directives 50. For example, in some embodiments, the one or more conditional directives 50 may include a conditional directive 50 that requires that a determination be made that a communiqué 52 that is received includes one or more representations (e.g., name, address, telephone number, image, voice signature, words/phrases, or other identifiers) associated with the particular source entity 20 before taking specific actions (e.g., as specified by, for example, the one or more conditional directives 50) to conditionally obfuscate the reception of the communiqué 52. In some embodiments, the one or more conditional directives 50 that is executed by the receiving device 10 may include a conditional directive 50 that may alternatively or additionally include a conditional directive 50 that requires that a determination be made that the received communiqué 52 is provided by the particular source entity 20 before conditionally obfuscating the reception of the communiqué 52.

In some embodiments, the one or more conditional directives 50 that may be executed by the receiving device 10 may include a conditional directive 50 that makes the conditional obfuscation of the reception of the communiqué 52 affiliated with the particular source entity 20 as a function of location of the receiving device 10. For example, the one or more conditional directives 50 may direct the receiving device 10 to conditionally obfuscate the reception of the communiqué 52 only when the receiving device 10 is determined to be at (or not at) one or more specified locations as specified by, for example, the one or more conditional directives 50.

In some embodiments, the one or more conditional directives 50 that may be executed by the receiving device 10 may include a conditional directive 50 that makes the conditional obfuscation of the reception of the communiqué 52 affiliated with the particular source entity 20 as a function of time with respect to the receiving device 10. For example, the one or more conditional directives 50 may direct the receiving device 10 to conditionally obfuscate the reception of the communiqué 52 only when the receiving device 10 is determined to have reached one or more specified times of a day or calendar year as specified by, for example, the one or more conditional directives 50.

In some embodiments, the one or more conditional directives 50 that may be executed by the receiving device 10 may include a conditional directive 50 that makes the conditional obfuscation of the reception of the communiqué 52 affiliated with the particular source entity 20 as a function of environmental conditions with respect to the receiving device 10. For example, the one or more conditional directives 50 may direct the receiving device 10 to conditionally obfuscate the reception of the communiqué 52 only when a particular third party is determined to be in the proximate vicinity (e.g., within 3 feet, 5 feet, 8 feet, or within some other distance from the receiving device 10 from which the third party may be able to overhear or see messages that are presented through the receiving device 10) of the receiving device 10 as specified by, for example, the one or more conditional directives 50. A determination as to whether a particular third party is within the proximate vicinity of the receiving user 32 may be based on data provided from a number of sources including, for example, a personal management application such as Microsoft Outlook, from microblog entries (e.g., “tweets”), or from data provided by one or more sensors 150 (e.g., image capturing device 152, audio capturing device 153, and so forth).

In some embodiments, the one or more conditional directives 50 that may be executed by the receiving device 10 may include a conditional directive 50 that requires the receiving device 10 to determine that the receiving device 10 is not possessed by the receiving user 32 that the communiqué 52 is directed to before obfuscating the reception of the communiqué 52. For example, the conditional directives 50 may direct the receiving device 10 to conditionally obfuscate the reception of the communiqué 52 only in the absence of verification (e.g., password verification or biometric verification such as a facial recognition verification, a retinal scan verification, a voice verification, or a fingerprint verification) of the receiving user 32 having possession of the receiving device 10.

In some embodiments, the one or more conditional directives 50 that may be executed by the receiving device 10 may include a conditional directive 50 that requires the receiving device 10 to determine whether the received communiqué 52 is directed to a representation of the receiving user 32 before conditionally obfuscating the reception of the communiqué 52 affiliated with the particular source entity 20. For example, the one or more conditional directives 50 may direct the receiving device 10 to conditionally obfuscate the reception of the communiqué 52 only when the receiving device 10 has determined that the received communiqué 52 is directed to an address (e.g., email address, IP address, URL, etc.), a telephone number, name, words/phrases, and/or other identifiers associated with the receiving user 32.

If the “necessary” conditions, as specified by the one or more conditional directives 50, have been determined to have occurred, then the receiving device 10 may obfuscate reception of the communiqué 52 affiliated with the particular source entity 20 in a variety of different ways depending on the specific circumstances (e.g., the type of communiqué 52 that was received and/or what type of receiving device 10 is the one or more conditional directives 50 being executed by). For example, in some embodiments, in order to obfuscate the reception of the communiqué 52, the receiving device 10 may intercept (e.g., seize or capture) the communiqué 52 upon receiving the communiqué 52 in order to prevent any indications of the reception of the communiqué 52 from being presented.

There are at least three conventional ways to indicate that a particular communiqué 52 has been received. One way to conventionally indicate that a particular communiqué 52 has been received is to automatically present (audioally and/or visually present) the entire communiqué 52 including message content. An example of such an approach is instant messages (IMs), which are typically presented in their entirety as soon as they are received. The second way to conventionally indicate that a particular communiqué 52 has been received is to present a listing of the communiqué 52 as part of a list of received communiqué 52. Such a listing of a received communiqué 52 will typically include certain basic information such as an identifier (e.g., telephone number, email address, etc.) associated with the sender of the communiqué 52, the time the communiqué 52 was received, and/or the subject heading if there is one. An example of such a listing is a listing for a received email. The third way to conventionally indicate that a particular communiqué 52 has been received is by presenting a basic alert such as a ring or a vibration that alerts the receiving user 32 that a communiqué 52 has been received, but provides very little information beyond the basic indication that a communiqué 52 has been received. Examples of such alerts include the ring or vibration generated by a telephone when receiving a telephone call.

In various embodiments, in order to obfuscate the reception of the communiqué 52 affiliated with the particular source entity 20, one or more of the above three ways of indicating the reception of the communiqué 52 may be prevented or at least disguised. For example, in some embodiments, in order to obfuscate the reception of the communiqué 52 affiliated with the particular source entity 20, the communiqué 52 itself may be prevented from being presented (e.g., audioally and/or visually indicated). In the same or different embodiments, a listing of the received communiqué 52 may be prevented from being listed or at least modified to disguise the listing (e.g., changing the sender's identifier such as telephone number or email address). In still other embodiments or in the same embodiments, an alert that is generated whenever a communiqué 52 is received may be disarmed or modified (e.g., changing a ring to a vibration) when a communiqué 52 that is determined to be affiliated with the particular source entity 20 is received.

As indicated previously, the receiving device 10 may present a covert indicator 54 that covertly indicates reception of the communiqué 52 in lieu of presenting any indication of reception of the communiqué 52 affiliated with a source entity 20 in order to obfuscate the reception of the communiqué 52 that is affiliated with the source entity 20 and that is directed to the receiving user 32. As also briefly indicated earlier, the covert indicator 54 that may be presented may indirectly indicate the reception of the communiqué 52 that is affiliated with the source entity 20. In general, the covert indicator 54 that may be presented may not, at least directly, indicate any aspect of the received communiqué 52 that would alert a third party to the existence of the communiqué 52, the reception of the communiqué 52, the source entity 20 affiliated with the communiqué 52, and/or the relationship between the source entity 20 and the communiqué 52.

The covert indicator 54 that is presented by the receiving device 10 may be in accordance with the one or more conditional directives 50 of the receiving user 32, the one or more conditional directives 50 defining how the covert indicator 54 may be presented in order to covertly indicate reception of the communiqué 52 affiliated with the source entity 20. In some cases, as a result of being based, at least in part, on the one or more conditional directives 50 of (e.g., provided by) the receiving user 32, only the receiving user 32, as well as those entities that the receiving user 32 may have confided in, may recognize the meaning of the covert indicator 54 when the covert indicator 54 is presented through, for example, a user interface 120 (e.g., display system 121, audio system 122, and/or vibrating system 123).

In various embodiments, the covert indicator 54 that may be presented by the receiving device 10 may come in a variety of different forms including as a covert visual indicator, as a covert audio indicator, and/or as a covert vibration indicator (note that in some cases a covert indicator 54 may be comprised of two or more types of covert indicators 54 a covert visual indicator, a covert audio indicator, and/or a covert vibration indicator). In embodiments where the covert indicator 54 that is presented includes at least an audio element in the form of a covert audio indicator, which may be presented through an audio system 122, the covert audio indicator may be at least one of a ping, a ring, or a hum. Alternatively, or in the same implementation, the covert indicator 54 may include a covert audio indicator that includes one or more simulated natural background noises (e.g., sound of a train or car passing, sounds of birds in the background, and so forth).

In some embodiments, the covert indicator 54 that may be presented by the receiving device 10 may comprise a covert audio indicator that includes at least one voice message. Such a voice message may be a fictional voice message or a non-fictional voice message (which may or may not be modified to covertly indicate reception of the communiqué 52) that may have been previously received and/or presented. Further, such a voice message, in some cases, may be or may appear to be a (fictional or non-fictional) communication audio message from a third party, an (fictional or non-fictional) audio message related to operational aspects of the receiving device 10 such as a message related to the operating system of the receiving device 10, or a (fictional or non-fictional) communiqué application related audio message (e.g., a message that appears to be related to, for example, a VoIP application). In order to covertly indicate reception of the communiqué 52 affiliated with the particular source entity 20, the voice message that may be presented may include, in some cases, particular words and/or phrases, and/or the voice message may have one or more particular characteristics such as tone, feminine/masculine characteristics, and/or speech pattern (e.g., accent).

In embodiments where the covert indicator 54 that is presented includes at least a visual element in the form of a covert visual indicator, which may be visually presented through a display system 121, the covert visual indicator may be one or more particular symbols or icons. Alternatively, or additionally, the covert visual indicator that may be presented may merely be the visual presentation of one or more particular colors (e.g., particular background colors or particular colors used for particular words or items). In some cases, the covert visual indicator that may be presented may be in the form of a visual message such as a textual message. As in the case of covert audio indicator that takes the form of a voice message described above, the covert visual indicator in the form of a visual message may be a fictional visual message or a non-fictional message (e.g., a previously received visual message that may or may not have been modified to indicate reception of the communiqué 52).

Also, as before, such a visual message for covertly indicating reception of the communiqué 52 may be or may at least appear to be a (fictional or non-fictional) communication visual message from a third party such as an email, an (fictional or non-fictional) visual message related to operational aspects of the receiving device 10 such as a visual message related to the operating system of the receiving device 10, or a (fictional or non-fictional) communiqué application related visual message (e.g., a message that appears to be related to, for example, an email application). In some cases, in order to covertly indicate the reception of the communiqué 52 affiliated with the source entity 20, the visual message that may be presented may include one or more particular words and/or phrases in one or more particular font or style.

In embodiments where the covert indicator 54 that is presented includes at least a vibration element in the form of a covert vibrating indicator, which may be presented through a vibrating system 123 (which many of today's mobile phones have). As will be further described herein, the covert vibrating indicator that may be presented may have particular characteristics (e.g., vibration pattern and/or intensity) in order to covertly indicate reception of the communiqué 52. As described earlier, the covert indicator 54 that is presented may include one, two, or all three types of covert indicators (e.g., one or more covert audio indicators, one or more covert visual indicators, and one or more covert vibrating indicators).

In accordance with various embodiments, the covert indicator 54 that covertly indicates the reception of the communiqué 52 affiliated with the particular source entity 20 may be presented by presenting, via a display system 121, a graphical user interface (GUI), that includes the covert indicator 54 (e.g., in the form of one or more symbols, one or more icons, one or more colors, one or more words, and/or one or more phrases). In some cases, the GUI that is presented may be a previously presented GUI that has been modified to include the covert indicator 54. In some instances, the GUI that is presented may be an interface for an operating system (OS) application (e.g., Windows 7, Windows Vista, Vista Smartphone Interface, Symbian OS, Android, and so forth). Note that for purposes of the following description, references to a GUI may be in reference to a GUI for a personal computer (PC), a telephone user interface (TUI) for a telephone device such as a Smartphone or a cellular telephone, or other types of device user interface for other computing/communication devices.

In alternative embodiments, however, the covert indicator 54 that covertly indicates the reception of the communiqué 52 affiliated with the particular source entity 20 may be presented by presenting, via a display system 121 and/or via an audio system 122, a communiqué application interface (e.g., an email application interface, a VoIP application interface, an IM application interface, and so forth) that includes the covert indicator 54. In some embodiments, the communiqué application interface that may be presented may be a modified version of a previously presented communiqué application interface that has been modified to include the covert indicator 54. For these embodiments, the covert indicator 54 that may be presented through the communiqué application interface may be a covert visual indicator, a covert audio indicator, and/or a covert vibrating indicator to covertly indicate the reception of the communiqué 52.

The presentation of the covert indicator 54, in lieu of presenting any direct indication of reception of the communiqué 52, may be in accordance with a variety of conditional directives 50 of the receiving user 32. For example, in some embodiments, one or more conditional directives 50 may direct the receiving device 10 to present the covert indicator 54 only when a received communiqué 52 has been determined by the receiving device 10 to include one or more representations (e.g., name, address such as email or IP address, telephone number, image, voice signature, words/phrase, and so forth) of the source entity 20. Note that a “voice signature” may be in reference to the distinct patterns of speech (e.g., tone, pitch, rhythm, accent, and so forth) that each person's voice may be uniquely associated with. In some embodiments, the one or more conditional directives 50 that may be executed by the receiving device 10 may direct the receiving device 10 to present the covert indicator 54 as a function of location of the receiving device 10, as a function of time of the receiving device 10, and/or as a function of environmental conditions of the receiving device 10 (e.g., presence or absence of a third party in the vicinity of the receiving device 10) as will be further described herein.

In the same or alternative embodiments, the one or more conditional directives 50 that may be executed by the receiving device 10 may direct the receiving device 10 to present the covert indicator 54 upon determining that the receiving device 10 is not in the possession of the receiving user 32 that the communiqué 52 is directed to. As will be further described herein, the receiving device 10 may determine whether the receiving device 10 is in the possession of the receiving user 32 based on data provided from a number of sources including from the receiving user 32 and/or one or more sensors 150. In some embodiments, the receiving device 10 may determine whether the receiving device 10 is in the possession of the receiving user 32 based on whether there is a verification (e.g., in the form of password or biometric verification) that the receiving user 32 is in possession of the receiving device 10.

In accordance with some embodiments, and as will be further described herein, after receiving or intercepting the communiqué 52 that has been determined to be affiliated with a particular source entity 20, and after presenting a covert indicator that covertly indicates the reception of the communiqué 52, the communiqué 52 may then be stored in a memory 140. The communiqué 52 that is stored in memory 140 may then be ultimately or subsequently presented when one or more triggering events occurs. One example of a triggering event is when verification (e.g., a password or biometric verification) has been made as to whether the receiving user 32 has possession of the receiving device 10. For example, after being covertly notified of the reception of the communiqué 52, the receiving user 32 may input a password (or a biometric verification) to verify that the receiving user 32 is in possession or control of the receiving device 10. After providing the appropriate password (or biometric verification), the receiving user 32 may be allowed access to the stored communiqué 52 affiliated with the source entity 20 and directed to the receiving user 32. Other trigger events that could result in the communiqué 52 being presented include, for example, a determination made by the receiving device 10 that the receiving device 10 is or is not at one or more specified locations or a determination made by the receiving device 10 has reached one or more particular times of a day or calendar year as will be further described herein.

Turning specifically now to the receiving device 10 of FIGS. 1a and 1b. The receiving device 10, as illustrated, may include a variety of modules, sub-modules, and various other components. In some embodiments, the receiving device 10 may be a network component device designed to communicate with one or more other network devices. The receiving device 10 may be any one of a variety of computing/communication devices that include at least a processor (e.g., microprocessor, controller, and so forth) and that can transmit/receive communiqués including, for example, a cellular telephone, a personal digital assistant (PDA), a Smartphone, a tablet computer, a laptop computer, a desktop computer, a workstation, and so forth.

As illustrated, the receiving device 10 may include one or more processors 101 (e.g., one or more microprocessors and/or controllers), a memory 140 (which may be a storage medium) including computer readable instructions 40, a transceiver 112 (e.g., for transmitting and receiving electronic communiqué signals), a network interface 113 (e.g., a network interface card or “NIC”), a user interface 120 (which may further include a display system 121, an audio system 122, and/or a vibrating system 123), and one or more sensors 150. In various implementations, the one or more processors 101 when executing the computer readable instructions 40 may include certain logic blocks for executing the novel operations and processes to be described herein. For example, the one or more processors 101, when executing the computer readable instructions 40 of the memory 140, may include logic blocks including a communiqué receiving module 102 and a covert indicator presenting module 104. In some embodiments, the one or more processors 101, when further executing the computer readable instructions 40 of the memory 140, may further include additional logic blocks such as a conditional directive receiving module 106, a communiqué storing module 108, and/or a communiqué presenting module 110.

As will be further described herein, the communiqué receiving module 102 may be configured to at least receive a communiqué 52 that is affiliated with a particular source entity 20 and that is directed to a particular receiving user 32, while the covert indicator presenting module 104 may be configured to present, in lieu of presenting indication of reception of the communiqué 52, a covert indicator 54 that covertly indicates reception of the communiqué 52, the presenting of the covert indicator 54 being in accordance with one or more conditional directives 50 of the receiving user 32 to conditionally obfuscate the reception of the communiqué 52 affiliated with the source entity 20. With respect to the other logic blocks that may be included in the one or more processors 101 when executing the computer readable instructions 40 of the memory 140, the conditional directive receiving module 106 may be configured to receive the one or more conditional directives 50 via, for example, the user interface 120, the communiqué storing module 108 may be designed to store the received communiqué 52 in, for example, a memory 140, and the communiqué presenting module 110 may be designed to present the stored communiqué 52 in response to, for example, one or more triggering events associated with the receiving device 10.

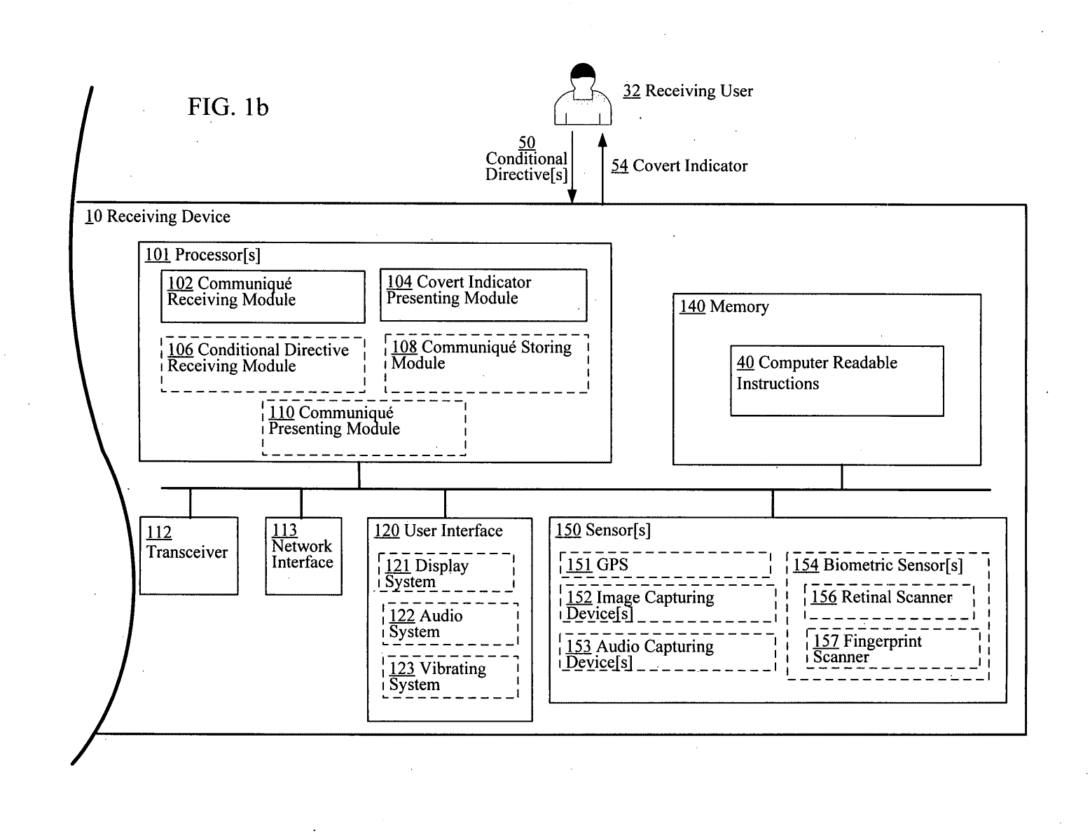

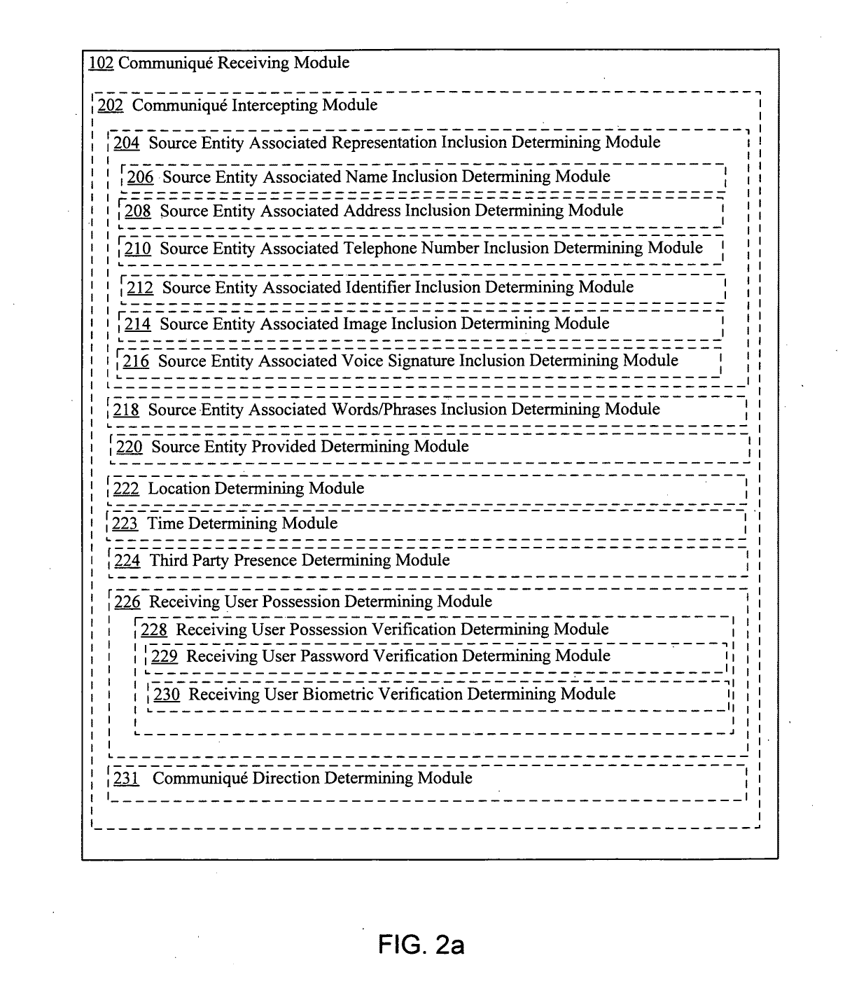

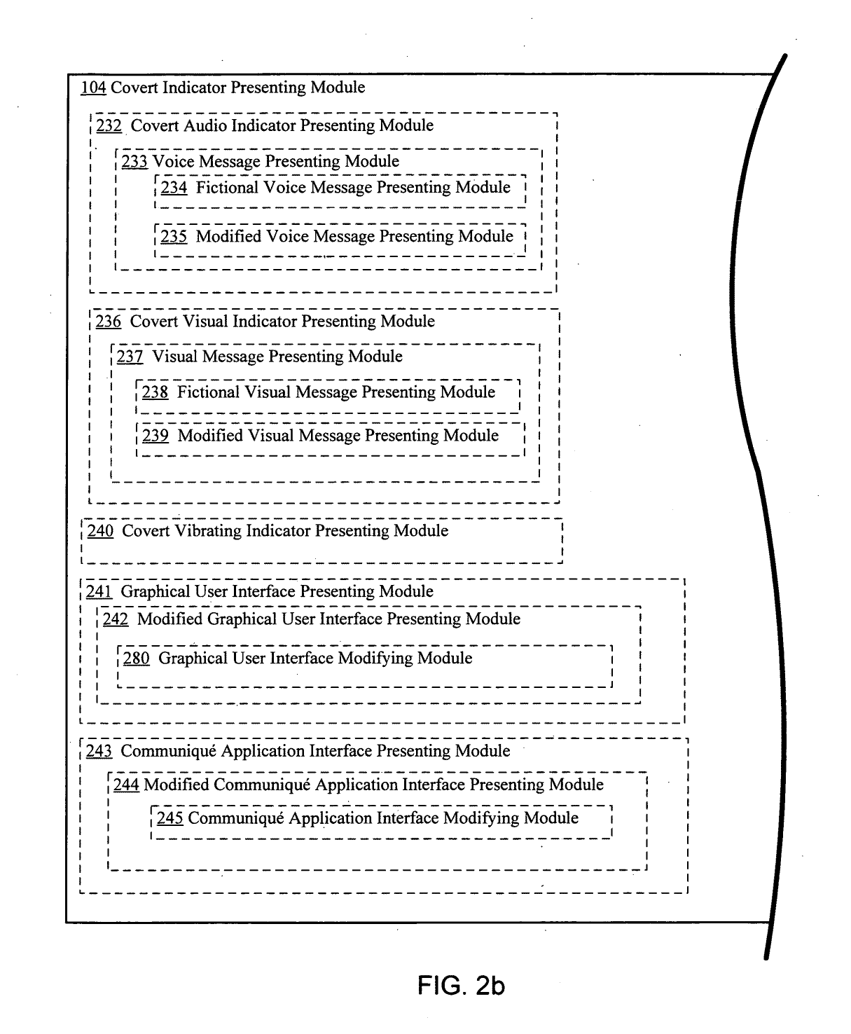

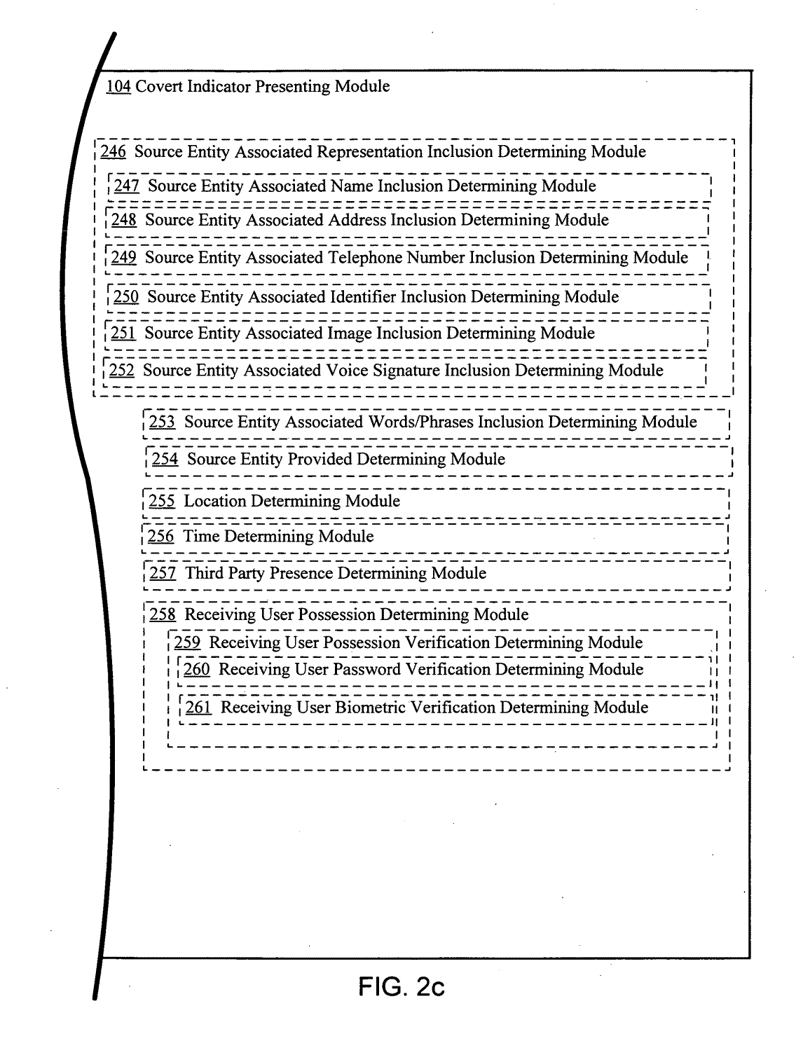

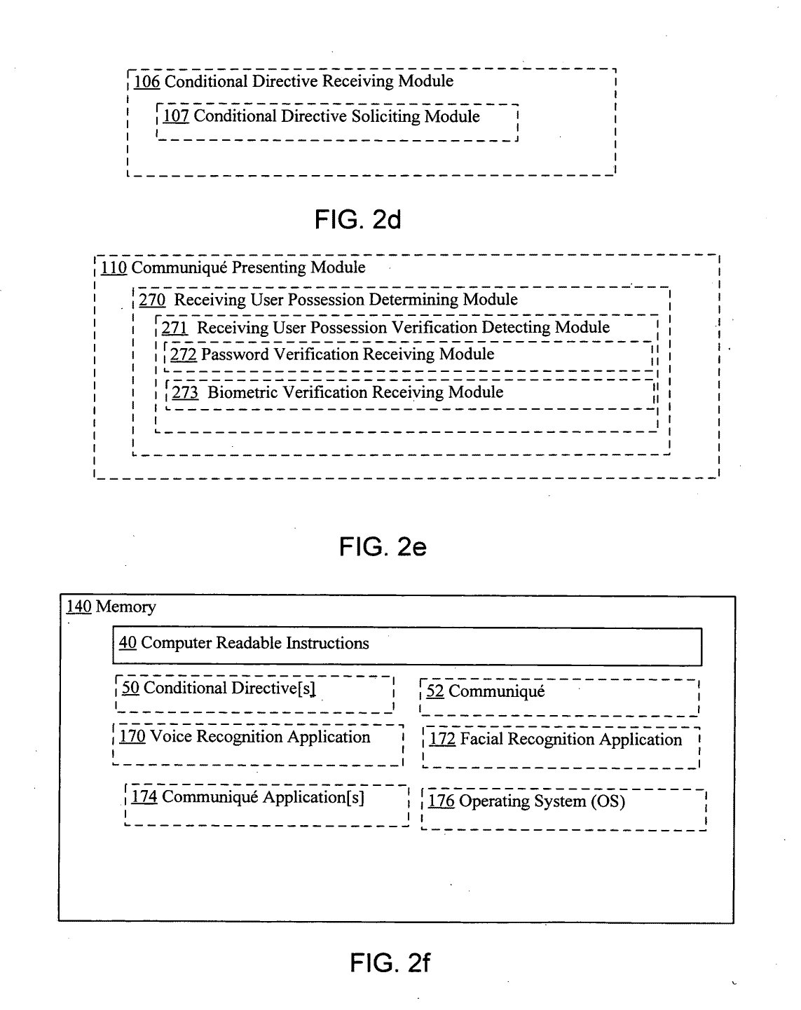

Note that the receiving device 10 illustrated in FIGS. 1a and 1b is the “software” implementation of the receiving device 10. That is, although the communiqué receiving module 102, the covert indicator presenting module 104, the conditional directive receiving module 106, the communiqué storing module 108, and the communiqué presenting module 110 illustrated in FIGS. 1a and 1b were depicted as being logic blocks implemented by the one or more processors 101 executing the computer readable instructions 40 (e.g., software) of memory 140, in alternative implementations, the communiqué receiving module 102, the covert indicator presenting module 104, the conditional directive receiving module 106, the communiqué storing module 108, and the communiqué presenting module 110 (and all their sub-modules as illustrated in FIGS. 2a, 2b, 2c, 2d, and 2e) may be alternatively implemented using hardware (e.g. circuitry such as application specific integrated circuit or ASIC), firmware, or any combination of hardware, firmware, and/or software.

As briefly described above, in various embodiments, the receiving device 10 may include one or more sensors 150. For example, in some embodiments, the receiving device 10 may include a global positioning system (GPS) 151, one or more image capturing devices 152 (e.g., digital camera or a webcam) that may also be part of the display system 121, one or more audio capturing devices 153 (e.g. one or more microphones) which may be part of the audio system 122, and one or more biometric sensors 154 (e.g., retinal scanner 156, fingerprint scanner 157, and so forth). These sensors 150 may be employed in order to facilitate in the implementation of various processes and operations to be described herein.

In various embodiments, the memory 140 that may be included in the receiving device 10 may be designed for storing various types of data as well as the computer readable instructions 40. For these embodiments, memory 140 may comprise of one or more of mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

As illustrated in FIG. 2f, memory 140 may store, as part of the computer readable instructions 40 in some cases, one or more conditional directives 50, a voice recognition application 170, a facial recognition application 172, one or more communiqué applications 174 (e.g., email application, text messaging application, IM application, VoIP application, and so forth), and/or an operating system (OS) 176. The voice recognition application 170 and the facial recognition application 172 may be employed in order to facilitate various aspects of the operations and processes to be described herein. In some cases, for example, the voice recognition application 170 and the facial recognition application 172 may be employed in order to determine whether the receiving user 32 has possession of the receiving device 10 or a third party is within proximate vicinity (e.g., close enough such that the third party may hear/see communiqués received through the receiving device 10) of the receiving device 10. As will be further explained, in some cases, the memory 140 may be designed to store one or more communiqués 52 that have been determined to be affiliated with a particular source entity 20 and that is directed to the receiving user 32.

Referring now to FIG. 2a illustrating a particular implementation of the communiqué receiving module 102 of the receiving device 10 of FIGS. 1a and 1b. As illustrated, the communiqué receiving module 102 may include one or more sub-modules including, for example, a communiqué intercepting module 202 that may further include a source entity associated representation inclusion determining module 204 (which may further include one or more sub-modules including a source entity associated name inclusion determining module 206, a source entity associated address inclusion determining module 208, a source entity associated telephone number inclusion determining module 210, a source entity associated identifier inclusion determining module 212, a source entity associated image inclusion determining module 214, and/or a source entity associated voice signature inclusion determining module 216). In brief, the communiqué intercepting module 202 may be designed to intercept (e.g., capture or seize) a communiqué 52 that has been determined to be affiliated with a particular source entity 20 and that is directed to a particular receiving user 32. In some implementations, the communiqué intercepting module 202 may further include a source entity associated words/phrases inclusion determining module 218, a source entity provided determining module 220, a location determining module 222, a time determining module 223, a third party presence determining module 224, a receiving user possession determining module 226 that may further include, in some cases, a receiving user possession verification determining module 228 (which may also further include a receiving user password verification determining module 229 and/or a receiving user biometric verification determining module 230), and/or a communiqué direction determining module 231.

In various alternative implementations each of the sub-modules of the communiqué receiving module 102, as well as the communiqué receiving module 102 itself, may be implemented using hardware, software (e.g., computer readable instructions 40 executed by one or more processors 101), firmware, or any combination thereof. Specific details related to the communiqué receiving module 102 as well as the above-described sub-modules of the communiqué receiving module 102 will be provided below in reference to the operations and processes to be described herein.

Referring now to FIGS. 2b and 2c illustrating a particular implementation of the covert indicator presenting module 104 of the receiving device 10 of FIGS. 1a and 1b. As illustrated in FIGS. 2b and 2c, the covert indicator presenting module 104 may include one or more sub-modules in various alternative implementations. For example, and as illustrated in FIG. 2b, the covert indicator presenting module 104 may include, in various implementations, a covert audio indicator presenting module 232 that may include a voice message presenting module 233 (which may further comprise a fictional voice message presenting module 234 and/or a modified voice message presenting module 235), a covert visual indicator presenting module 236 that may include a visual message presenting module 237 (which may further comprise a fictional visual message presenting module 238 and/or a modified visual message presenting module 239), a covert vibrating indicator presenting module 240, a graphical user interface (GUI) presenting module 241 that may include a modified graphical user interface presenting module 242 (which may further comprise a graphical user interface modifying module 280), and/or a communiqué application interface presenting module 243 that may include a modified communiqué application interface presenting module 244 (which may further comprise a communiqué application interface modifying module 245).

As further illustrated in FIG. 2c, the covert indicator presenting module 104 may also include a source entity associated representation inclusion determining module 246 (which may further comprise of a source entity associated name inclusion determining module 247, a source entity associated address inclusion determining module 248, a source entity associated telephone number inclusion determining module 249, a source entity associated identifier inclusion determining module 250, a source entity associated image inclusion determining module 251, and/or a source entity associated voice signature inclusion determining module 252), a source entity associated words/phrases inclusion determining module 253, a source entity provided determining module 254, a location determining module 255, a time determining module 256, a third party presence determining module 257, and/or a receiving user possession determining module 258 that may include a receiving user possession verification determining module 259 (which may further comprise a receiving user password verification determining module 260 and/or a receiving user biometric verification determining module 261).

In various alternative implementations each of the sub-modules of the covert indicator presenting module 104, as well as the covert indicator presenting module 104 itself, may be implemented using hardware, software (e.g., computer readable instructions 40 executed by one or more processors 101), firmware, or any combination thereof. Specific details related to the covert indicator presenting module 104, as well as the above-described sub-modules of the covert indicator presenting module 104, will be provided below in reference to the operations and processes to be described herein.

Turning now to FIG. 2d illustrating a particular implementation of the conditional directive receiving module 106 of the receiving device 10 of FIGS. 1a and 1b. As briefly described above, the conditional directive receiving module 106 may be designed to receive one or more conditional directives 50 via, for example, the user interface 120. In some embodiments, the conditional directive receiving module 106 may further include a conditional directive soliciting module 107 that is designed to solicit one or more conditional directives 50 from, for example, a receiving user 32 via the user interface 120.

Referring now to FIG. 2e illustrating a particular implementation of the communiqué presenting module 110 of the receiving device 10 of FIGS. 1a and 1b. As briefly indicated earlier, the communiqué presenting module 110 may be designed to present a received communiqué 52 that has been determined to be at least affiliated with a source entity 20 in response to a triggering event associated with the receiving device 10. In some instances, the received communiqué 52 may be presented via the user interface 120. In various embodiments, the communiqué presenting module 110 may further include a receiving user possession determining module 270 that may further include a receiving user possession verification detecting module 271 (which may further comprise a password verification receiving module 272 and/or a biometric verification receiving module 273).

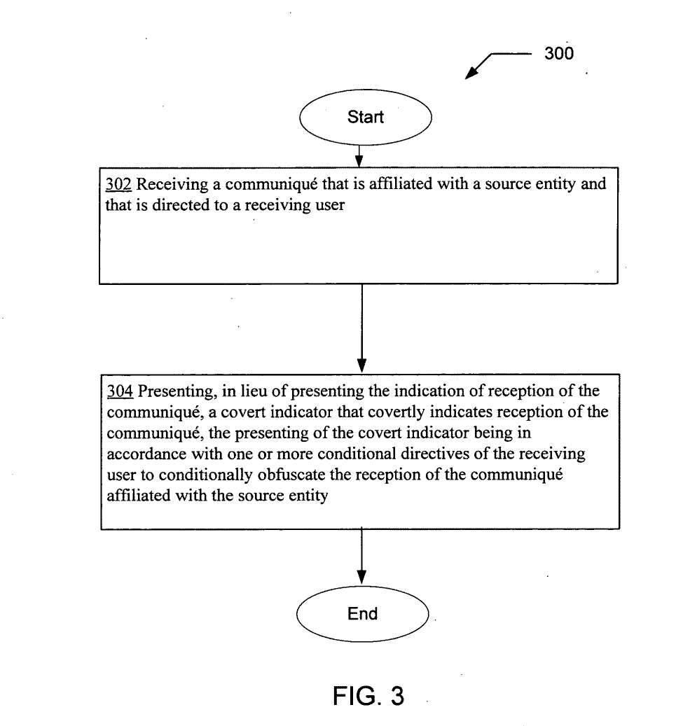

A more detailed discussion related to the receiving device 10 of FIGS. 1a and 1b will now be provided with respect to the processes and operations to be described herein. FIG. 3 illustrates an operational flow 300 representing example operations for, among other things, obfuscating reception of a communiqué that is affiliated with a particular source entity. In FIG. 3 and in the following figures that include various examples of operational flows, discussions and explanations will be provided with respect to the exemplary environment 100 described above and as illustrated in FIGS. 1a and 1b, and/or with respect to other examples (e.g., as provided in FIGS. 2a, 2b, 2c, 2d, 2c, 2e, and 20 and contexts. However, it should be understood that the operational flows may be executed in a number of other environments and contexts, and/or in modified versions of FIGS. 1a, 1b, 2a, 2b, 2c, 2d, 2c, 2e, and 2f. Also, although the various operational flows are presented in the sequence(s) illustrated, it should be understood that the various operations may be performed in other orders other than those which are illustrated, or may be performed concurrently.

Further, in FIG. 3 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 3 as well as the other operations to be described herein may be performed by at least one of a machine, an article of manufacture, or a composition of matter.

In any event, after a start operation, the operational flow 300 of FIG. 3 may move to a communiqué receiving operation 302 for receiving a communiqué that is affiliated with a source entity and that is directed to a receiving user. For instance, and as an illustration, the communiqué receiving module 102 of the receiving device 10 of FIGS. 1a and 1b receiving a communiqué 52 that is affiliated with a source entity 20 and that is directed to a receiving user 32 (e.g., a human or robotic user). The communiqué 52 that is received may be in the form of an email message, a text message, an instant message (IM), a telephone call, a Voice over Internet Protocol (VoIP) call, a video call, or other forms of electronic communication. As described earlier, the source entity 20 may comprise of a human or robotic source user 22 and/or a source device 24. In some cases, the source entity 20 may be an organization such as a business or a social or interest group. In some cases, the source entity 20 may be a website. As also described earlier, the receiving device 10 of FIGS. 1a and 1b may be a variety of computing/communication devices capable of receiving/transmitting communiqués including, for example, a cellular telephone, a personal digital assistant (PDA), a Smartphone, a landline telephone, a laptop or desktop computer, a computer tablet, a workstation, and so forth.

In addition to the communiqué receiving operation 302, operational flow 300 may also include a covert indicator presenting operation 304 for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity as further illustrated in FIG. 3. For instance, the covert indicator presenting module 104 of the receiving device 10 of FIGS. 1a and 1b presenting (e.g., visually and/or audioally presenting), in lieu of presenting indication of reception of the communiqué 52, a covert indicator 54 that covertly indicates reception of the communiqué 52, the presenting of the covert indicator 54 being in accordance with one or more conditional directives 50 of the receiving user 32 (e.g., one or more conditional directives 50 provided by the receiving user 32) to conditionally obfuscate (e.g., hide or disguise) the reception of the communiqué 52 affiliated with the source entity 20.

In various embodiments, the covert indicator 54 that may be presented may covertly indicate the reception of the communiqué 52 to only selective parties (e.g., receiving user 32) without alerting others by providing a covert indicator 54 that may be supplied by or may only be known to the selective parties (e.g., only the selective parties including the receiving user 32 knows the meaning of the covert indicator 54). In some embodiments, the covert indicator 54 may, at least, not directly describe any aspect of the reception of the communiqué 52 including, for example, the identity of the source entity 20 affiliated with the communiqué 52 or the reception of the communiqué 52 itself. In some implementations, the presentation of the covert indicator 54 in lieu of presenting indication of the reception of the communiqué 52 in the covert indicator presenting operation 304 of FIG. 3 may involve the presentation of the covert indicator 54 in lieu of presenting the communiqué 52 itself. In some implementations, the presentation of the covert indicator 54 in lieu of presenting indication of the reception of the communiqué 52 in the covert indicator presenting operation 304 of FIG. 3 may involve the presentation of the covert indicator 54 in lieu of presenting any direct indication of the reception of the communiqué 52.

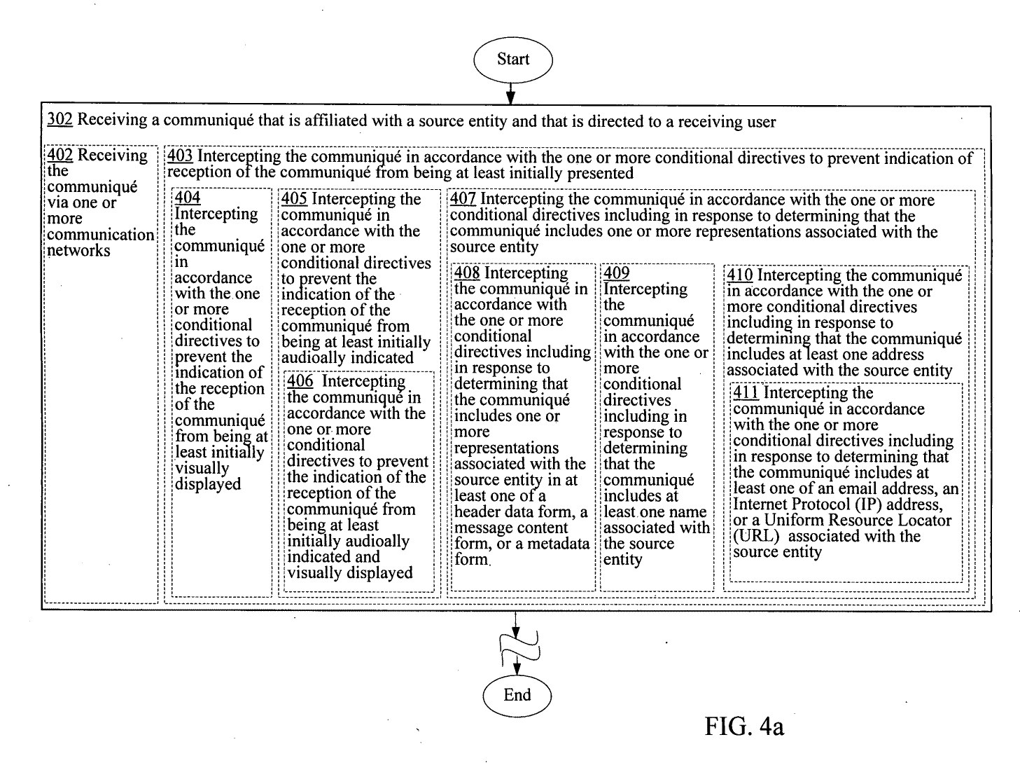

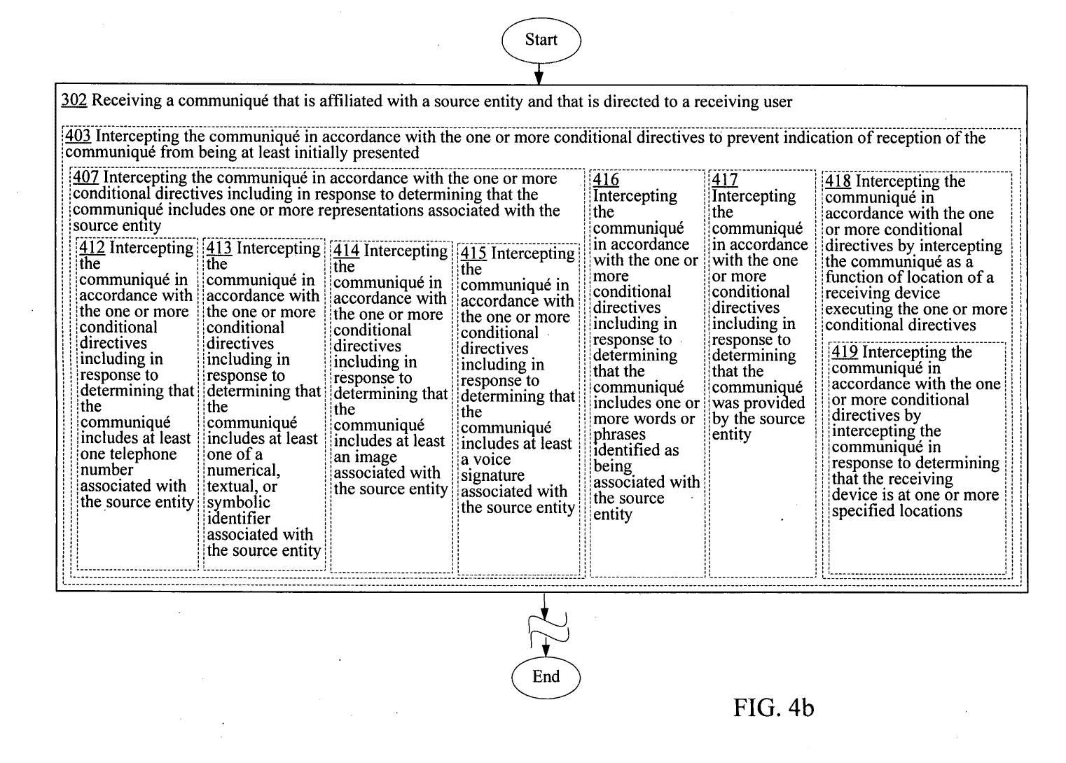

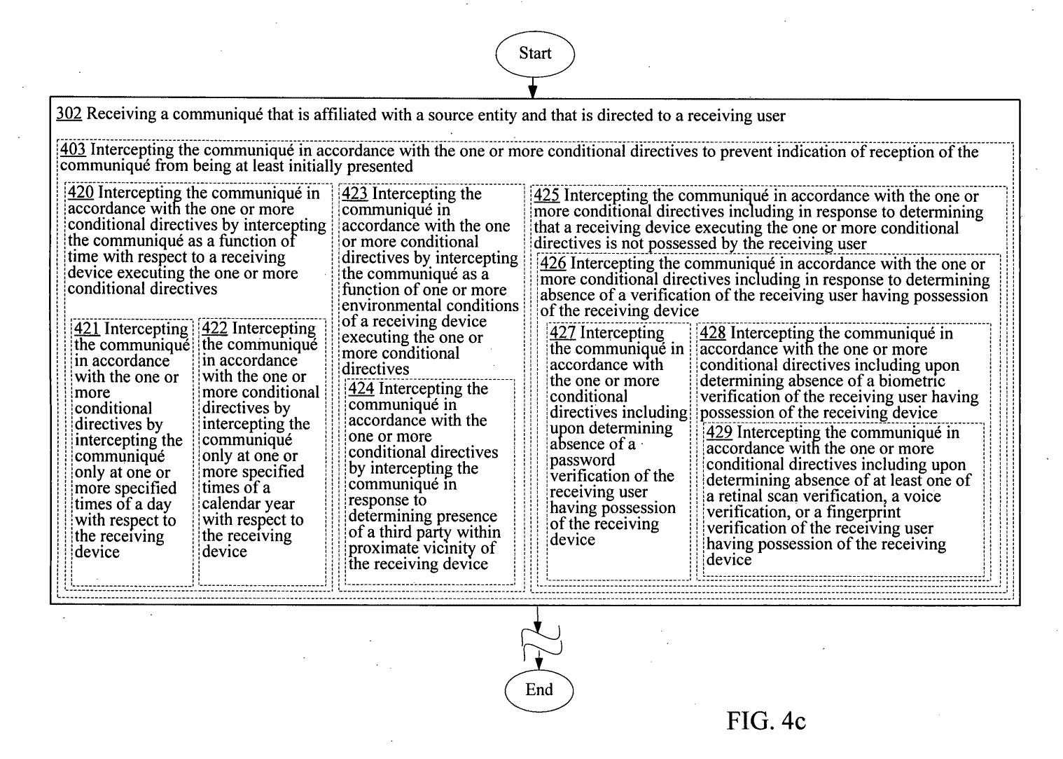

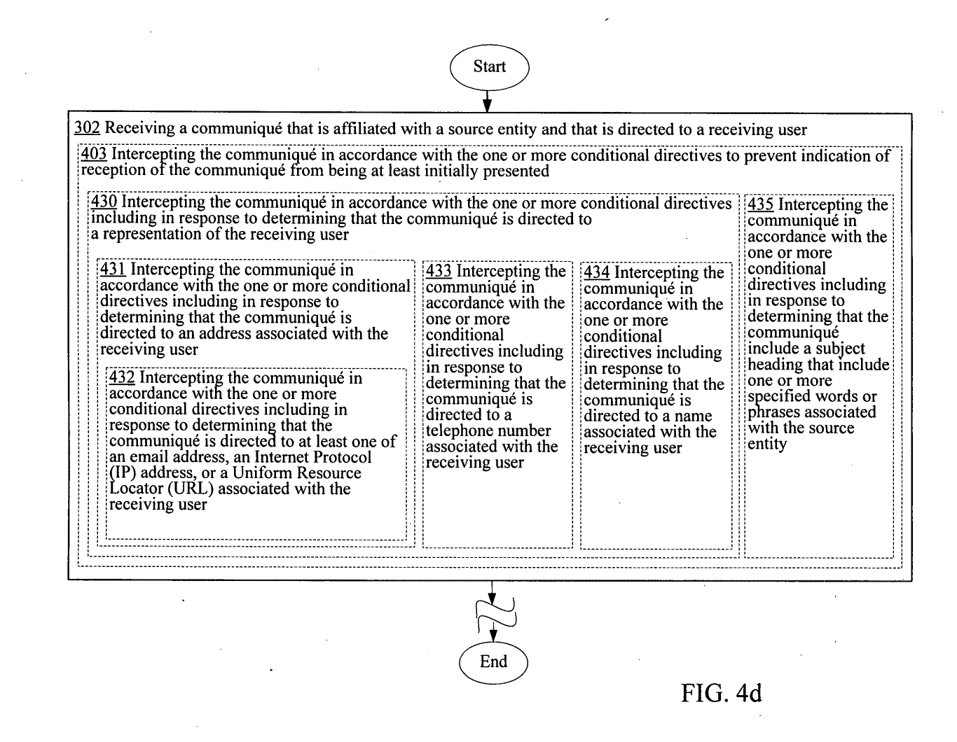

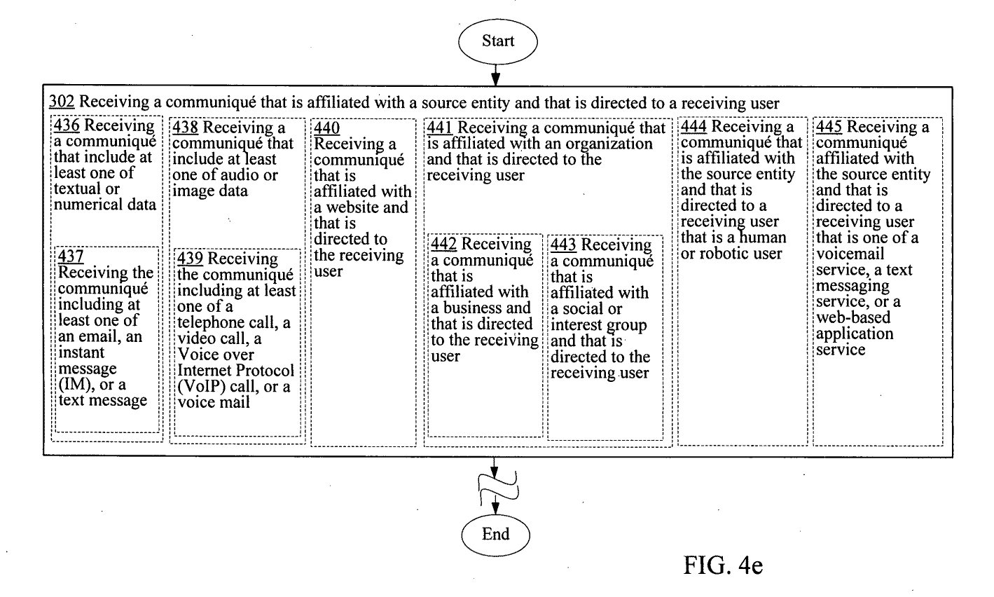

As will be further described herein, the communiqué receiving operation 302 and the covert indicator presenting operation 304 of FIG. 3 may be executed in a number of different ways in various alternative implementations. For example, FIGS. 4a, 4b, 4c, 4d, and 4e illustrate some of the various ways that the communiqué receiving operation 302 of FIG. 3 may be executed in various alternative implementations. In some implementations, for example, the communiqué receiving operation 302 of FIG. 3 may include an operation 402 for receiving the communiqué via one or more communication networks as depicted in FIG. 4a. For instance, the communiqué receiving module 102 of the receiving device 10 of FIGS. 1a and 1b receiving the communiqué 52 via one or more communication networks 40 (e.g., WLAN, LAN, WMAN, cellular network, PSTN, and so forth).

In the same or different implementations, the communiqué receiving operation 302 of FIG. 3 may include an operation 403 for intercepting the communiqué in accordance with the one or more conditional directives to prevent indication of reception of the communiqué from being at least initially presented as further depicted in FIG. 4a. For instance, the communiqué intercepting module 202 (see FIG. 2a) of the receiving device 10 of FIGS. 1a and 1b intercepting (e.g., seizing or capturing) the communiqué 52 in accordance with the one or more conditional directives 50 to prevent indication of reception of the communiqué 52 from being at least initially presented (e.g., being automatically shown or displayed). Note that in some cases, this may mean that the communiqué 52 itself may be prevented from being presented since in some instances, such as in the case where the communiqué 52 is a telephone call or an IM, the presentation of the communiqué 52 is the indication the communiqué 52 has been received. Note that and as will be further described herein, the communiqué 52 may, in some embodiments, be subsequently presented when one or more triggering events have occurred.

The operation 403 for intercepting the communiqué 52 that is affiliated with the source entity 20 may be executed in a number of different ways in various alternative implementations. For example, in various implementations, operation 403 may include an operation 404 for intercepting the communiqué in accordance with the one or more conditional directives to prevent the indication of the reception of the communiqué from being at least initially visually displayed as further depicted in FIG. 4a. For instance, the communiqué intercepting module 202 of the receiving device 10 of FIGS. 1a and 1b intercepting the communiqué 52 in accordance with the one or more conditional directives 50 to prevent the indication of reception of the communiqué 52 from being at least initially visually displayed. For example, if the communiqué 52 is an email, to intercept the email in order to prevent the indication of the reception of the email, which may be the email itself, from being displayed through, for example, a display system 121 (e.g., a display monitor or a touchscreen). In the case of preventing an indication of the reception an email message, the indication to be prevented from being visually displayed may be, for example, the subject heading of the email, the sender identification, date received, and so forth.

In various implementations, operation 403 may include an operation 405 for intercepting the communiqué in accordance with the one or more conditional directives to prevent the indication of the reception of the communiqué from being at least initially audioally indicated as also depicted in FIG. 4a. For instance, the communiqué intercepting module 202 of the receiving device 10 of FIGS. 1a and 1b intercepting the communiqué 52 in accordance with the one or more conditional directives 50 to prevent the indication of the reception of the communiqué 52 from being at least initially audioally indicated (e.g., preventing a receiving device 10 such as a phone from ringing). For example, if the communiqué 52 is an VoIP call, to intercept the VoIP call in order to prevent the indication of the reception of the VoIP call from being audioally indicated through, for example, an audio system 122 (e.g., speakers).

In some implementations, operation 405 may include an operation 406 for intercepting the communiqué in accordance with the one or more conditional directives to prevent the indication of the reception of the communiqué from being at least initially audioally indicated and visually displayed as depicted in FIG. 4a. For instance, the communiqué intercepting module 202 of the receiving device 10 of FIGS. 1a and 1b intercepting the communiqué 52 in accordance with the one or more conditional directives 50 to prevent the indication of the reception of the communiqué 52 from being at least initially audioally indicated and visually displayed. For example, if the communiqué 52 is a video message, to intercept the video message in order to prevent the indication of the reception of the video message from being audioally indicated and visually displayed through, for example, an audio system 122 (e.g., speakers) and a display system 121 (e.g., display monitor or touchscreen).

In some implementations, operation 403 may include an operation 407 for intercepting the communiqué in accordance with the one or more conditional directives including in response to determining that the communiqué includes one or more representations associated with the source entity as further depicted in FIG. 4a. For instance, the communiqué intercepting module 202 including the source entity associated representation inclusion determining module 204 (see FIG. 2a) of the receiving device 10 of FIGS. 1a and 1b intercepting the communiqué 52 in accordance with the one or more conditional directives 50 including in response to, for example, the source entity associated representation inclusion determining module 204 determining that the communiqué 52 includes one or more representations (e.g., identifiers or symbols) associated with the source entity 20.

In some implementations, operation 407 may further include an operation 408 for intercepting the communiqué in accordance with the one or more conditional directives including in response to determining that the communiqué includes one or more representations associated with the source entity in at least one of a header data form, a message content form, or a metadata form as depicted in FIG. 4a. For instance, the communiqué intercepting module 202 including the source entity associated representation inclusion determining module 204 of the receiving device 10 of FIGS. 1a and 1b intercepting the communiqué 52 in accordance with the one or more conditional directives 50 including in response to, for example, the source entity associated representation inclusion determining module 204 determining that the communiqué 52 includes one or more representations associated with the source entity 20 in at least one of a header data form, a message content form, or a metadata form.

In the same or different implementations, operation 407 may include an operation 409 for intercepting the communiqué in accordance with the one or more conditional directives including in response to determining that the communiqué includes at least one name associated with the source entity as depicted in FIG. 4a. For instance, the communiqué intercepting module 202 including the source entity associated name inclusion determining module 206 (see FIG. 2a) of the receiving device 10 of FIGS. 1a and 1b intercepting the communiqué 52 in accordance with the one or more conditional directives 50 including in response to, for example, the source entity associated name inclusion determining module 206 determining that the communiqué 52 includes at least one name (e.g., legal name, business name, username, nickname, website name, and so forth) associated with the source entity 20.

In the same or different implementations, operation 407 may further include an operation 410 for intercepting the communiqué in accordance with the one or more conditional directives including in response to determining that the communiqué includes at least one address associated with the source entity as further depicted in FIG. 4a. For instance, the communiqué intercepting module 202 including the source entity associated address inclusion determining module 208 (see FIG. 2a) of the receiving device 10 of FIGS. 1a and 1b intercepting the communiqué 52 in accordance with the one or more conditional directives 50 including in response to, for example, the source entity associated address inclusion determining module 208 determining that the communiqué 52 includes at least one address associated with the source entity 20.

In some cases, operation 410 may further include an operation 411 for intercepting the communiqué in accordance with the one or more conditional directives including in response to determining that the communiqué includes at least one of an email address, an Internet Protocol (IP) address, or a Uniform Resource Locator (URL) associated with the source entity as further depicted in FIG. 4a. For instance, the communiqué intercepting module 202 including the source entity associated address inclusion determining module 208 of the receiving device 10 of FIGS. 1a and 1b intercepting the communiqué 52 in accordance with the one or more conditional directives 50 including in response to, for example, the source entity associated address inclusion determining module 208 determining that the communiqué 52 includes at least one of an email address, an Internet Protocol (IP) address, or a Uniform Resource Locator (URL) associated with the source entity 20.

In some implementations, operation 407 for intercepting the communiqué 52 may include an operation 412 for intercepting the communiqué in accordance with the one or more conditional directives including in response to determining that the communiqué includes at least one telephone number associated with the source entity as depicted in FIG. 4b. For instance, the communiqué intercepting module 202 including the source entity associated telephone number inclusion determining module 210 (see FIG. 2a) of the receiving device 10 of FIGS. 1a and 1b intercepting the communiqué 52 in accordance with the one or more conditional directives 50 including in response to, for example, the source entity associated telephone number inclusion determining module 210 determining that the communiqué 52 includes at least one telephone number associated with the source entity 20.

In the same or different implementations, operation 407 may include an operation 413 for intercepting the communiqué in accordance with the one or more conditional directives including in response to determining that the communiqué includes at least one of a numerical, textual, or symbolic identifier associated with the source entity as further depicted in FIG. 4b. For instance, the communiqué intercepting module 202 including the source entity associated identifier inclusion determining module 212 (see FIG. 2a) of the receiving device 10 of FIGS. 1a and 1b intercepting the communiqué 52 in accordance with the one or more conditional directives 50 including in response to, for example, the source entity associated identifier inclusion determining module 212 determining that the communiqué 52 includes at least one of a numerical (e.g., zip code or nickname), textual (e.g., motto), or symbolic (e.g., logo) identifier associated with the source entity 20.

In the same or different implementations, operation 407 may include an operation 414 for intercepting the communiqué in accordance with the one or more conditional directives including in response to determining that the communiqué includes at least an image associated with the source entity as further depicted in FIG. 4b. For instance, the communiqué intercepting module 202 including the source entity associated image inclusion determining module 214 (see FIG. 2a) of the receiving device 10 of FIGS. 1a and 1b intercepting the communiqué 52 in accordance with the one or more conditional directives 50 including in response to, for example, the source entity associated image inclusion determining module 214 determining that the communiqué 52 includes at least an image (e.g., digital facial image, iconic figure, webcam image, and so forth) associated with the source entity 20.

In the same or different implementations, operation 407 may include an operation 415 for intercepting the communiqué in accordance with the one or more conditional directives including in response to determining that the communiqué includes at least a voice signature associated with the source entity as further depicted in FIG. 4b. For instance, the communiqué intercepting module 202 including the source entity associated voice signature inclusion determining module 216 (see FIG. 2a) of the receiving device 10 of FIGS. 1a and 1b intercepting the communiqué 52 in accordance with the one or more conditional directives 50 including in response to, for example, the source entity associated voice signature inclusion determining module 216 determining that the communiqué 52 includes at least a voice signature associated with the source entity 20.

A “voice signature,” which may also be referred to as “voice biometrics,” relates to the particular combination of characteristics associated with a person's voice that may make each person's voice distinctive. For example, a typical individual will have a voice with certain distinct characteristics (e.g., speech pattern, pitch, tone, rhythm, accent, and so forth) that make that individual's voice relatively unique. Thus, there are currently a number of voice recognition systems available in the commercial market that can link, for example, a recorded voice to a particular person based on the particular person's voice signature.

In some cases, operation 403 for intercepting the communiqué in accordance with the one or more conditional directives to prevent indication of reception of the communiqué from being at least initially presented may include an operation 416 for intercepting the communiqué in accordance with the one or more conditional directives including in response to determining that the communiqué includes one or more words or phrases identified as being associated with the source entity as further depicted in FIG. 4b. For instance, the communiqué intercepting module 202 including the source entity associated words/phrases inclusion determining module 218 (see FIG. 2a) of the receiving device 10 of FIGS. 1a and 1b intercepting the communiqué 52 in accordance with the one or more conditional directives 50 including in response to, for example, the source entity associated words/phrases inclusion determining module 218 determining that the communiqué 52 includes one or more words or phrases identified as being associated with the source entity 20 (e.g., a motto or song linked to the source entity 20).

In the same or different implementations, operation 403 may include an operation 417 for intercepting the communiqué in accordance with the one or more conditional directives including in response to determining that the communiqué was provided by the source entity as further depicted in FIG. 4b. For instance, the communiqué intercepting module 202 including the source entity provided determining module 220 (see FIG. 2a) of the receiving device 10 of FIGS. 1a and 1b intercepting the communiqué 52 in accordance with the one or more conditional directives 50 including in response to, for example, the source entity provided determining module 220 determining that the communiqué 52 was provided by the source entity 20.

In the same or different implementations, operation 403 may include an operation 418 for intercepting the communiqué in accordance with the one or more conditional directives by intercepting the communiqué as a function of location of a receiving device executing the one or more conditional directives as further depicted in FIG. 4b. For instance, the communiqué intercepting module 202 of the receiving device 10 of FIGS. 1a and 1b intercepting the communiqué 52 in accordance with the one or more conditional directives 50 by intercepting the communiqué 52 as a function of location of a receiving device (e.g., the receiving device 10 of FIGS. 1a and 1b, which may be a computing/communication device such as a Smartphone, a cellular telephone, a laptop computer, a desktop computer, etc) executing the one or more conditional directives 50.

In some cases, operation 418 may, in turn, include an operation 419 for intercepting the communiqué in accordance with the one or more conditional directives by intercepting the communiqué in response to determining that the receiving device is at one or more specified locations as further depicted in FIG. 4b. For instance, the communiqué intercepting module 202 including the location determining module 222 (see FIG. 2a) of the receiving device 10 of FIGS. 1a and 1b intercepting the communiqué 52 in accordance with the one or more conditional directives 50 by intercepting the communiqué 52 in response to, for example, the location determining module 222 determining that the receiving device 10 is at one or more specified locations (e.g., as specified by the one or more conditional directives 50 of the receiving user 32).

In the same or different implementations, operation 403 may include an operation 420 for intercepting the communiqué in accordance with the one or more conditional directives by intercepting the communiqué as a function of time with respect to a receiving device executing the one or more conditional directives as depicted in FIG. 4c. For instance, the communiqué intercepting module 202 of the receiving device 10 of FIGS. 1a and 1b intercepting the communiqué 52 in accordance with the one or more conditional directives 50 by intercepting the communiqué 52 as a function of time with respect to a receiving device (e.g., the receiving device 10 of FIGS. 1a and 1b) executing the one or more conditional directives 50.

In turn, operation 420 may further include an operation 421 for intercepting the communiqué in accordance with the one or more conditional directives by intercepting the communiqué only at one or more specified times of a day with respect to the receiving device as further depicted in FIG. 4c. For instance, the communiqué intercepting module 202 of the receiving device 10 of FIGS. 1a and 1b intercepting the communiqué 52 in accordance with the one or more conditional directives 50 by intercepting the communiqué 52 only at one or more specified times (e.g., between 8 PM to 6 AM) of a day with respect to the receiving device 10.

In the same or different implementations, operation 420 may further include an operation 422 for intercepting the communiqué in accordance with the one or more conditional directives by intercepting the communiqué only at one or more specified times of a calendar year with respect to the receiving device as further depicted in FIG. 4c. For instance, the communiqué intercepting module 202 of the receiving device 10 of FIGS. 1a and 1b intercepting the communiqué 52 in accordance with the one or more conditional directives 50 by intercepting the communiqué 52 only at one or more specified times (e.g., month of December) of a calendar year with respect to the receiving device 10.

In the same or different implementations, operation 403 may include an operation 423 for intercepting the communiqué in accordance with the one or more conditional directives by intercepting the communiqué as a function of one or more environmental conditions of a receiving device executing the one or more conditional directives as further depicted in FIG. 4c. For instance, the communiqué intercepting module 202 of the receiving device 10 of FIGS. 1a and 1b intercepting the communiqué 52 in accordance with the one or more conditional directives 50 by intercepting the communiqué 52 as a function of one or more environmental conditions of a receiving device (e.g., the receiving device 10 of FIGS. 1a and 1b) executing the one or more conditional directives 50. In this context, the one or more environmental conditions of the receiving device 10 may be related to, for example, the presence of absence of one or more entities in the vicinity of the receiving device 10 or the social or business conditions associated with the receiving user 32. In some embodiments, such environmental conditions may be determined based on data from entries made through a personal management application such as Microsoft Outlook, from microblog entries (e.g., “tweets”), or from data provided by one or more sensors 150 (e.g., image capturing device 152, audio capturing device 153, and so forth).

In some implementations, operation 423 may further include an operation 424 for intercepting the communiqué in accordance with the one or more conditional directives by intercepting the communiqué in response to determining presence of a third party within proximate vicinity of the receiving device as further depicted in FIG. 4c. For instance, the communiqué intercepting module 202 including the third party presence determining module 224 of the receiving device 10 of FIGS. 1a and 1b intercepting the communiqué 52 in accordance with the one or more conditional directives 50 by intercepting the communiqué 52 in response to, for example, the third party presence determining module 224 determining presence of a third party within proximate vicinity of the receiving device. The within “proximate vicinity” referenced here may be in reference to distances within 3 feet, 5 feet, 8 feet, or within some other distance from the receiving device 10 from which a third party may be able to overhear or see messages (e.g., communiqué 52) that are presented through the receiving device 10.

In the same or different implementations, operation 403 may include an operation 425 for intercepting the communiqué in accordance with the one or more conditional directives including in response to determining that a receiving device executing the one or more conditional directives is not possessed by the receiving user as further depicted in FIG. 4c. For instance, the communiqué intercepting module 202 including the receiving user possession determining module 226 (see FIG. 2a) of the receiving device 10 of FIGS. 1a and 1b intercepting the communiqué 52 in accordance with the one or more conditional directives 50 including in response to determining (e.g., as determined by the receiving user possession determining module 226, which may be designed to determine whether the receiving device 10 is or is not in the possession of the receiver user 32) that a receiving device 10 executing the one or more conditional directives 50 is not possessed (e.g., not controlled) by the receiving user 32.

As further illustrated in FIG. 4c, operation 425 may include one or more additional operations in various alternative implementations. For example, in some implementations, operation 425 may include an operation 426 for intercepting the communiqué in accordance with the one or more conditional directives including in response to determining absence of a verification of the receiving user having possession of the receiving device as further depicted in FIG. 4c. For instance, the communiqué intercepting module 202 including the receiving user possession verification determining module 228 (see FIG. 2a) of the receiving device 10 of FIGS. 1a and 1b intercepting the communiqué 52 in accordance with the one or more conditional directives 50 including in response to determining (e.g., by the receiving user possession verification determining module 228, which may be designed to determine whether there is or there is not a verification that the receiving device 10 is in the possession of the receiving user 32) absence of a verification of the receiving user 32 having possession of the receiving device 10.

In some cases, operation 426 may further include an operation 427 for intercepting the communiqué in accordance with the one or more conditional directives including upon determining absence of a password verification of the receiving user having possession of the receiving device as further depicted in FIG. 4c. For instance, the communiqué intercepting module 202 including the receiving user password verification determining module 229 (see FIG. 2a) of the receiving device 10 of FIGS. 1a and 1b intercepting the communiqué 52 in accordance with the one or more conditional directives 50 including upon determining (e.g., by the receiving user password verification determining module 229, which may be designed to determine whether a password that verifies that the receiving device 10 is in the possession of the receiving user 32 has or has not been entered or provided) absence of a password verification of the receiving user 32 having possession of the receiving device 10.

In the same or different implementations, operation 426 may also include an operation 428 for intercepting the communiqué in accordance with the one or more conditional directives including upon determining absence of a biometric verification of the receiving user having possession of the receiving device as further depicted in FIG. 4c. For instance, the communiqué intercepting module 202 including the receiving user biometric verification determining module 230 (see FIG. 2a) of the receiving device 10 of FIGS. 1a and 1b intercepting the communiqué 52 in accordance with the one or more conditional directives 50 including upon determining (e.g., by the receiving user biometric verification determining module 230, which may be designed to determine whether a biometric verification data that verifies that the receiving device 10 is in the possession of the receiving user 32 has or has not been entered or provided) absence of a biometric verification of the receiving user 32 having possession of the receiving device 10.

In some implementations, operation 428 may further include an operation 429 for intercepting the communiqué in accordance with the one or more conditional directives including upon determining absence of at least one of a retinal scan verification, a voice verification, or a fingerprint verification of the receiving user having possession of the receiving device as further depicted in FIG. 4c. For instance, the communiqué intercepting module 202 including the receiving user biometric verification determining module 230 of the receiving device 10 of FIGS. 1a and 1b intercepting the communiqué 52 in accordance with the one or more conditional directives 50 including upon, for example, the receiving user biometric verification determining module 230 determining absence of at least one of a retinal scan verification, a voice verification, or a fingerprint verification of the receiving user 32 having possession of the receiving device 10.

In some cases, operation 403 for intercepting the communiqué in accordance with the one or more conditional directives to prevent indication of reception of the communiqué from being at least initially presented may include an operation 430 for intercepting the communiqué in accordance with the one or more conditional directives including in response to determining that the communiqué is directed to a representation of the receiving user as depicted in FIG. 4d. For instance, the communiqué intercepting module 202 including the communiqué direction determining module 231 (see FIG. 2a) of the receiving device 10 of FIGS. 1a and 1b intercepting the communiqué 52 in accordance with the one or more conditional directives 50 including in response to, for example, the communiqué direction determining module 231 determining that the communiqué 52 is directed to (e.g., being sent to or addressed to) a representation of the receiving user 32.

As further illustrated in FIG. 4d, operation 430 may further include one or more additional operations in various alternative implementations. For example, in some implementations, operation 430 may include an operation 431 for intercepting the communiqué in accordance with the one or more conditional directives including in response to determining that the communiqué is directed to an address associated with the receiving user as further depicted in FIG. 4d. For instance, the communiqué intercepting module 202 including the communiqué direction determining module 231 (see FIG. 2a) of the receiving device 10 of FIGS. 1a and 1b intercepting the communiqué 52 in accordance with the one or more conditional directives 50 including in response to, for example, the communiqué direction determining module 231 determining that the communiqué 52 is directed to an address associated with the receiving user 32.

In some implementations, operation 431 may further include an operation 432 for intercepting the communiqué in accordance with the one or more conditional directives including in response to determining that the communiqué is directed to at least one of an email address, an Internet Protocol (IP) address, or a Uniform Resource Locator (URL) associated with the receiving user as further depicted in FIG. 4d. For instance, the communiqué intercepting module 202 including the communiqué direction determining module 231 of the receiving device 10 of FIGS. 1a and 1b intercepting the communiqué 52 in accordance with the one or more conditional directives 50 including in response to, for example, the communiqué direction determining module 231 determining that the communiqué 52 is directed to at least one of an email address, an Internet Protocol (IP) address, or a Uniform Resource Locator (URL) associated with the receiving user 32.

In the same or different implementations, operation 430 may include an operation 433 for intercepting the communiqué in accordance with the one or more conditional directives including in response to determining that the communiqué is directed to a telephone number associated with the receiving user as further depicted in FIG. 4d. For instance, the communiqué intercepting module 202 including the communiqué direction determining module 231 of the receiving device 10 of FIGS. 1a and 1b intercepting the communiqué 52 in accordance with the one or more conditional directives 50 including in response to, for example, communiqué direction determining module 231 determining that the communiqué 52 is directed to a telephone number associated with the receiving user 32.

In the same or different implementations, operation 430 may include an operation 434 for intercepting the communiqué in accordance with the one or more conditional directives including in response to determining that the communiqué is directed to a name associated with the receiving user as further depicted in FIG. 4d. For instance, the communiqué intercepting module 202 including the communiqué direction determining module 231 of the receiving device 10 of FIGS. 1a and 1b intercepting the communiqué 52 in accordance with the one or more conditional directives 50 including in response to, for example, the communiqué direction determining module 231 determining that the communiqué 52 is directed to a name (e.g., username) associated with the receiving user 32.

In various implementations, operation 403 for intercepting the communiqué in accordance with the one or more conditional directives to prevent indication of reception of the communiqué from being at least initially presented may include an operation 435 for intercepting the communiqué in accordance with the one or more conditional directives including in response to determining that the communiqué include a subject heading that include one or more specified words or phrases associated with the source entity as further depicted in FIG. 4d. For instance, the communiqué intercepting module 202 of the receiving device 10 of FIGS. 1a and 1b intercepting the communiqué 52 in accordance with the one or more conditional directives 50 including in response to determining that the communiqué 52 (e.g., an email) include a subject heading that include one or more specified (e.g., as specified by the one or more conditional directives 50) words or phrases associated with the source entity 20.

In various implementations, the communiqué receiving operation 302 of FIG. 3 may include an operation 436 for receiving a communiqué that include at least one of textual or numerical data as depicted in FIG. 4e. For instance, the communiqué receiving module 102 of the receiving device 10 of FIGS. 1a and 1b receiving a communiqué 52 that include at least one of textual or numerical data (e.g., in the form of message content data or header data).

The communiqué 52 received through operation 436 may, in some cases, be a visual type of communiqué 52. For example, in some implementations, operation 436 may include an operation 437 for receiving the communiqué including at least one of an email, an instant message (IM), or a text message as further depicted in FIG. 4e. For instance, the communiqué receiving module 102 of the receiving device 10 of FIGS. 1a and 1b receiving the communiqué 52 being a visual type of communiqué 52 including at least one of an email, an instant message (IM), or a text message.

In the same or different implementations, the communiqué receiving operation 302 may include an operation 438 for receiving a communiqué that include at least one of audio or image data as depicted in FIG. 4e. For instance, the communiqué receiving module 102 of the receiving device 10 of FIGS. 1a and 1b receiving a communiqué 52 that include at least one of audio or image data (e.g., in the form of message content data).

In some implementations, operation 438 may further include an operation 439 for receiving the communiqué including at least one of a telephone call, a video call, a Voice over Internet Protocol (VoIP) call, or a voice mail as depicted in FIG. 4e. For instance, the communiqué receiving module 102 of the receiving device 10 of FIGS. 1a and 1b receiving the communiqué 52 including at least one of a telephone call, a video call, a Voice over Internet Protocol (VoIP) call, or a voice mail.

The communiqué 52 that may be received through the communiqué receiving operation 302 of FIG. 3 may be affiliated with any one of a variety of entities in various alternative implementations. For example, in some implementations, the communiqué receiving operation 302 may include an operation 440 for receiving a communiqué that is affiliated with a website and that is directed to the receiving user as depicted in FIG. 4e. For instance, the communiqué receiving module 102 of the receiving device 10 of FIGS. 1a and 1b receiving a communiqué 52 that is affiliated with a website (e.g., an Internet pharmacy, a social website such as a dating website, an adult website, and so forth) that is directed to the receiving user 32.

In some implementations, the communiqué receiving operation 302 may include an operation 441 for receiving a communiqué that is affiliated with an organization and that is directed to the receiving user as depicted in FIG. 4e. For instance, the communiqué receiving module 102 of the receiving device 10 of FIGS. 1a and 1b receiving a communiqué 52 that is affiliated with an organization and that is directed to the receiving user 32.

In some cases, operation 441 may, in turn, include an operation 442 for receiving a communiqué that is affiliated with a business and that is directed to the receiving user as further depicted in FIG. 4e. For instance, the communiqué receiving module 102 of the receiving device 10 of FIGS. 1a and 1b receiving a communiqué 52 that is affiliated with a business and that is directed to the receiving user 32.

In some cases, operation 441 may include an operation 443 for receiving a communiqué that is affiliated with a social or interest group and that is directed to the receiving user as depicted in FIG. 4e. For instance, the communiqué receiving module 102 of the receiving device 10 of FIGS. 1a and 1b receiving a communiqué 52 that is affiliated with a social or interest group and that is directed to the receiving user 32.

In some implementations, the communiqué receiving operation 302 may include an operation 444 for receiving a communiqué that is affiliated with the source entity and that is directed to a receiving user that is a human or robotic user as further depicted in FIG. 4e. For instance, the communiqué receiving module 102 of the receiving device 10 of FIGS. 1a and 1b receiving a communiqué 52 that is affiliated with the source entity 20 and that is directed to a receiving user 32 that is a human or robotic user.

In some implementations, the communiqué receiving operation 302 may include an operation 445 for receiving a communiqué affiliated with the source entity and that is directed to a receiving user that is one of a voicemail service, a text messaging service, or a web-based application service as depicted in FIG. 4e. For instance, the communiqué receiving module 102 of the receiving device 10 of FIGS. 1a and 1b receiving a communiqué 52 affiliated with the source entity 20 and that is directed to a receiving user 32 that is one of a voicemail service, a text messaging service, or a web-based application service.

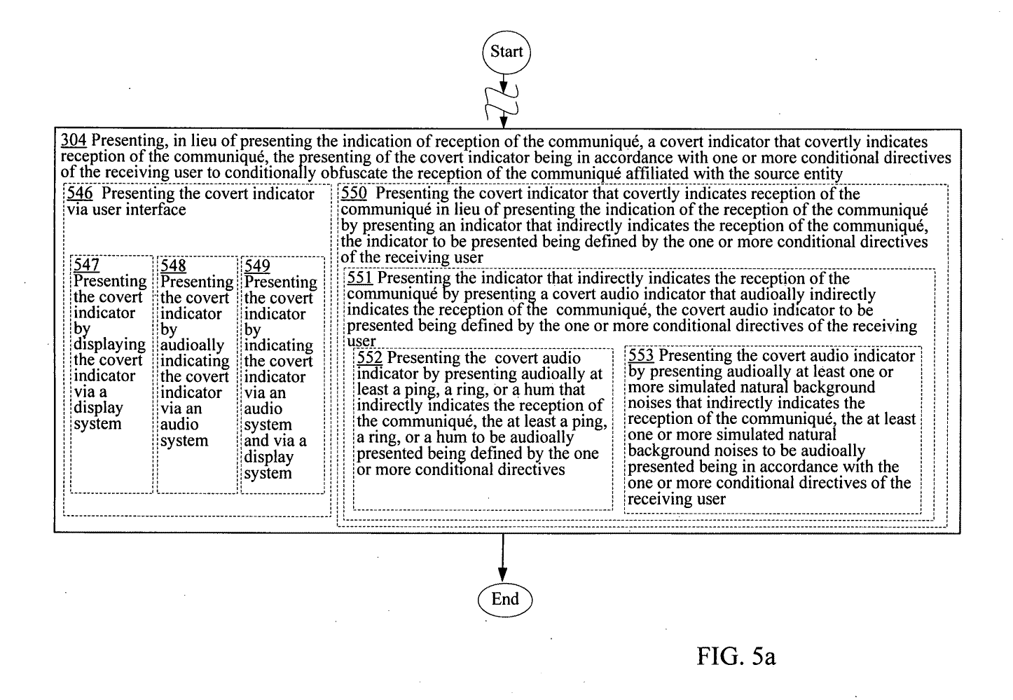

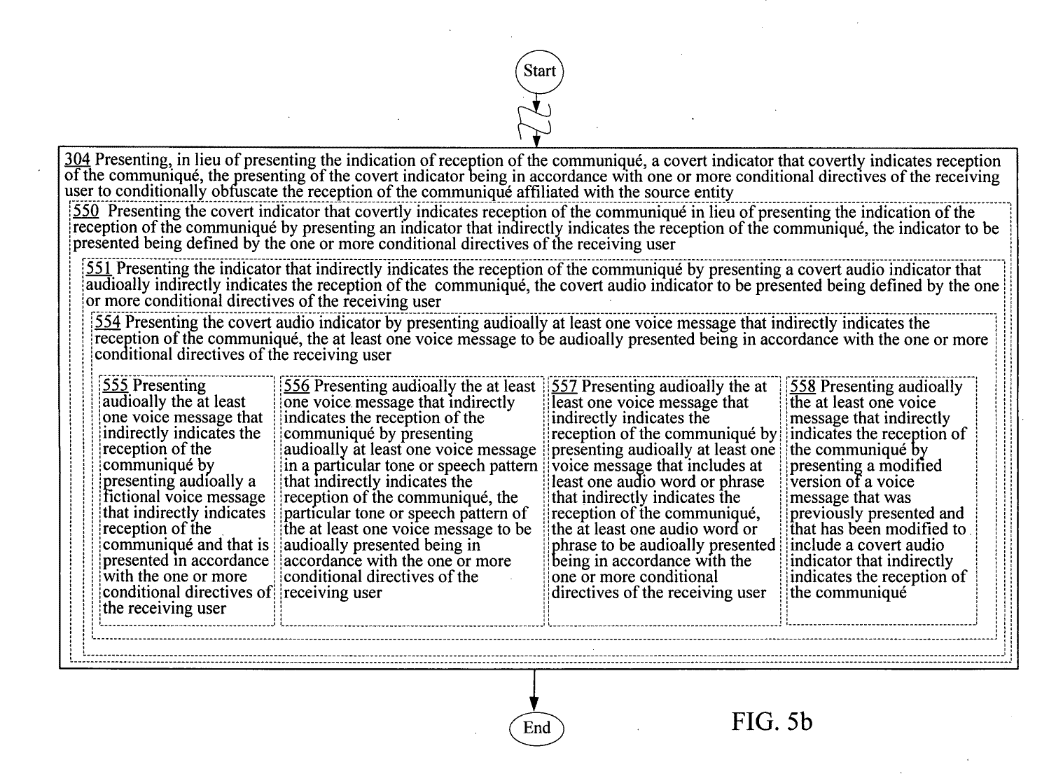

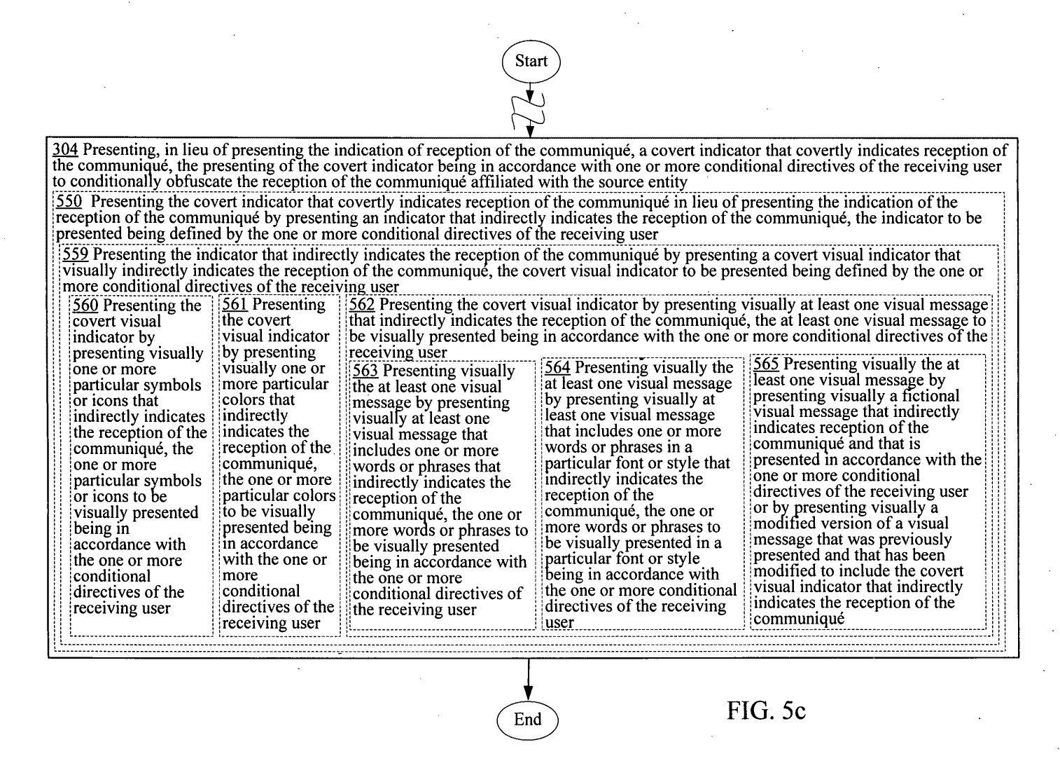

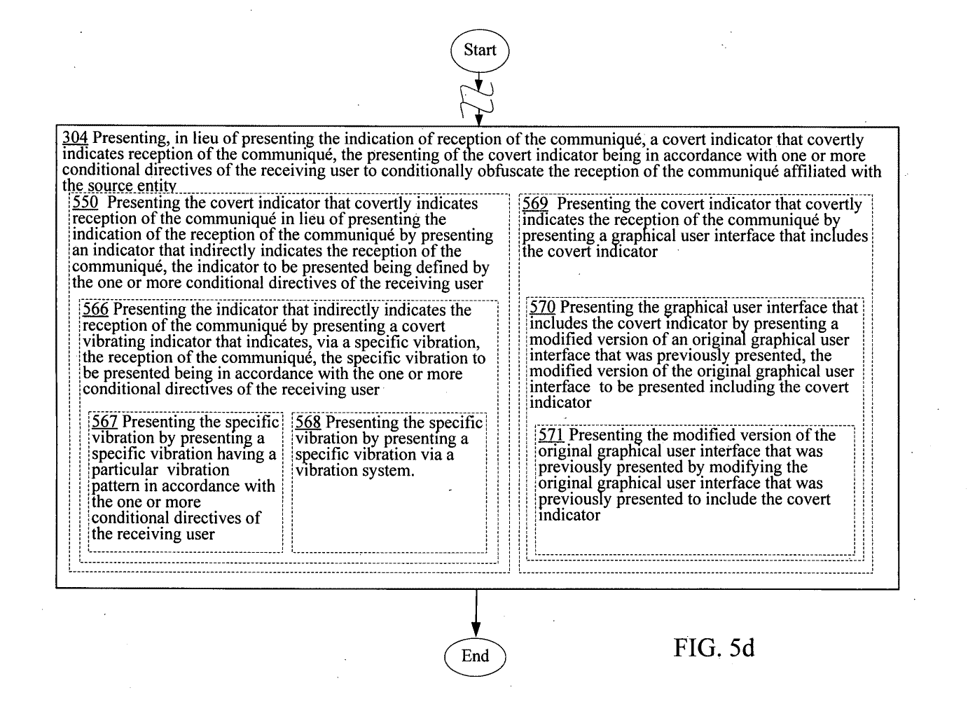

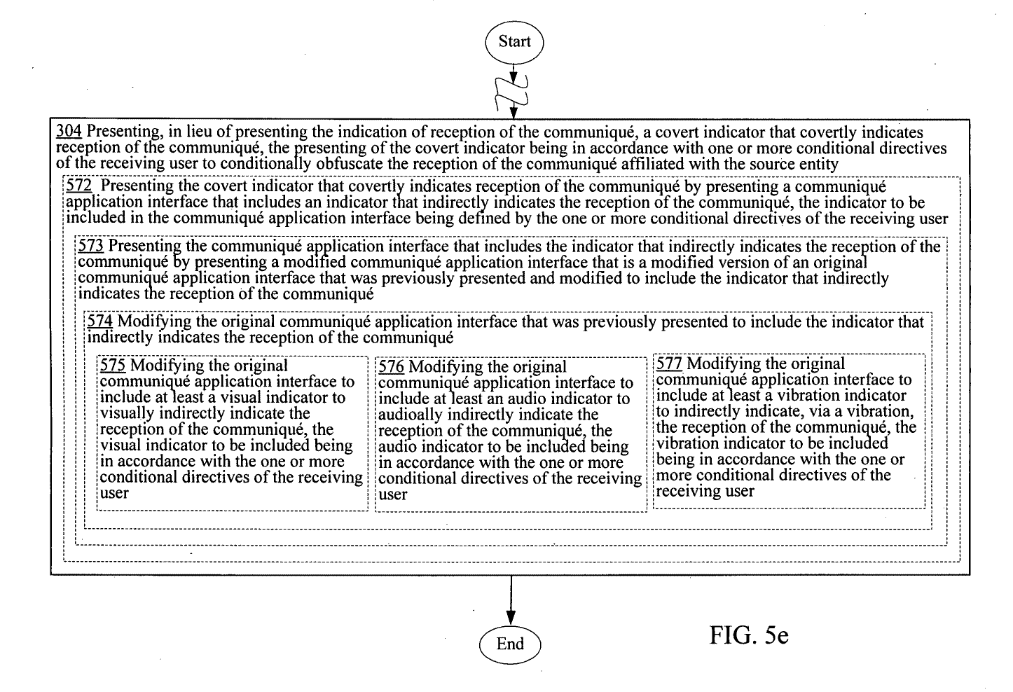

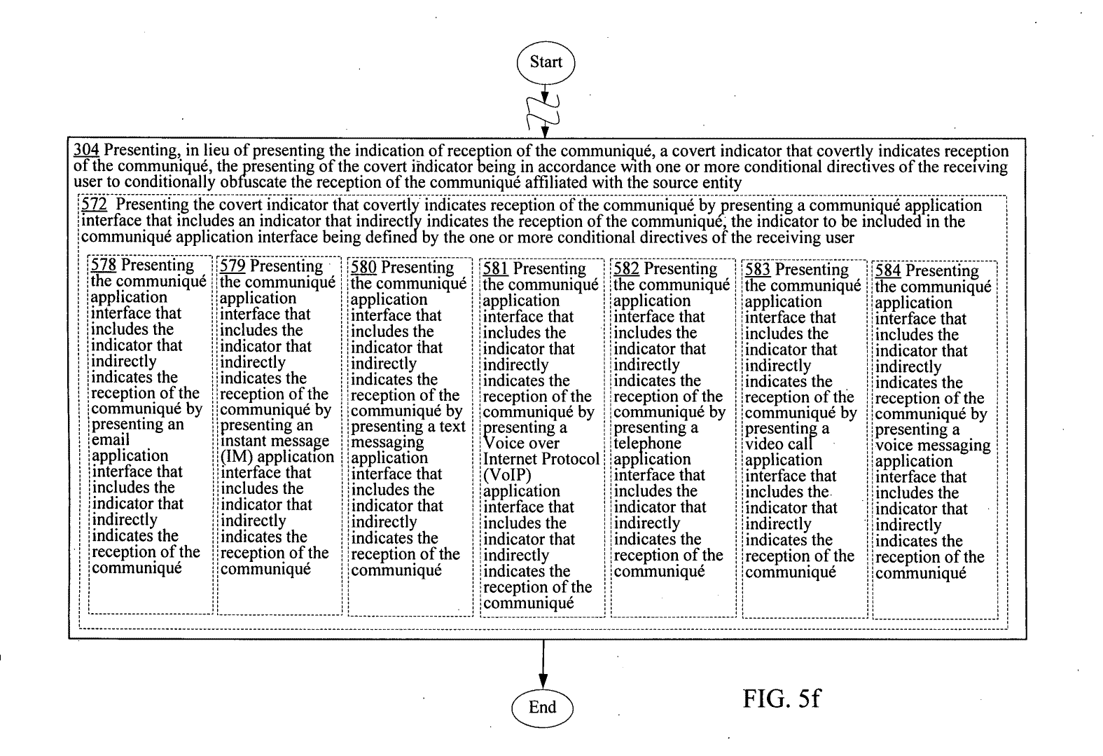

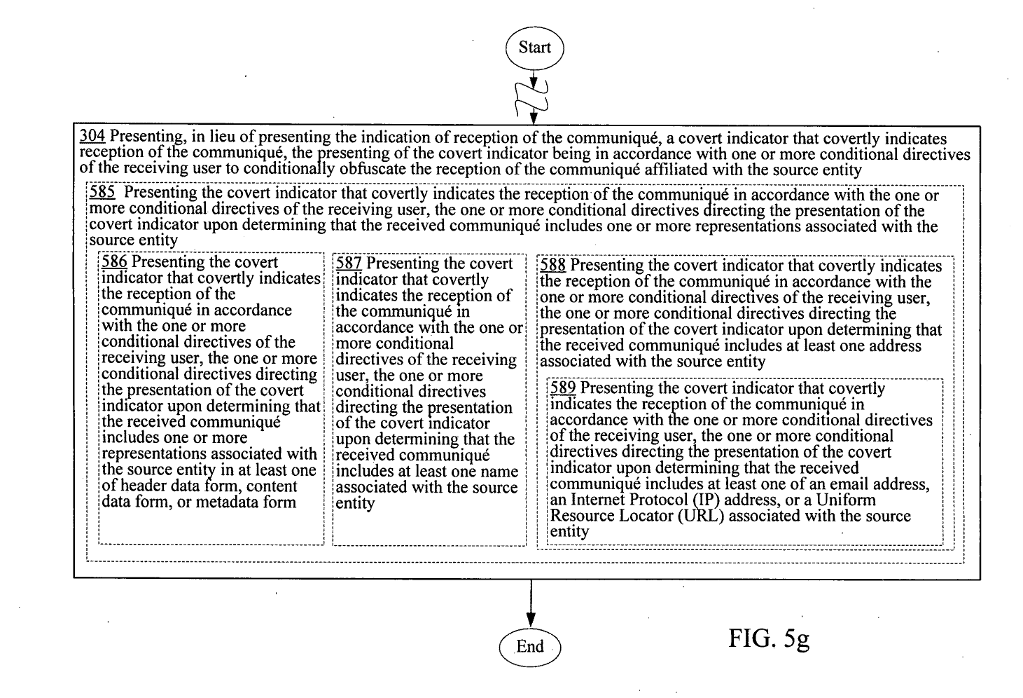

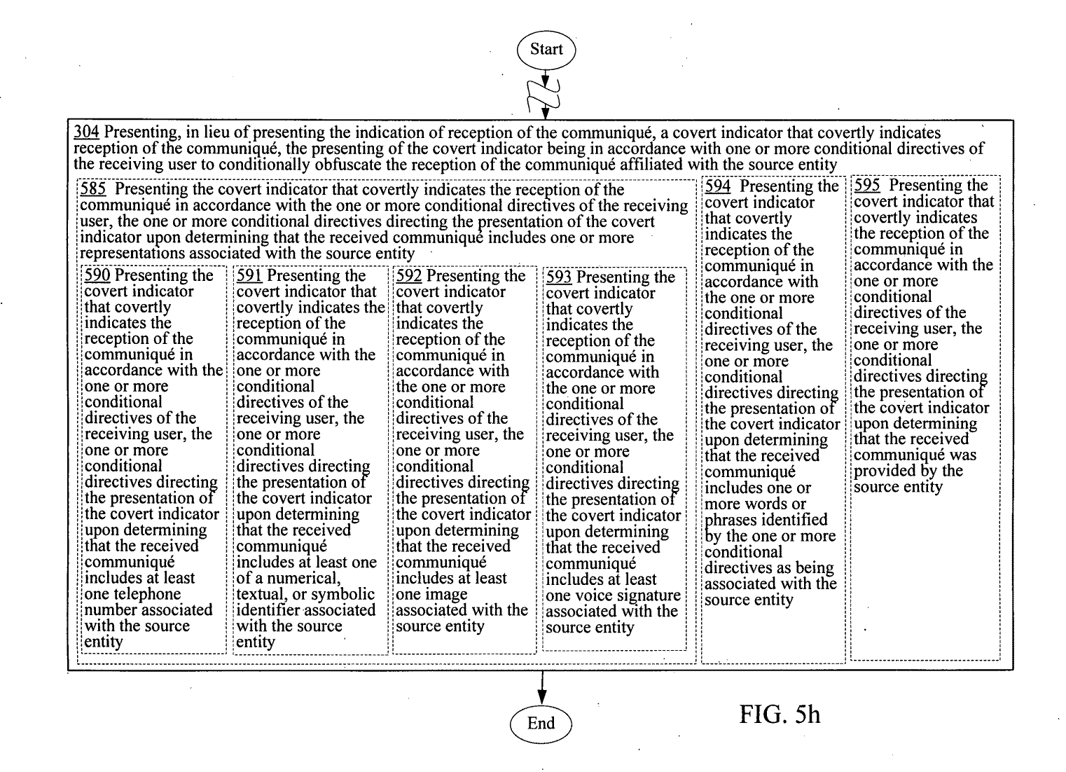

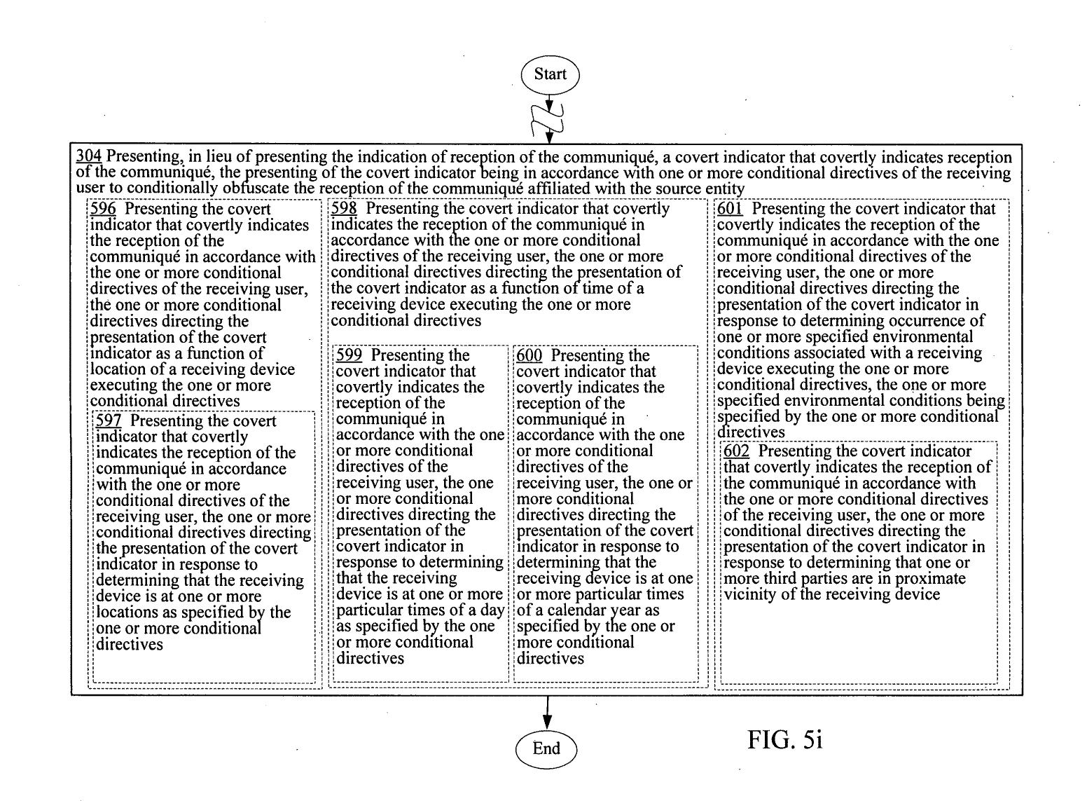

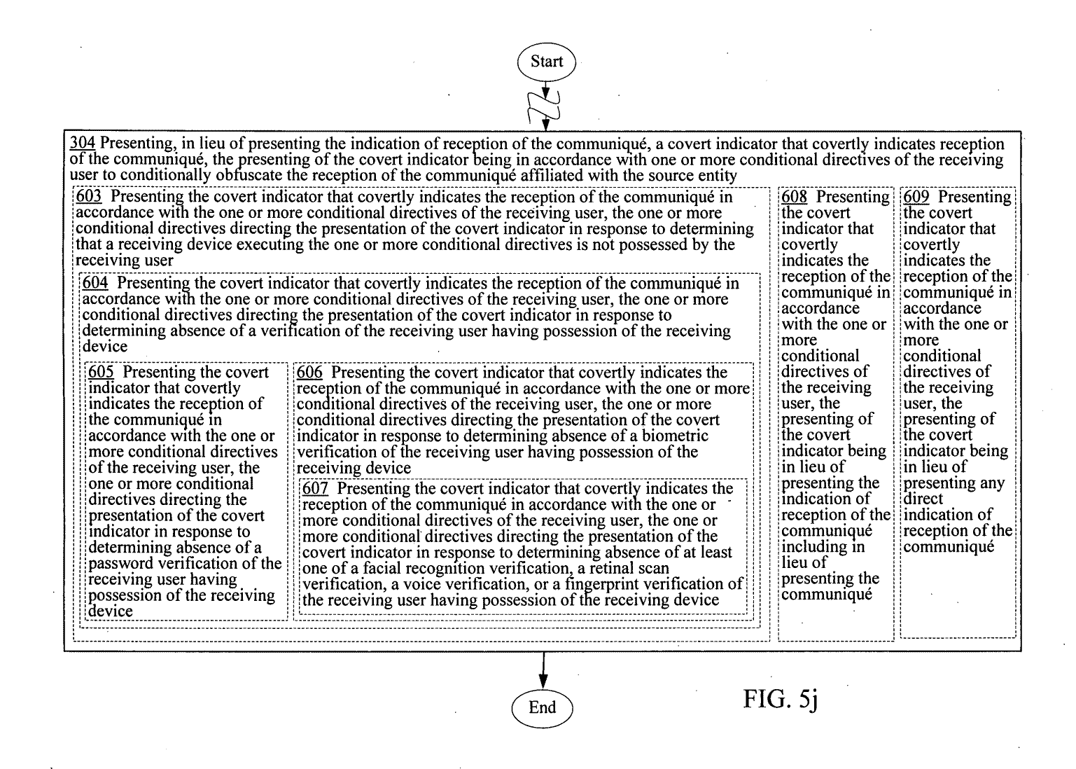

Referring back to the covert indicator presenting operation 304 of FIG. 3, the covert indicator presenting operation 304 similar to the communiqué receiving operation 302 of FIG. 3 may be executed in a number of different ways in various alternative implementations as illustrated in FIGS. 5a, 5b, 5c, 5d, 5e, 5f, 5g, 5h, 5i, and 5j. For example, in some implementations, the communiqué presenting operation 304 of FIG. 3 may include an operation 546 for presenting the covert indicator via user interface as further depicted in FIG. 5a. For instance, the covert indicator presenting module 104 of the receiving device 10 of FIGS. 1a and 1b presenting the covert indicator 54 via user interface 120 (e.g., a display monitor, a touchscreen, one or more speakers, vibration system, and/or other hardware devices for interfacing with a receiving user 32).

As further illustrated in FIG. 5a, the covert indicator 54 that may be presented through operation 546 may be presented through any one or more of a variety of hardware systems in various implementations. For example, in some implementations, operation 546 may further include an operation 547 for presenting the covert indicator by displaying the covert indicator via a display system as further depicted in FIG. 5a. For instance, the covert indicator presenting module 104 of the receiving device 10 of FIGS. 1a and 1b presenting the covert indicator 54 by displaying the covert indicator 54 via a display system 121 (e.g., display monitor such as a LCD or a touchscreen):

In some alternative implementations, operation 546 may include an operation 548 for presenting the covert indicator by audioally indicating the covert indicator via an audio system as further depicted in FIG. 5a. For instance, the covert indicator presenting module 104 of the receiving device 10 of FIGS. 1a and 1b presenting the covert indicator 54 by audioally indicating the covert indicator 54 via an audio system 122 (e.g., one or more speakers).

In still other implementations, operation 546 may include an operation 549 for presenting the covert indicator by indicating the covert indicator via an audio system and via a display system as further depicted in FIG. 5a. For instance, the covert indicator presenting module 104 of the receiving device 10 of FIGS. 1a and 1b presenting the covert indicator 54 by indicating the covert indicator 54 via an audio system 122 and via a display system 121. This may be the case, for example, when the covert indicator 54 to be presented has both a visual component (e.g., a still or moving image) and an audio component (e.g., a voice or a particular music) such as a talking iconic indicator.

In various, implementations, the covert indicator presenting operation 304 of FIG. 3 may include an operation 550 for presenting the covert indicator that covertly indicates reception of the communiqué in lieu of presenting the indication of the reception of the communiqué by presenting an indicator that indirectly indicates the reception of the communiqué, the indicator to be presented being defined by the one or more conditional directives of the receiving user as further depicted in FIG. 5a. For instance, the covert indicator presenting module 104 of the receiving device 10 of FIGS. 1a and 1b presenting the covert indicator 54 that covertly indicates reception of the communiqué 52 in lieu of presenting the indication of the reception of the communiqué 52 by presenting an indicator (e.g., the covert indicator 54) that indirectly indicates the reception of the communiqué 52, the indicator to be presented being defined by the one or more conditional directives 50 of the receiving user 32.

In other words, to present a covert indicator 54 (the meaning of which may not be known by one or more third parties) that when presented would convey a particular meaning (e.g., indicating reception of the communiqué 52 affiliated with the source entity 20) to only certain individuals or entities. For example, such an indicator (e.g., the covert indicator 54), when presented, may covertly indicate the reception of the communiqué 52 to only the receiver user 32 and to other individuals that the receiving user 32 may have confided in regarding the meaning of the covert indicator 54. In order to do so, the presented indicator (e.g., covert indicator 54) may not, at least, directly identify the reception of the communiqué 52, the communiqué 52 itself, the source entity 20 affiliated with the communiqué 52, and/or other aspects of the communiqué 52 that would alert a third party that the communiqué 52 affiliated with the particular source entity 20 has been received. In some cases, the covert nature of the indicator to be presented may be made possible by having the receiving user 32 select the indicator (e.g., the covert indicator 54) to be presented via the one or more conditional directives 50, which the receiving user 32 supplies.

As further illustrated in FIGS. 5a, 5b, 5c, and 5d, operation 550 may include one or more additional operations in various alternative implementations. For example, in some implementations, operation 550 may further include an operation 551 for presenting the indicator that indirectly indicates the reception of the communiqué by presenting a covert audio indicator that audioally indirectly indicates the reception of the communiqué, the covert audio indicator to be presented being defined by the one or more conditional directives of the receiving user as depicted in FIG. 5a. For instance, the covert indicator presenting module 104 including the covert audio indicator presenting module 232 (see FIG. 2b) of the receiving device 10 of FIGS. 1a and 1b presenting the indicator (e.g., the covert indicator 54) that indirectly indicates the reception of the communiqué 52 by having the covert audio indicator presenting module 232 presenting via the audio system 122 a covert audio indicator that audioally indirectly indicates the reception of the communiqué 52, the covert audio indicator to be presented (e.g., audioally presented via one or more speakers) being defined by the one or more conditional directives 50 of the receiving user 32.

In some cases, operation 551 may further include an operation 552 for presenting the covert audio indicator by presenting audioally at least a ping, a ring, or a hum that indirectly indicates the reception of the communiqué, the at least a ping, a ring, or a hum to be audioally presented being defined by the one or more conditional directives as depicted in FIG. 5a. For instance, the covert indicator presenting module 104 including the covert audio indicator presenting module 232 (see FIG. 2b) of the receiving device 10 of FIGS. 1a and 1b presenting the covert audio indicator by presenting audioally at least a ping, a ring, or a hum that indirectly indicates the reception of the communiqué 52, the at least a ping, a ring, or a hum to be audioally presented being defined by the one or more conditional directives 50.

In the same or different implementations, operation 551 may further include an operation 553 for presenting the covert audio indicator by presenting audioally at least one or more simulated natural background noises that indirectly indicates the reception of the communiqué, the at least one or more simulated natural background noises to be audioally presented being in accordance with the one or more conditional directives of the receiving user as further depicted in FIG. 5a. For instance, the covert indicator presenting module 104 including the covert audio indicator presenting module 232 of the receiving device 10 of FIGS. 1a and 1b presenting the covert audio indicator (e.g., covert indicator 54) by presenting audioally at least one or more simulated natural background noises (e.g., dog barking, noise of a train or a truck passing, sound of someone speaking in the background, and so forth) that indirectly indicates the reception of the communiqué 52 (e.g., a telephone call or a voice message), the at least one or more simulated natural background noises to be audioally presented (e.g., via an audio system 122 including one or more speakers) being in accordance with the one or more conditional directives 50 of the receiving user 32. Note that in some cases, the one or more simulated natural background noises may merely be recordings of natural background noise. In order to present such a covert audio indicator, in some implementations, the covert audio indicator may be combined with a voice message that may have been previously presented such as an actual or “real” voice message previously recorded or a fictional voice message.

In the same or different implementations, operation 551 may further include an operation 554 for presenting the covert audio indicator by presenting audioally at least one voice message that indirectly indicates the reception of the communiqué, the at least one voice message to be audioally presented being in accordance with the one or more conditional directives of the receiving user as depicted in FIG. 5b. For instance, the covert audio indicator presenting module 232 including the voice message presenting module 233 (see FIG. 2b) of the receiving device 10 of FIGS. 1a and 1b presenting the covert audio indicator (e.g., covert indicator 54) by having the voice message presenting module 233 presenting audioally at least one voice message that indirectly indicates (e.g., via simulated natural background noise or the use of a particular phrase or word in the voice message) the reception of the communiqué 52, the at least one voice message to be audioally presented being in accordance with the one or more conditional directives 50 of the receiving user 32.

As further illustrated in FIG. 5b, operation 554 may further include one or more additional operations in various alternative implementations. For example, in some implementations, operation 554 may include an operation 555 for presenting audioally the at least one voice message that indirectly indicates the reception of the communiqué by presenting audioally a fictional voice message that indirectly indicates reception of the communiqué and that is presented in accordance with the one or more conditional directives of the receiving user as depicted in FIG. 5b. For instance, the voice message presenting module 233 including the fictional voice message presenting module 234 (see FIG. 2b) of the receiving device 10 of FIGS. 1a and 1b presenting audioally the at least one voice message that indirectly indicates the reception of the communiqué by having the fictional voice message presenting module 234 presenting audioally a fictional voice message (e.g., covert indicator 54) that indirectly indicates reception of the communiqué 52 and that is presented in accordance with the one or more conditional directives 50 of the receiving user 32.

The fictional voice message to be presented may be a fictional voice message from a fictional third party, or a fictional operational audio message related to a communiqué application (e.g., an email application) or other types of applications (e.g., an operating system such as Microsoft Vista or Window 7.0). The fictional voice message may indirectly indicate to the receiving user 32 the reception of the communiqué 52 in any number of ways since the fictional voice message (e.g., covert indicator 54) will be presented in accordance with the one or more conditional directives 50 provided by the receiving user 32. For example, in some cases, the mere presentation of the fictional voice message may be sufficient to alert the receiving user 32 of the reception of the communiqué 52. Alternatively, insertion of particular words or phrases or insertion of particular simulated background noise (e.g., passing train) into the fictional voice message may be employed in order to alert the receiving user 32 of the reception of the communiqué 52.

In the same or different implementations, operation 554 may also include an operation 556 for presenting audioally the at least one voice message that indirectly indicates the reception of the communiqué by presenting audioally at least one voice message in a particular tone or speech pattern that indirectly indicates the reception of the communiqué, the particular tone or speech pattern of the at least one voice message to be audioally presented being in accordance with the one or more conditional directives of the receiving user as further depicted in FIG. 5b. For instance, the voice message presenting module 233 of the receiving device 10 of FIGS. 1a and 1b presenting audioally the at least one voice message that indirectly indicates the reception of the communiqué 52 by presenting audioally at least one voice message in a particular tone or speech pattern (e.g., covert indicator 54) that indirectly indicates the reception of the communiqué 52, the particular tone or speech pattern of the at least one voice message to be audioally presented being in accordance with the one or more conditional directives 50 of the receiving user 32.

In the same or different implementations, operation 554 may also include an operation 557 for presenting audioally the at least one voice message that indirectly indicates the reception of the communiqué by presenting audioally at least one voice message that includes at least one audio word or phrase that indirectly indicates the reception of the communiqué, the at least one audio word or phrase to be audioally presented being in accordance with the one or more conditional directives of the receiving user as depicted in FIG. 5b. For instance, the voice message presenting module 233 of the receiving device 10 of FIGS. 1a and 1b presenting audioally the at least one voice message that indirectly indicates the reception of the communiqué 52 by presenting audioally at least one voice message that includes at least one audio word or phrase (e.g., covert indicator 54) that indirectly indicates the reception of the communiqué 52, the at least one audio word or phrase to be audioally presented being in accordance with the one or more conditional directives 50 of the receiving user 32.

In the same or different implementations, operation 554 may also include an operation 558 for presenting audioally the at least one voice message that indirectly indicates the reception of the communiqué by presenting a modified version of a voice message that was previously presented and that has been modified to include a covert audio indicator that indirectly indicates the reception of the communiqué as further depicted in FIG. 5b. For instance, the voice message presenting module 233 including the modified voice message presenting module 235 (see FIG. 2b) of the receiving device 10 of FIGS. 1a and 1b presenting audioally the at least one voice message that indirectly indicates the reception of the communiqué 52 by having the modified voice message presenting module 235 presenting a modified version of a voice message that was previously presented and that has been modified to include a covert audio indicator (e.g., words or phrases, or simulated background noise) that indirectly indicates the reception of the communiqué 52. For these implementations, the voice message that is modified may have been, for example, a real (non-fictional) voice message that was previously from a third party, a fictional voice message, or a “real” or fictional operational message related to operational aspects of the receiving device 10.

In some cases, operation 550 for presenting the covert indicator that covertly indicates reception of the communiqué in lieu of presenting the indication of the reception of the communiqué by presenting an indicator that indirectly indicates the reception of the communiqué, the indicator to be presented being defined by the one or more conditional directives of the receiving user may include an operation 559 for presenting the indicator that indirectly indicates the reception of the communiqué by presenting a covert visual indicator that visually indirectly, indicates the reception of the communiqué, the covert visual indicator to be presented being defined by the one or more conditional directives of the receiving user as depicted in FIG. 5c. For instance, the covert indicator presenting module 104 including the covert visual indicator presenting module 236 (see FIG. 2b) of receiving device 10 of FIGS. 1a and 1b presenting the indicator (e.g., covert indicator 54) that indirectly indicates the reception of the communiqué 52 by having the covert visual indicator presenting module 236 presenting a covert visual indicator that visually indirectly indicates the reception of the communiqué 52, the covert visual indicator to be presented being defined by the one or more conditional directives 50 of the receiving user 32. As will be further described herein, a variety of covert visual indicators may be used in various alternative implementations in order to indirectly indicate (e.g., to the receiving user 32) the reception of the communiqué 52.

For example, in some implementations, operation 559 may include an operation 560 for presenting the covert visual indicator by presenting visually one or more particular symbols or icons that indirectly indicates the reception of the communiqué, the one or more particular symbols or icons to be visually presented being in accordance with the one or more conditional directives of the receiving user as further depicted in FIG. 5c. For instance, the covert visual indicator presenting module 236 of the receiving device 10 of FIGS. 1a and 1b presenting the covert visual indicator (e.g., covert indicator 54) by presenting visually (e.g., via a display system 121 including a display monitor or a touchscreen) one or more particular symbols or icons that indirectly indicates the reception of the communiqué 52, the one or more particular symbols or icons to be visually presented being in accordance with the one or more conditional directives 50 of the receiving user 32.

In the same or different implementations, operation 559 may also include an operation 561 for presenting the covert visual indicator by presenting visually one or more particular colors that indirectly indicates the reception of the communiqué, the one or more particular colors to be visually presented being in accordance with the one or more conditional directives of the receiving user as further depicted in FIG. 5c. For instance, the covert visual indicator presenting module 236 of the receiving device 10 of FIGS. 1a and 1b presenting the covert visual indicator (e.g., covert indicator 54) by presenting visually (e.g., via a display system 121 including a display monitor or a touchscreen) one or more particular colors that indirectly indicates the reception of the communiqué 52, the one or more particular colors to be visually presented being in accordance with the one or more conditional directives 50 of the receiving user 32. The one or more particular colors to be presented may be in the form of background colors of a display screen or in the form of colors for one or more visual items (e.g., icons, lettering, or figures) that are displayed through a display screen.

In the same or different implementations, operation 559 may also include an operation 562 for presenting the covert visual indicator by presenting visually at least one visual message that indirectly indicates the reception of the communiqué, the at least one visual message to be visually presented being in accordance with the one or more conditional directives of the receiving user as further depicted in FIG. 5c. For instance, the covert visual indicator presenting module 236 including the visual message presenting module 237 (see FIG. 2b) of the receiving device 10 of FIGS. 1a and 1b presenting the covert visual indicator (e.g., covert indicator 54) by having the visual message presenting module 237 presenting visually (e.g., via a display system 121 including a display monitor or a touchscreen) at least one visual message that indirectly indicates the reception of the communiqué 52, the at least one visual message to be visually presented being in accordance with the one or more conditional directives 50 of the receiving user 32. The visual message to be presented may be fictional message (e.g., a message created for indirectly indicating reception of the communiqué 52) or non-fictional message (e.g., an actual message that may or may not have been modified). The visual message to be presented may also be in the form of a communiqué message such as an email or text message, or an operational message related to, for example, a communiqué application (e.g., instant messaging application), or an operational message related to an operating system (e.g., Symbian OS or Windows 7).

As further illustrated in FIG. 5c, operation 562 may further include one or more additional operations in various implementations. For example, in some implementations, operation 562 may include an operation 563 for presenting visually the at least one visual message by presenting visually at least one visual message that includes one or more words or phrases that indirectly indicates the reception of the communiqué, the one or more words or phrases to be visually presented being in accordance with the one or more conditional directives of the receiving user as further depicted in FIG. 5c. For instance, the visual message presenting module 237 of the receiving device 10 of FIGS. 1a and 1b presenting visually (e.g., via display system 121) the at least one visual message by presenting visually at least one visual message that includes one or more words or phrases (e.g., covert indicator 54) that indirectly indicates the reception of the communiqué 52, the one or more words or phrases to be visually presented being in accordance with the one or more conditional directives 50 of the receiving user 32.

In the same or different implementations, operation 562 may also include an operation 564 for presenting visually the at least one visual message by presenting visually at least one visual message that includes one or more words or phrases in a particular font or style that indirectly indicates the reception of the communiqué, the one or more words or phrases to be visually presented in a particular font or style being in accordance with the one or more conditional directives of the receiving user as further depicted in FIG. 5c. For instance, the visual message presenting module 237 of the receiving device 10 of FIGS. 1a and 1b presenting visually the at least one visual message by presenting visually (e.g., via display system 121 including a display monitor or a touchscreen) at least one visual message that includes one or more words or phrases in a particular font or style that indirectly indicates the reception of the communiqué 52, the one or more words or phrases to be visually presented in a particular font or style being in accordance with the one or more conditional directives 50 of the receiving user 32.

In the same or different implementations, operation 562 may also include an operation 565 for presenting visually the at least one visual message by presenting visually a fictional visual message that indirectly indicates reception of the communiqué and that is presented in accordance with the one or more conditional directives of the receiving user or by presenting visually a modified version of a visual message that was previously presented and that has been modified to include the covert visual indicator that indirectly indicates the reception of the communiqué as further depicted in FIG. 5c. For instance, the visual message presenting module 237 including the fictional visual message presenting module 238 or the modified visual message presenting module 239 (see FIG. 2b) of the receiving device 10 of FIGS. 1a and 1b presenting visually (e.g., via display system 121) the at least one visual message by having the fictional visual message presenting module 238 presenting visually a fictional visual message (a message that was created for this purpose) that indirectly indicates reception of the communiqué 52 and that is presented in accordance with the one or more conditional directives 50 of the receiving user 32 or by having the modified visual message presenting module 239 presenting visually a modified version of a visual message that was previously presented and that has been modified to include the covert visual indicator (e.g., background color, particular symbols or icons, one or more particular words or phrases, and so forth) that indirectly indicates the reception of the communiqué 52.

Referring now to FIG. 5d, the operation 550 for presenting the covert indicator that covertly indicates reception of the communiqué in lieu of presenting the indication of the reception of the communiqué by presenting an indicator that indirectly indicates the reception of the communiqué, the indicator to be presented being defined by the one or more conditional directives of the receiving user may include, in various implementations, an operation 566 for presenting the indicator that indirectly indicates the reception of the communiqué by presenting a covert vibrating indicator that indicates, via a specific vibration, the reception of the communiqué, the specific vibration to be presented being in accordance with the one or more conditional directives of the receiving user. For instance, the covert indicator presenting module 104 including the covert vibrating indicator presenting module 240 (see FIG. 2b) of the receiving device 10 of FIGS. 1a and 1b presenting the indicator (e.g., covert indicator 54) that indirectly indicates the reception of the communiqué 52 by having the covert vibrating indicator presenting module 240 presenting a covert vibrating indicator that indicates, via a specific vibration, the reception of the communiqué 52, the specific vibration (e.g., specific pattern of vibration or specific vibration strength) to be presented being in accordance with the one or more conditional directives 50 of the receiving user 32. In some cases, the specific vibration that may be generated may be presented in conjunction with the presentation of one or more other covert indicators (e.g., audio or visual indicators that covertly or indirectly indicates the reception of the communiqué 52).

As further illustrated in FIG. 5d, operation 566 may further include one or more additional operations in various implementations. For example, in some implementations, operation 566 may include an operation 567 for presenting the specific vibration by presenting a specific vibration having a particular vibration pattern in accordance with the one or more conditional directives of the receiving user as further depicted in FIG. 5d. For instance, the covert vibrating indicator presenting module 240 of the receiving device 10 of FIGS. 1a and 1b presenting the specific vibration by presenting a specific vibration having a particular vibration pattern in accordance with the one or more conditional directives 50 of the receiving user 32.

In the same or different implementations, operation 566 may include an operation 568 for presenting the specific vibration by presenting a specific vibration via a vibration system as further depicted in FIG. 5d. For instance, the covert vibrating indicator presenting module 240 of the receiving device 10 of FIGS. 1a and 1b presenting the specific vibration by presenting a specific vibration (e.g., specific vibration rhythm) via a vibration system 123.

Referring back to FIG. 5d, in various implementations, the covert indicator presenting operation 304 of FIG. 3 may include an operation 569 for presenting the covert indicator that covertly indicates the reception of the communiqué by presenting a graphical user interface that includes the covert indicator as further depicted in FIG. 5d. For instance, the covert indicator presenting module 104 including the graphical user interface presenting module 241 (see FIG. 2b) of the receiving device 10 of FIGS. 1a and 1b presenting the covert indicator 54 that covertly indicates the reception of the communiqué 52 by having the graphical user interface presenting module 241 presenting a graphical user interface (e.g., an operating system (OS) application interface such as the interface for Google's Android, Symbian OS interface, Vista Smartphone interface, Windows 7 interface, and so forth) that includes the covert indicator 54 (e.g., a covert audio indicator, a covert visual indicator, and/or a covert vibrating indicator).

As further illustrated in FIG. 5d, operation 569 may further include one or more additional operations in various implementations. For example, in some cases, operation 569 may include an operation 570 for presenting the graphical user interface that includes the covert indicator by presenting a modified version of an original graphical user interface that was previously presented, the modified version of the original graphical user interface to be presented including the covert indicator as further depicted in FIG. 5d. For instance, the graphical user interface presenting module 241 including the modified graphical user interface presenting module 242 (see FIG. 2b) of the receiving device 10 of FIGS. 1a and 1b presenting the graphical user interface (GUI) that includes the covert indicator 54 by having the modified graphical user interface presenting module 242 presenting a modified version of an original graphical user interface that was previously presented through, for example, a display system 121, the modified version of the original graphical user interface to be presented including the covert indicator 54 (e.g., a covert visual indicator, a covert audio indicator, and/or a covert vibrating indicator that may be presented in conjunction with the graphical user interface).

In some cases, operation 570 may, in turn, include an operation 571 for presenting the modified version of the original graphical user interface that was previously presented by modifying the original graphical user interface that was previously presented to include the covert indicator as further depicted in FIG. 5d. For instance, the modified graphical user interface presenting module 242 including the graphical user interface modifying module 280 (see FIG. 2b) of the receiving device 10 of FIGS. 1a and 1b presenting the modified version of the original graphical user interface that was previously presented by having the graphical user interface modifying module 280 modifying the original graphical user interface that was previously presented to include the covert indicator 54.

Turning now to FIG. 5e, in various implementations, the covert indicator presenting operation 304 of FIG. 3 may include an operation 572 for presenting the covert indicator that covertly indicates reception of the communiqué by presenting a communiqué application interface that includes an indicator that indirectly indicates the reception of the communiqué, the indicator to be included in the communiqué application interface being defined by the one or more conditional directives of the receiving user. For instance, the covert indicator presenting module 104 including the communiqué application interface presenting module 243 (see FIG. 2b) of the receiving device 10 of FIGS. 1a and 1b presenting the covert indicator 54 that covertly indicates reception of the communiqué 52 by having the communiqué application interface presenting module 243 presenting a communiqué application interface (e.g., email application interface or a VoIP application interface) that includes an indicator that indirectly indicates the reception of the communiqué 52, the indicator to be included in the communiqué application interface being defined by the one or more conditional directives 50 of the receiving user 32.

As further illustrated in FIG. 5e, operation 572 may further include one or more additional operations in various implementations. For example, in some implementations, operation 572 may further include an operation 573 for presenting the communiqué application interface that includes the indicator that indirectly indicates the reception of the communiqué by presenting a modified communiqué application interface that is a modified version of an original communiqué application interface that was previously presented and modified to include the indicator that indirectly indicates the reception of the communiqué as further depicted in FIG. 5e. For instance, the communiqué application interface presenting module 243 including the modified communiqué application interface presenting module 244 (see FIG. 2b) of the receiving device 10 of FIGS. 1a and 1b presenting the communiqué application interface that includes the indicator that indirectly indicates the reception of the communiqué 52 by having the modified communiqué application interface presenting module 244 presenting a modified communiqué application interface that is a modified version of an original communiqué application interface that was previously presented and modified to include the indicator (e.g., covert indicator 54) that indirectly indicates the reception of the communiqué 52. Note that in various implementations the modified communiqué application interface to be presented may be a visual interface and/or an audio interface.

In various implementations, operation 573 may, in turn, further include an operation 574 for modifying the original communiqué application interface that was previously presented to include the indicator that indirectly indicates the reception of the communiqué as further depicted in FIG. 5e. For instance, the communiqué application interface modifying module 245 (see FIG. 2b) of the receiving device 10 of FIGS. 1a and 1b modifying the original communiqué application interface (e.g., an email application interface, an IM application interface, an VoIP application interface, and so forth) that was previously presented to include the indicator (e.g., covert indicator 54) that indirectly indicates the reception of the communiqué 52.

In some implementations, operation 574 may further include an operation 575 for modifying the original communiqué application interface to include at least a visual indicator to visually indirectly indicate the reception of the communiqué, the visual indicator to be included being in accordance with the one or more conditional directives of the receiving user as depicted in FIG. 5e. For instance, the communiqué application interface modifying module 245 of the receiving device 10 of FIGS. 1a and 1b modifying the original communiqué application interface to include at least a visual indicator (e.g., a color, a symbol, an icon, a word, and/or a phrase) to visually indirectly indicate the reception of the communiqué 52, the visual indicator to be included being in accordance with the one or more conditional directives 50 of the receiving user 32.

In the same or different implementations, operation 574 may include an operation 576 for modifying the original communiqué application interface to include at least an audio indicator to audioally indirectly indicate the reception of the communiqué, the audio indicator to be included being in accordance with the one or more conditional directives of the receiving user as further depicted in FIG. 5e. For instance, the communiqué application interface modifying module 245 of the receiving device 10 of FIGS. 1a and 1b modifying the original communiqué application interface to include at least an audio indicator (e.g., a ping, a buzz, a simulated natural background noise, words/phrases, and so forth) to audioally indirectly indicate the reception of the communiqué 52, the audio indicator to be included being in accordance with the one or more conditional directives 50 of the receiving user 32.

In the same or different implementations, operation 574 may include an operation 577 for modifying the original communiqué application interface to include at least a vibration indicator to indirectly indicate, via a vibration, the reception of the communiqué, the vibration indicator to be included being in accordance with the one or more conditional directives of the receiving user as depicted in FIG. 5e. For instance, the communiqué application interface modifying module 245 of the receiving device 10 of FIGS. 1a and 1b modifying the original communiqué application interface to include at least a vibration indicator to indirectly indicate, via a vibration, the reception of the communiqué 52, the vibration indicator to be included being in accordance with the one or more conditional directives 50 of the receiving user 32. In some cases, the vibration indicator may be presented in conjunction with the presentation of other covert indicators 54 (e.g., visual and/or audio indicators).

The communiqué application interface that may be presented through operation 572 of FIG. 5e may be any one of a variety of communiqué application interfaces that may be used in order to access a variety of communiqué types (e.g., text messages, IMs, emails, VoIP calls, and so forth). For example, in some cases, operation 572 may include an operation 578 for presenting the communiqué application interface that includes the indicator that indirectly indicates the reception of the communiqué by presenting an email application interface that includes the indicator that indirectly indicates the reception of the communiqué as depicted in FIG. 5f. For instance, the communiqué application interface presenting module 243 (see FIG. 2b) of the receiving device 10 of FIGS. 1a and 1b presenting the communiqué application interface that includes the indicator (e.g., covert indicator 54) that indirectly indicates the reception of the communiqué 52 by presenting an email application interface that includes the indicator (e.g., a covert audio indicator, a covert visual indicator, and/or a covert vibration indicator) that indirectly indicates the reception of the communiqué 52.

In some implementations, operation 572 may include an operation 579 for presenting the communiqué application interface that includes the indicator that indirectly indicates the reception of the communiqué by presenting an instant message (IM) application interface that includes the indicator that indirectly indicates the reception of the communiqué as depicted in FIG. 5f. For instance, the communiqué application interface presenting module 243 of the receiving device 10 of FIGS. 1a and 1b presenting the communiqué application interface that includes the indicator (e.g., covert indicator 54) that indirectly indicates the reception of the communiqué 52 by presenting an instant message (IM) application interface that includes the indicator (e.g., covert audio indicator, covert visual indicator, and/or covert vibration indicator) that indirectly indicates the reception of the communiqué 52.

In some implementations, operation 572 may include an operation 580 for presenting the communiqué application interface that includes the indicator that indirectly indicates the reception of the communiqué by presenting a text messaging application interface that includes the indicator that indirectly indicates the reception of the communiqué as further depicted in FIG. 5f. For instance, the communiqué application interface presenting module 243 of the receiving device 10 of FIGS. 1a and 1b presenting the communiqué application interface that includes the indicator (e.g., covert indicator 54) that indirectly indicates the reception of the communiqué 52 by presenting a text messaging application interface that includes the indicator (e.g., covert audio indicator, covert visual indicator, and/or covert vibration indicator) that indirectly indicates the reception of the communiqué 52.

In some implementations, operation 572 may include an operation 581 for presenting the communiqué application interface that includes the indicator that indirectly indicates the reception of the communiqué by presenting a Voice over Internet Protocol (VoIP) application interface that includes the indicator that indirectly indicates the reception of the communiqué as depicted in FIG. 5f. For instance, the communiqué application interface presenting module 243 of the receiving device 10 of FIGS. 1a and 1b presenting the communiqué application interface that includes the indicator (e.g., covert indicator 54) that indirectly indicates the reception of the communiqué 52 by presenting a Voice over Internet Protocol (VoIP) application interface that includes the indicator (e.g., covert audio indicator, covert visual indicator, and/or covert vibration indicator) that indirectly indicates the reception of the communiqué 52.

In some implementations, operation 572 may include an operation 582 for presenting the communiqué application interface that includes the indicator that indirectly indicates the reception of the communiqué by presenting a telephone application interface that includes the indicator that indirectly indicates the reception of the communiqué as further depicted in FIG. 5f. For instance, the communiqué application interface presenting module 243 of the receiving device 10 of FIGS. 1a and 1b presenting the communiqué application interface that includes the indicator (e.g., covert indicator 54) that indirectly indicates the reception of the communiqué 52 by presenting a telephone application interface that includes the indicator (e.g., covert audio indicator, covert visual indicator, and/or covert vibration indicator) that indirectly indicates the reception of the communiqué 52.

In some implementations, operation 572 may include an operation 583 for presenting the communiqué application interface that includes the indicator that indirectly indicates the reception of the communiqué by presenting a video call application interface that includes the indicator that indirectly indicates the reception of the communiqué as further depicted in FIG. 5f. For instance, the communiqué application interface presenting module 243 of the receiving device 10 of FIGS. 1a and 1b presenting the communiqué application interface that includes the indicator (e.g., covert indicator 54) that indirectly indicates the reception of the communiqué 52 by presenting a video call application interface that includes the indicator (e.g., covert audio indicator, covert visual indicator, and/or covert vibration indicator) that indirectly indicates the reception of the communiqué 52.

In some implementations, operation 572 may include an operation 584 for presenting the communiqué application interface that includes the indicator that indirectly indicates the reception of the communiqué by presenting a voice messaging application interface that includes the indicator that indirectly indicates the reception of the communiqué as depicted in FIG. 5f. For instance, the communiqué application interface presenting module 243 of the receiving device 10 of FIGS. 1a and 1b presenting the communiqué application interface that includes the indicator (e.g., covert indicator 54) that indirectly indicates the reception of the communiqué 52 by presenting a voice messaging application interface that includes the indicator (e.g., covert audio indicator, covert visual indicator, and/or covert vibration indicator) that indirectly indicates the reception of the communiqué 52.

The one or more conditional directives 50 of the receiving user 32 that may be the basis for executing the covert indicator presenting operation 304 of FIG. 3 may be related any one or more of a variety of conditional directives 50 in various alternative implementations. For example, in some implementations, the covert indicator presenting operation 304 of FIG. 3 may include an operation 585 for presenting the covert indicator that covertly indicates the reception of the communiqué in accordance with the one or more conditional directives of the receiving user, the one or more conditional directives directing the presentation of the covert indicator upon determining that the received communiqué includes one or more representations associated with the source entity as depicted in FIG. 5g. For instance, the covert indicator presenting module 104 including the source entity associated representation inclusion determining module 246 (see FIG. 2c) of the receiving device 10 of FIGS. 1a and 1b presenting the covert indicator 54 that covertly indicates the reception of the communiqué in accordance with the one or more conditional directives 50 of the receiving user 32, the one or more conditional directives 50 directing the presentation of the covert indicator 54 upon determining (e.g., as determined by the source entity associated representation inclusion determining module 246) that the received communiqué 52 includes one or more representations (e.g., identifiers) associated with the source entity 20.

As further illustrated in FIG. 5g, operation 585 may further include one or more additional operations in various alternative implementations. For example, in some implementations, operation 585 may include an operation 586 for presenting the covert indicator that covertly indicates the reception of the communiqué in accordance with the one or more conditional directives of the receiving user, the one or more conditional directives directing the presentation of the covert indicator upon determining that the received communiqué includes one or more representations associated with the source entity in at least one of header data form, content data form, or metadata form as depicted in FIG. 5g. For instance, the covert indicator presenting module 104 including the source entity associated representation inclusion determining module 246 of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated representation inclusion determining module 246) that the received communiqué 52 includes one or more representations associated with the source entity 20 in at least one of header data form, content data form (e.g., audio data for VoIP call, alphanumeric data for email, and so forth), or metadata form.

In the same or different implementations, operation 585 may include an operation 587 for presenting the covert indicator that covertly indicates the reception of the communiqué in accordance with the one or more conditional directives of the receiving user, the one or more conditional directives directing the presentation of the covert indicator upon determining that the received communiqué includes at least one name associated with the source entity as depicted in FIG. 5g. For instance, the covert indicator presenting module 104 including the source entity associated name inclusion determining module 247 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated name inclusion determining module 247) that the received communiqué 52 includes at least one name (e.g., a legal name, a username, a website name, a business name, a nickname, and so forth) associated with the source entity 20.

In the same or different implementations, operation 585 may also include an operation 588 for presenting the covert indicator that covertly indicates the reception of the communiqué in accordance with the one or more conditional directives of the receiving user, the one or more conditional directives directing the presentation of the covert indicator upon determining that the received communiqué includes at least one address associated with the source entity as depicted in FIG. 5g. For instance, the covert indicator presenting module 104 including the source entity associated address inclusion determining module 248 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated address inclusion determining module 248) that the received communiqué 52 includes at least one address associated with the source entity 20.

In some implementations, operation 588 may further include an operation 589 for presenting the covert indicator that covertly indicates the reception of the communiqué in accordance with the one or more conditional directives of the receiving user, the one or more conditional directives directing the presentation of the covert indicator upon determining that the received communiqué includes at least one of an email address, an Internet Protocol (IP) address, or a Uniform Resource Locator (URL) associated with the source entity as depicted in FIG. 5g. For instance, the covert indicator presenting module 104 including the source entity associated address inclusion determining module 248 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining that the received communiqué 52 includes at least one of an email address, an Internet Protocol (IP) address, or a Uniform Resource Locator (URL) associated with the source entity 20.

In the same or different implementations, operation 585 may also include an operation 590 for presenting the covert indicator that covertly indicates the reception of the communiqué in accordance with the one or more conditional directives of the receiving user, the one or more conditional directives directing the presentation of the covert indicator upon determining that the received communiqué includes at least one telephone number associated with the source entity as depicted in FIG. 5h. For instance, the covert indicator presenting module 104 including the source entity associated telephone number inclusion determining module 249 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated telephone number inclusion determining module 249) that the received communiqué 52 includes at least one telephone number associated with the source entity 20.

In the same or different implementations, operation 585 may also include an operation 591 for presenting the covert indicator that covertly indicates the reception of the communiqué in accordance with the one or more conditional directives of the receiving user, the one or more conditional directives directing the presentation of the covert indicator upon determining that the received communiqué includes at least one of a numerical, textual, or symbolic identifier associated with the source entity as further depicted in FIG. 5h. For instance, the covert indicator presenting module 104 including the source entity associated identifier inclusion determining module 250 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated identifier inclusion determining module 250) that the received communiqué 52 includes at least one of a numerical (e.g., zip code), textual (e.g., slogan or motto), or symbolic (e.g., logo or icon) identifier associated with the source entity 20.

In the same or different implementations, operation 585 may also include an operation 592 for presenting the covert indicator that covertly indicates the reception of the communiqué in accordance with the one or more conditional directives of the receiving user, the one or more conditional directives directing the presentation of the covert indicator upon determining that the received communiqué includes at least one image associated with the source entity as further depicted in FIG. 5h. For instance, the covert indicator presenting module 104 including the source entity associated image inclusion determining module 251 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated image inclusion determining module 251) that the received communiqué 52 includes at least one image (e.g., digital facial image, iconic figure, and so forth) associated with the source entity 20.

In the same or different implementations, operation 585 may also include an operation 593 for presenting the covert indicator that covertly indicates the reception of the communiqué in accordance with the one or more conditional directives of the receiving user, the one or more conditional directives directing the presentation of the covert indicator upon determining that the received communiqué includes at least one voice signature associated with the source entity as further depicted in FIG. 5h. For instance, the covert indicator presenting module 104 including the source entity associated voice signature inclusion determining module 252 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated voice signature inclusion determining module 252) that the received communiqué 52 includes at least one voice signature associated with the source entity 20.

As further illustrated in FIG. 5h, the covert indicator presenting operation 304 of FIG. 3 may include an operation 594 for presenting the covert indicator that covertly indicates the reception of the communiqué in accordance with the one or more conditional directives of the receiving user, the one or more conditional directives directing the presentation of the covert indicator upon determining that the received communiqué includes one or more words or phrases identified by the one or more conditional directives as being associated with the source entity. For instance, the covert indicator presenting module 104 including the source entity associated words/phrases inclusion determining module 253 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity associated words/phrases inclusion determining module 253) that the received communiqué 52 includes one or more words or phrases (e.g., favorite saying or motto) identified by the one or more conditional directives 50 as being associated with the source entity 20.

In the same or different implementations, the covert indicator presenting operation 304 may also include an operation 595 for presenting the covert indicator that covertly indicates the reception of the communiqué in accordance with the one or more conditional directives of the receiving user, the one or more conditional directives directing the presentation of the covert indicator upon determining that the received communiqué was provided by the source entity as further depicted in FIG. 5h. For instance, the covert indicator presenting module 104 including the source entity providing determining module 254 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 upon determining (e.g., as determined by the source entity providing determining module 254) that the received communiqué 52 was provided by the source entity 20.

In the same or different implementations, the covert indicator presenting operation 304 may also include an operation 596 for presenting the covert indicator that covertly indicates the reception of the communiqué in accordance with the one or more conditional directives of the receiving user, the one or more conditional directives directing the presentation of the covert indicator as a function of location of a receiving device executing the one or more conditional directives as depicted in FIG. 5i. For instance, the covert indicator presenting module 104 including the location determining module 255 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 as a function of location (e.g., as determined by the location determining module 255) of a receiving device 10 executing the one or more conditional directives 50.

Operation 596, in turn, may further include an operation 597 for presenting the covert indicator that covertly indicates the reception of the communiqué in accordance with the one or more conditional directives of the receiving user, the one or more conditional directives directing the presentation of the covert indicator in response to determining that the receiving device is at one or more locations as specified by the one or more conditional directives as further depicted in FIG. 5i. For instance, the covert indicator presenting module 104 including the location determining module 255 of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to determining by, for example, the location determining module 255 that the receiving device 10 is at one or more locations as specified by the one or more conditional directives 50.

In the same or different implementations, the covert indicator presenting operation 304 may include an operation 598 for presenting the covert indicator that covertly indicates the reception of the communiqué in accordance with the one or more conditional directives of the receiving user, the one or more conditional directives directing the presentation of the covert indicator as a function of time of a receiving device executing the one or more conditional directives as further depicted in FIG. 5i. For instance, the covert indicator presenting module 104 including the time determining module 256 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 as a function of time of a receiving device 10 (e.g., as determined by the time determining module 256) executing the one or more conditional directives 50.

In various implementations, operation 598 may further include an operation 599 for presenting the covert indicator that covertly indicates the reception of the communiqué in accordance with the one or more conditional directives of the receiving user, the one or more conditional directives directing the presentation of the covert indicator in response to determining that the receiving device is at one or more particular times of a day as specified by the one or more conditional directives as further depicted in FIG. 5i. For instance, the covert indicator presenting module 104 including the time determining module 256 of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to the time determining module 256 determining that the receiving device 10 is at one or more particular times (e.g., between 6 and 8 AM and 6 PM and 10 PM) of a day as specified by the one or more conditional directives 50.

In some implementations, operation 598 may include an operation 600 for presenting the covert indicator that covertly indicates the reception of the communiqué in accordance with the one or more conditional directives of the receiving user, the one or more conditional directives directing the presentation of the covert indicator in response to determining that the receiving device is at one or more particular times of a calendar year as specified by the one or more conditional directives as further depicted in FIG. 5i. For instance, the covert indicator presenting module 104 including the time determining module 256 of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to the time determining module 256 determining that the receiving device 10 is at one or more particular times of a calendar year (e.g., month of January) as specified by the one or more conditional directives 50.

As further illustrated in FIG. 5i, the covert indicator presenting operation 304 of FIG. 3, in various implementations, may include an operation 601 for presenting the covert indicator that covertly indicates the reception of the communiqué in accordance with the one or more conditional directives of the receiving user, the one or more conditional directives directing the presentation of the covert indicator in response to determining occurrence of one or more specified environmental conditions associated with a receiving device executing the one or more conditional directives, the one or more specified environmental conditions being specified by the one or more conditional directives. For instance, the covert indicator presenting module 104 of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to determining occurrence of one or more specified environmental conditions associated with a receiving device 10 executing the one or more conditional directives 50, the one or more specified environmental conditions (e.g., presence or absence of one or more third parties in the proximate vicinity of the receiving device 10, whether the receiving device 10 is in a work environment or social environment, and so forth) being specified by the one or more conditional directives 50.

In some implementations, operation 601 may further include an operation 602 for presenting the covert indicator that covertly indicates the reception of the communiqué in accordance with the one or more conditional directives of the receiving user, the one or more conditional directives directing the presentation of the covert indicator in response to determining that one or more third parties are in proximate vicinity of the receiving device as further depicted in FIG. 5i. For instance, the covert indicator presenting module 104 including the third party presence determining module 257 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to determining that one or more third parties are in proximate vicinity (e.g., within 3 feet, 5 feet, 8 feet, or within any other maximum distance from the receiving device 10 from which a third party can see/hear/sense a communiqué being presented through the receiving device 10) of the receiving device 10.

In various implementations, the covert indicator presenting operation 304 of FIG. 3 may be implemented only when the receiving device 10 is determined to be not in the possession for the receiving device 10. For example, in some implementations, the covert indicator presenting operation 304 may include an operation 603 for presenting the covert indicator that covertly indicates the reception of the communiqué in accordance with the one or more conditional directives of the receiving user, the one or more conditional directives directing the presentation of the covert indicator in response to determining that a receiving device executing the one or more conditional directives is not possessed by the receiving user as depicted in FIG. 5j. For instance, the covert indicator presenting module 104 including the receiving user possession determining module 258 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to, for example, the receiving user possession determining module 258 determining that a receiving device 10 executing the one or more conditional directives 50 is not possessed (e.g., controlled) by the receiving user 32. Note that in various implementations the receiving user possession determining module 258 may be designed to determine whether the receiving user 32 has or has not possession of the receiving device 10. Such a determination may be based on a number of factors as will be described herein.

As further illustrated in FIG. 5j, operation 603 may further include one or more additional operations in various alternative implementations. For example, in various implementations, operation 603 may further include an operation 604 for presenting the covert indicator that covertly indicates the reception of the communiqué in accordance with the one or more conditional directives of the receiving user, the one or more conditional directives directing the presentation of the covert indicator in response to determining absence of a verification of the receiving user having possession of the receiving device as further illustrated in FIG. 5j. For instance, the covert indicator presenting module 104 including the receiving user possession verification determining module 259 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to determining absence of a verification (e.g., absence of verifying data or input) of the receiving user 32 having possession of the receiving device 10.

In some implementations, operation 604 may further include an operation 605 for presenting the covert indicator that covertly indicates the reception of the communiqué in accordance with the one or more conditional directives of the receiving user, the one or more conditional directives directing the presentation of the covert indicator in response to determining absence of a password verification of the receiving user having possession of the receiving device as further depicted in FIG. 5j. For instance, the covert indicator presenting module 104 including the receiving user password verification determining module 260 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to determining absence of a password verification of the receiving user 32 having possession (e.g., control) of the receiving device 10. In other words, the receiving device 10 may request that the receiving user 32 provide a particular password, which may or may not have been originally provided by the receiving user 32, in order to verify that the receiving device 10 is in the possession of the receiving user 32. If the correct password has not been provided then a determination is made that the receiving user 32 is not in the possession of the receiving device 10.

In the same or different implementations, operation 604 may also include an operation 606 for presenting the covert indicator that covertly indicates the reception of the communiqué in accordance with the one or more conditional directives of the receiving user, the one or more conditional directives directing the presentation of the covert indicator in response to determining absence of a biometric verification of the receiving user having possession of the receiving device as further depicted in FIG. 5j. For instance, the covert indicator presenting module 104 including the receiving user biometric verification determining module 261 (see FIG. 2c) of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to determining absence of a biometric verification (e.g., data provided by sensors 150) of the receiving user 32 having possession of the receiving device 10.

In some cases, operation 606 may, in turn, further include an operation 607 for presenting the covert indicator that covertly indicates the reception of the communiqué in accordance with the one or more conditional directives of the receiving user, the one or more conditional directives directing the presentation of the covert indicator in response to determining absence of at least one of a facial recognition verification, a retinal scan verification, a voice verification, or a fingerprint verification of the receiving user having possession of the receiving device as further depicted in FIG. 5j. For instance, the covert indicator presenting module 104 including the receiving user biometric verification determining module 261 of the receiving device 10 of FIGS. 1a and 1b presenting the covert indicator 54 that covertly indicates the reception of the communiqué 52 in accordance with the one or more conditional directives 50 of the receiving user 32, the one or more conditional directives 50 directing the presentation of the covert indicator 54 in response to determining absence of at least one of a facial recognition verification, a retinal scan verification, a voice verification, or a fingerprint verification of the receiving user 32 having possession of the receiving device 10.

In various implementations, the covert indicator presenting operation 304 of FIG. 3 may include an operation 608 for presenting the covert indicator that covertly indicates the reception of the communiqué in accordance with the one or more conditional directives of the receiving user, the presenting of the covert indicator being in lieu of presenting the indication of reception of the communiqué including in lieu of presenting the communiqué as further depicted in FIG. 5j. For instance, the covert indicator presenting module 104 of the receiving device 10 of FIGS. 1a and 1b presenting the covert indicator 54 that covertly indicates the reception of the communiqué 52 in accordance with the one or more conditional directives 50 of the receiving user 32, the presenting of the covert indicator 54 being in lieu of presenting the indication of reception of the communiqué 52 including in lieu of presenting the communiqué 52 itself.

In various implementations, the covert indicator presenting operation 304 of FIG. 3 may include an operation 609 for presenting the covert indicator that covertly indicates the reception of the communiqué in accordance with the one or more conditional directives of the receiving user, the presenting of the covert indicator being in lieu of presenting any direct indication of reception of the communiqué as further depicted in FIG. 5j. For instance, the covert indicator presenting module 104 of the receiving device 10 of FIGS. 1a and 1b presenting the covert indicator 54 that covertly indicates the reception of the communiqué 52 in accordance with the one or more conditional directives 50 of the receiving user 32, the presenting of the covert indicator 54 being in lieu of presenting any or all direct indications of reception of the communiqué 52. For purposes of this description, the covert indicator 54 may be presented in lieu of presenting a wide variety of direct indicators of the communiqué 52 including a telephone ring, a visual listing by subject title, sender name, and so forth related to a received communiqué 52 such as an email message, the communiqué 52 itself such as a text message or an instant message, and so forth.

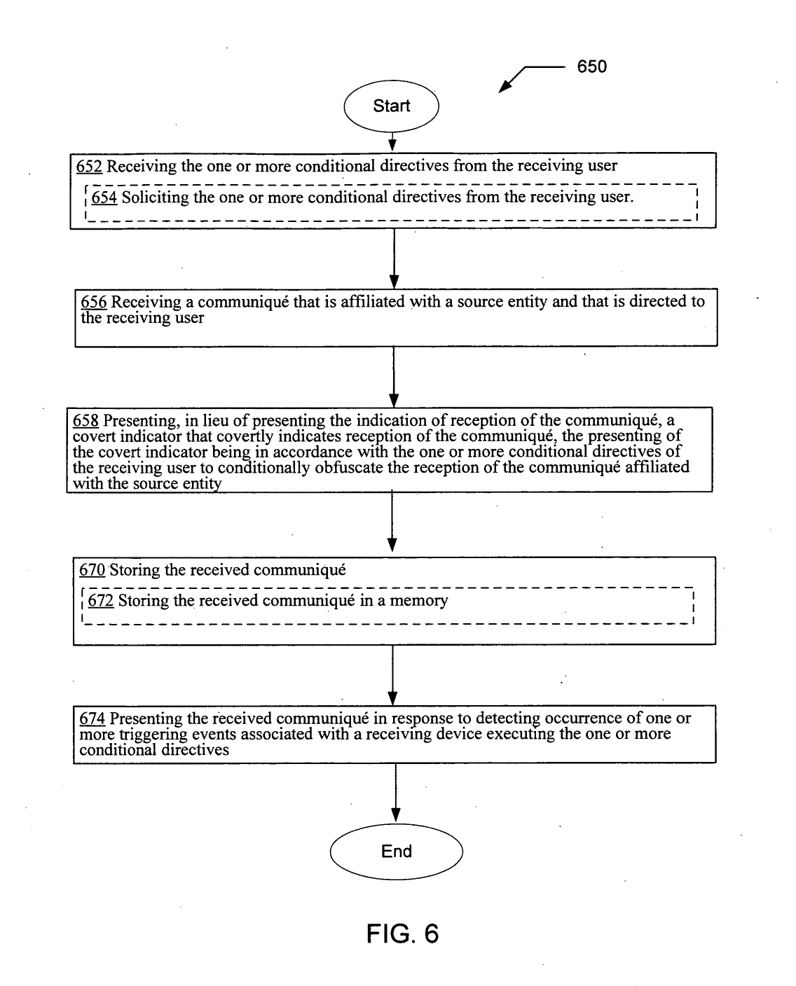

Referring to FIG. 6 illustrating another operational flow 650 in accordance with various embodiments. Operational flow 650 includes certain operations that mirror the operations included in operational flow 300 of FIG. 3. These operations include a communiqué receiving operation 656 and a covert indicator presenting operation 658 that corresponds to and mirror the communiqué receiving operation 302 and the covert indicator presenting operation 304, respectively, of FIG. 3.

In addition, operational flow 650 may include a conditional directive receiving operation 652 for receiving the one or more conditional directives from the receiving user as depicted in FIG. 6. For instance, the conditional directive receiving module 106 of the receiving device 10 receiving (e.g., via the user interface 120 including a microphone, a keypad or keyboard, a mouse, a touchscreen, and/or other hardware devices) the one or more conditional directives 50 from the receiving user 32.

In some cases, the conditional directive receiving operation 652 may include an operation 654 for soliciting the one or more conditional directives from the receiving user as further depicted in FIG. 6. For instance, the conditional directive soliciting module 107 (see FIG. 2d) of the receiving device 10 of FIGS. 1a and 1b soliciting the one or more conditional directives 50 from the receiving user 32. Such a solicitation may be made through a display system 121 (e.g., display monitor, touchscreen, keyboard, keypad, mouse, and so forth) and/or an audio system (e.g., one or more speakers, microphone, and so forth) by visually and/or audioally requesting the receiving user 32 to at least indicate conditions for presenting a covert indicator 54 in lieu of presenting a received communiqué 52 (e.g., as received by the receiving device 10) that is affiliated with a source entity 20 and directed to the receiving user 32.

In some cases, operational flow 650 may include a communiqué storing operation 670 for storing the received communiqué and a communiqué presenting operation 674 for presenting the received communiqué in response to detecting occurrence of one or more triggering events associated with a receiving device executing the one or more conditional directives as further illustrated in FIG. 6. For instance, the communiqué storing module 108 and the communiqué presenting module 110 of the receiving device 10 of FIGS. 1a and 1b storing the received communiqué 52 and presenting the received communiqué 52 in response to detecting occurrence of one or more triggering events associated with a receiving device 10 executing the one or more conditional directives 50, respectively.

In some cases, the communiqué storing operation 670 of FIG. 6 may further include an operation 672 for storing the received communiqué in a memory as further depicted in FIG. 6. For instance, the communiqué storing module 108 of the receiving device 10 of FIGS. 1a and 1b storing (e.g., saving) the received communiqué 52 in a memory 140, which may be any one or more of a variety of memory types including volatile and/or non-volatile memory such as, for example, a flash memory, a static random access memory (SRAM), a dynamic random access memory (DRAM), an electrically erasable programmable read only memory (EEPROM), and/or other types of storage devices.

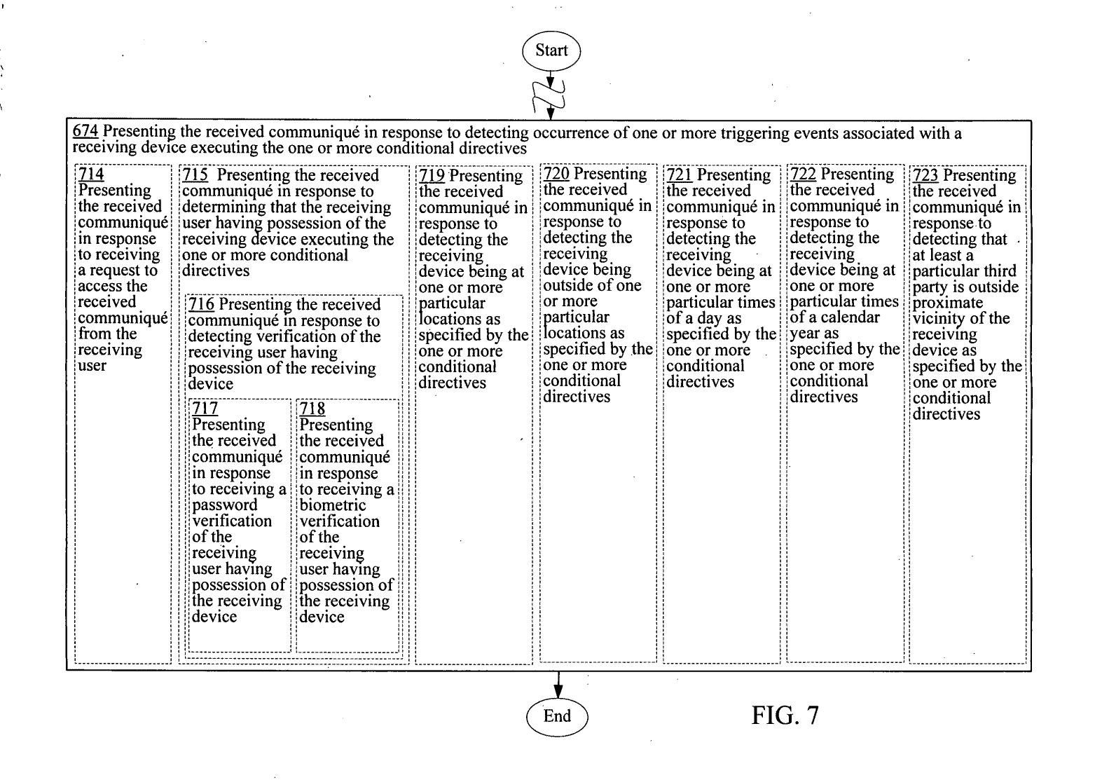

As further illustrated in FIG. 7, the communiqué presenting operation 674 of FIG. 6 may be implemented in a number of different ways in various alternative implementations. For example, in some implementations, the communiqué presenting operation 674 may include an operation 714 for presenting the received communiqué in response to receiving a request to access the received communiqué from the receiving user as depicted in FIG. 7. For instance, the communiqué presenting module 110 of the receiving device 10 of FIGS. 1a and 1b presenting (audioally and/or visually presenting) the received communiqué 52 in response to receiving a request (e.g., via user interface 120) to access the received communiqué 52 from the receiving user 32.

In the same or different implementations, the communiqué presenting operation 674 may include an operation 715 for presenting the received communiqué in response to determining that the receiving user having possession of the receiving device executing the one or more conditional directives as further depicted in FIG. 7. For instance, the communiqué presenting module 110 including the receiving user possession determining module 270 (see FIG. 2e) of the receiving device 10 of FIGS. 1a and 1b presenting the received communiqué 52 in response to, for example, the receiving user possession determining module 270 determining that the receiving user 32 having possession of the receiving device 10 executing the one or more conditional directives 50.

In some cases, operation 715 may further include an operation 716 for presenting the received communiqué in response to detecting verification of the receiving user having possession of the receiving device as further depicted in FIG. 7. For instance, the communiqué presenting module 110 including the receiving user possession verification detecting module 271 (see FIG. 2e) of the receiving device 10 of FIGS. 1a and 1b presenting the received communiqué 52 in response to, for example, the receiving user possession verification detecting module 271 detecting verification of the receiving user 32 having possession of the receiving device 10.

Operation 716, in turn, may further include one or more additional operations in various implementations. For example, in some implementations, operation 716 may include an operation 717 for presenting the received communiqué in response to receiving a password verification of the receiving user having possession of the receiving device as further depicted in FIG. 7. For instance, the communiqué presenting module 110 including the password verification receiving module 272 (see FIG. 2e) of the receiving device 10 of FIGS. 1a and 1b presenting the received communiqué 52 in response to, for example, the password verification receiving module 272 receiving a password verification of the receiving user 32 having possession of the receiving device 10. Such password verification may be provided through, for example, a microphone, a keypad, a keyboard, a mouse, a touchscreen and/or other hardware devices designed to receive data from an end user.

In the same or different implementations, operation 716 may include an operation 718 for presenting the received communiqué in response to receiving a biometric verification of the receiving user having possession of the receiving device as further depicted in FIG. 7. For instance, the communiqué presenting module 110 including the biometric verification receiving module 273 (see FIG. 2e) of the receiving device 10 of FIGS. 1a and 1b presenting the received communiqué 52 in response to, for example, the biometric verification receiving module 273 receiving a biometric verification (e.g., a facial recognition verification, a retinal scan verification, a voice verification, or a fingerprint verification of the receiving user 32 having possession of the receiving device 10) of the receiving user 32 having possession of the receiving device 10.

In the same or different implementations, the communiqué presenting operation 674 may include an operation 719 for presenting the received communiqué in response to detecting the receiving device being at one or more particular locations as specified by the one or more conditional directives as further depicted in FIG. 7: For instance, the communiqué presenting module 110 of the receiving device 10 of FIGS. 1a and 1b presenting the received communiqué 52 in response to detecting (e.g., as detected by a GPS 151) the receiving device 10 being at one or more particular locations as specified by the one or more conditional directives 50.

In the same or different implementations, the communiqué presenting operation 674 may include an operation 720 for presenting the received communiqué in response to detecting the receiving device being outside of one or more particular locations as specified by the one or more conditional directives as further depicted in FIG. 7. For instance, the communiqué presenting module 110 of the receiving device 10 of FIGS. 1a and 1b presenting the received communiqué in response to detecting (e.g., as detected by a GPS 151) the receiving device 10 being outside of one or more particular locations as specified by the one or more conditional directives 50.

In the same or different implementations, the communiqué presenting operation 674 may include an operation 721 for presenting the received communiqué in response to detecting the receiving device being at one or more particular times of a day as specified by the one or more conditional directives as further depicted in FIG. 7. For instance, the communiqué presenting module 110 of the receiving device 10 of FIGS. 1a and 1b presenting the received communiqué 52 in response to detecting the receiving device 10 being at one or more particular times of a day as specified by the one or more conditional directives 50.

In the same or different implementations, the communiqué presenting operation 674 may include an operation 722 for presenting the received communiqué in response to detecting the receiving device being at one or more particular times of a calendar year as specified by the one or more conditional directives as further depicted in FIG. 7. For instance, the communiqué presenting module 110 of the receiving device 10 of FIGS. 1a and 1b presenting the received communiqué 52 in response to detecting the receiving device 10 being at one or more particular times of a calendar year as specified by the one or more conditional directives 50.

In the same or different implementations, the communiqué presenting operation 674 may include an operation 723 for presenting the received communiqué in response to detecting that at least a particular third party is outside proximate vicinity of the receiving device as specified by the one or more conditional directives as further depicted in FIG. 7. For instance, the communiqué presenting module 110 of the receiving device 10 of FIGS. 1a and 1b presenting the received communiqué 52 in response to detecting that at least a particular third party is outside proximate vicinity (e.g., outside of 3 feet, 5 feet, 8 feet, or outside any other maximum distance from the receiving device 10 from which a third party can see/hear/sense a communiqué being presented through the receiving device 10) of the receiving device 10 as specified by the one or more conditional directives 50.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts; and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1.-123. (canceled)

124. A computationally-implemented system, comprising:
means for receiving a communiqué that is affiliated with a source entity and that is directed to a receiving user and
means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity.

125. (canceled)

126. The computationally-implemented system of claim 124, wherein said means for receiving a communiqué that is affiliated with a source entity and that is directed to a receiving user comprises:
means for intercepting the communiqué in accordance with the one or more conditional directives to prevent indication of reception of the communiqué from being at least initially presented.

127.-140. (canceled)

141. The computationally-implemented system of claim 126, wherein said means for intercepting the communiqué in accordance with the one or more conditional directives to prevent indication of reception of the communiqué from being at least initially presented comprises:
means for intercepting the communiqué in accordance with the one or more conditional directives by intercepting the communiqué as a function of location of a receiving device executing the one or more conditional directives.

142. The computationally-implemented system of claim 141, wherein said means for intercepting the communiqué in accordance with the one or more conditional directives by intercepting the communiqué as a function of location of a receiving device executing the one or more conditional directives comprises:
means for intercepting the communiqué in accordance with the one or more conditional directives by intercepting the communiqué in response to determining that the receiving device is at one or more specified locations.

143. The computationally-implemented system of claim 126, wherein said means for intercepting the communiqué in accordance with the one or more conditional directives to prevent indication of reception of the communiqué from being at least initially presented comprises:
means for intercepting the communiqué in accordance with the one or more conditional directives by intercepting the communiqué as a function of time with respect to a receiving device executing the one or more conditional directives.

144. The computationally-implemented system of claim 143, wherein said means for intercepting the communiqué in accordance with the one or more conditional directives by intercepting the communiqué as a function of time with respect to a receiving device executing the one or more conditional directives comprises:
means for intercepting the communiqué in accordance with the one or more conditional directives by intercepting the communiqué only at one or more specified times of a day with respect to the receiving device.

145. The computationally-implemented system of claim 143, wherein said means for intercepting the communiqué in accordance with the one or more conditional directives by intercepting the communiqué as a function of time with respect to a receiving device executing the one or more conditional directives comprises:
means for intercepting the communiqué in accordance with the one or more conditional directives by intercepting the communiqué only at one or more specified times of a calendar year with respect to the receiving device.

146. The computationally-implemented system of claim 126, wherein said means for intercepting the communiqué in accordance with the one or more conditional directives to prevent indication of reception of the communiqué from being at least initially presented comprises:
means for intercepting the communiqué in accordance with the one or more conditional directives by intercepting the communiqué as a function of one or more environmental conditions of a receiving device executing the one or more conditional directives.

147. The computationally-implemented system of claim 146, wherein said means for intercepting the communiqué in accordance with the one or more conditional directives by intercepting the communiqué as a function of one or more environmental conditions of a receiving device executing the one or more conditional directives comprises:
means for intercepting the communiqué in accordance with the one or more conditional directives by intercepting the communiqué in response to determining presence of a third party within proximate vicinity of the receiving device.

148.-172. (canceled)

173. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates reception of the communiqué in lieu of presenting the indication of the reception of the communiqué by presenting an indicator that indirectly indicates the reception of the communiqué, the indicator to be presented being defined by the one or more conditional directives of the receiving user.

174. The computationally-implemented system of claim 173, wherein said means for presenting the covert indicator that covertly indicates reception of the communiqué in lieu of presenting the indication of the reception of the communiqué by presenting an indicator that indirectly indicates the reception of the communiqué, the indicator to be presented being defined by the one or more conditional directives of the receiving user comprises:
means for presenting the indicator that indirectly indicates the reception of the communiqué by presenting a covert audio indicator that audioally indirectly indicates the reception of the communiqué, the covert audio indicator to be presented being defined by the one or more conditional directives of the receiving user.

175. The computationally-implemented system of claim 174, wherein said means for presenting the indicator that indirectly indicates the reception of the communiqué by presenting a covert audio indicator that audioally indirectly indicates the reception of the communiqué, the covert audio indicator to be presented being defined by the one or more conditional directives of the receiving user comprises:
means for presenting the covert audio indicator by presenting audioally at least a ping, a ring, or a hum that indirectly indicates the reception of the communiqué, the at least a ping, a ring, or a hum to be audioally presented being defined by the one or more conditional directives.

176. The computationally-implemented system of claim 174, wherein said means for presenting the indicator that indirectly indicates the reception of the communiqué by presenting a covert audio indicator that audioally indirectly indicates the reception of the communiqué, the covert audio indicator to be presented being defined by the one or more conditional directives of the receiving user comprises:
means for presenting the covert audio indicator by presenting audioally at least one or more simulated natural background noises that indirectly indicates the reception of the communiqué, the at least one or more simulated natural background noises to be audioally presented being in accordance with the one or more conditional directives of the receiving user.

177. The computationally-implemented system of claim 174, wherein said means for presenting the indicator that indirectly indicates the reception of the communiqué by presenting a covert audio indicator that audioally indirectly indicates the reception of the communiqué, the covert audio indicator to be presented being defined by the one or more conditional directives of the receiving user comprises:
means for presenting the covert audio indicator by presenting audioally at least one voice message that indirectly indicates the reception of the communiqué, the at least one voice message to be audioally presented being in accordance with the one or more conditional directives of the receiving user.

178. (canceled)

179. The computationally-implemented system of claim 177, wherein said means for presenting the covert audio indicator by presenting audioally at least one voice message that indirectly indicates the reception of the communiqué, the at least one voice message to be audioally presented being in accordance with the one or more conditional directives of the receiving user comprises:
means for presenting audioally the at least one voice message that indirectly indicates the reception of the communiqué by presenting audioally at least one voice message in a particular tone or speech pattern that indirectly indicates the reception of the communiqué, the particular tone or speech pattern of the at least one voice message to be audioally presented being in accordance with the one or more conditional directives of the receiving user.

180. (canceled)

181. The computationally-implemented system of claim 177, wherein said means for presenting the covert audio indicator by presenting audioally at least one voice message that indirectly indicates the reception of the communiqué, the at least one voice message to be audioally presented being in accordance with the one or more conditional directives of the receiving user comprises:
means for presenting audioally the at least one voice message that indirectly indicates the reception of the communiqué by presenting a modified version of a voice message that was previously presented and that has been modified to include a covert audio indicator that indirectly indicates the reception of the communiqué.

182. The computationally-implemented system of claim 173, wherein said means for presenting the covert indicator that covertly indicates reception of the communiqué in lieu of presenting the indication of the reception of the communiqué by presenting an indicator that indirectly indicates the reception of the communiqué, the indicator to be presented being defined by the one or more conditional directives of the receiving user comprises:
means for presenting the indicator that indirectly indicates the reception of the communiqué by presenting a covert visual indicator that visually indirectly indicates the reception of the communiqué, the covert visual indicator to be presented being defined by the one or more conditional directives of the receiving user.

183. (canceled)

184. The computationally-implemented system of claim 182, wherein said means for presenting the indicator that indirectly indicates the reception of the communiqué by presenting a covert visual indicator that visually indirectly indicates the reception of the communiqué, the covert visual indicator to be presented being defined by the one or more conditional directives of the receiving user comprises:
means for presenting the covert visual indicator by presenting visually one or more particular colors that indirectly indicates the reception of the communiqué, the one or more particular colors to be visually presented being in accordance with the one or more conditional directives of the receiving user.

185. The computationally-implemented system of claim 182, wherein said means for presenting the indicator that indirectly indicates the reception of the communiqué by presenting a covert visual indicator that visually indirectly indicates the reception of the communiqué, the covert visual indicator to be presented being defined by the one or more conditional directives of the receiving user comprises:
means for presenting the covert visual indicator by presenting visually at least one visual message that indirectly indicates the reception of the communiqué, the at least one visual message to be visually presented being in accordance with the one or more conditional directives of the receiving user.

186. (canceled)

187. The computationally-implemented system of claim 185, wherein said means for presenting the covert visual indicator by presenting visually at least one visual message that indirectly indicates the reception of the communiqué, the at least one visual message to be visually presented being in accordance with the one or more conditional directives of the receiving user comprises:
means for presenting visually the at least one visual message by presenting visually at least one visual message that includes one or more words or phrases in a particular font or style that indirectly indicates the reception of the communiqué, the one or more words or phrases to be visually presented in a particular font or style being in accordance with the one or more conditional directives of the receiving user.

188. The computationally-implemented system of claim 185, wherein said means for presenting the covert visual indicator by presenting visually at least one visual message that indirectly indicates the reception of the communiqué, the at least one visual message to be visually presented being in accordance with the one or more conditional directives of the receiving user comprises:
means for presenting visually the at least one visual message by presenting visually a fictional visual message that indirectly indicates reception of the communiqué and that is presented in accordance with the one or more conditional directives of the receiving user or by presenting visually a modified version of a visual message that was previously presented and that has been modified to include the covert visual indicator that indirectly indicates the reception of the communiqué.

189. The computationally-implemented system of claim 173, wherein said means for presenting the covert indicator that covertly indicates reception of the communiqué in lieu of presenting the indication of the reception of the communiqué by presenting an indicator that indirectly indicates the reception of the communiqué, the indicator to be presented being defined by the one or more conditional directives of the receiving user comprises:
means for presenting the indicator that indirectly indicates the reception of the communiqué by presenting a covert vibrating indicator that indicates, via a specific vibration, the reception of the communiqué, the specific vibration to be presented being in accordance with the one or more conditional directives of the receiving user.

190.-191. (canceled)

192. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates the reception of the communiqué by presenting a graphical user interface that includes the covert indicator.

193. The computationally-implemented system of claim 192, wherein said means for presenting the covert indicator that covertly indicates the reception of the communiqué by presenting a graphical user interface that includes the covert indicator comprises:
means for presenting the graphical user interface that includes the covert indicator by presenting a modified version of an original graphical user interface that was previously presented, the modified version of the original graphical user interface to be presented including the covert indicator.

194. The computationally-implemented system of claim 193, wherein said means for presenting the graphical user interface that includes the covert indicator by presenting a modified version of an original graphical user interface that was previously presented, the modified version of the original graphical user interface to be presented including the covert indicator comprises:
means for presenting the modified version of the original graphical user interface that was previously presented by modifying the original graphical user interface that was previously presented to include the covert indicator.

195. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates reception of the communiqué by presenting a communiqué application interface that includes an indicator that indirectly indicates the reception of the communiqué, the indicator to be included in the communiqué application interface being defined by the one or more conditional directives of the receiving user.

196. The computationally-implemented system of claim 195, wherein said means for presenting the covert indicator that covertly indicates reception of the communiqué by presenting a communiqué application interface that includes an indicator that indirectly indicates the reception of the communiqué, the indicator to be included in the communiqué application interface being defined by the one or more conditional directives of the receiving user comprises:
means for presenting the communiqué application interface that includes the indicator that indirectly indicates the reception of the communiqué by presenting a modified communiqué application interface that is a modified version of an original communiqué application interface that was previously presented and modified to include the indicator that indirectly indicates the reception of the communiqué.

197. The computationally-implemented system of claim 196, wherein said means for presenting the communiqué application interface that includes the indicator that indirectly indicates the reception of the communiqué by presenting a modified communiqué application interface that is a modified version of an original communiqué application interface that was previously presented and modified to include the indicator that indirectly indicates the reception of the communiqué comprises:
means for modifying the original communiqué application interface that was previously presented to include the indicator that indirectly indicates the reception of the communiqué.

198.-218. (canceled)

219. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates the reception of the communiqué in accordance with the one or more conditional directives of the receiving user, the one or more conditional directives directing the presentation of the covert indicator as a function of location of a receiving device executing the one or more conditional directives.

220. The computationally-implemented system of claim 219, wherein said means for presenting the covert indicator that covertly indicates the reception of the communiqué in accordance with the one or more conditional directives of the receiving user, the one or more conditional directives directing the presentation of the covert indicator as a function of location of a receiving device executing the one or more conditional directives comprises:
means for presenting the covert indicator that covertly indicates the reception of the communiqué in accordance with the one or more conditional directives of the receiving user, the one or more conditional directives directing the presentation of the covert indicator in response to determining that the receiving device is at one or more locations as specified by the one or more conditional directives.

221. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates the reception of the communiqué in accordance with the one or more conditional directives of the receiving user, the one or more conditional directives directing the presentation of the covert indicator as a function of time of a receiving device executing the one or more conditional directives.

222. The computationally-implemented system of claim 221, wherein said means for presenting the covert indicator that covertly indicates the reception of the communiqué in accordance with the one or more conditional directives of the receiving user, the one or more conditional directives directing the presentation of the covert indicator as a function of time of a receiving device executing the one or more conditional directives comprises:
means for presenting the covert indicator that covertly indicates the reception of the communiqué in accordance with the one or more conditional directives of the receiving user, the one or more conditional directives directing the presentation of the covert indicator in response to determining that the receiving device is at one or more particular times of a day as specified by the one or more conditional directives.

223. The computationally-implemented system of claim 221, wherein said means for presenting the covert indicator that covertly indicates the reception of the communiqué in accordance with the one or more conditional directives of the receiving user, the one or more conditional directives directing the presentation of the covert indicator as a function of time of a receiving device executing the one or more conditional directives comprises:
means for presenting the covert indicator that covertly indicates the reception of the communiqué in accordance with the one or more conditional directives of the receiving user, the one or more conditional directives directing the presentation of the covert indicator in response to determining that the receiving device is at one or more particular times of a calendar year as specified by the one or more conditional directives.

224. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates the reception of the communiqué in accordance with the one or more conditional directives of the receiving user, the one or more conditional directives directing the presentation of the covert indicator in response to determining occurrence of one or more specified environmental conditions associated with a receiving device executing the one or more conditional directives, the one or more specified environmental conditions being specified by the one or more conditional directives.

225. The computationally-implemented system of claim 224, wherein said means for presenting the covert indicator that covertly indicates the reception of the communiqué in accordance with the one or more conditional directives of the receiving user, the one or more conditional directives directing the presentation of the covert indicator in response to determining occurrence of one or more specified environmental conditions associated with a receiving device executing the one or more conditional directives, the one or more specified environmental conditions being specified by the one or more conditional directives comprises:
means for presenting the covert indicator that covertly indicates the reception of the communiqué in accordance with the one or more conditional directives of the receiving user, the one or more conditional directives directing the presentation of the covert indicator in response to determining that one or more third parties are in proximate vicinity of the receiving device.

226.-230. (canceled)

231. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates the reception of the communiqué in accordance with the one or more conditional directives of the receiving user, the presenting of the covert indicator being in lieu of presenting the indication of reception of the communiqué including in lieu of presenting the communiqué.

232. The computationally-implemented system of claim 124, wherein said means for presenting, in lieu of presenting indication of reception of the communiqué, a covert indicator that covertly indicates reception of the communiqué, the presenting of the covert indicator being in accordance with one or more conditional directives of the receiving user to conditionally obfuscate the reception of the communiqué affiliated with the source entity comprises:
means for presenting the covert indicator that covertly indicates the reception of the communiqué in accordance with the one or more conditional directives of the receiving user, the presenting of the covert indicator being in lieu of presenting any direct indication of reception of the communiqué.

233. The computationally-implemented system of claim 124, further comprising:
means for receiving the one or more conditional directives from the receiving user.

234. The computationally-implemented system of claim 233, wherein said means for receiving the one or more conditional directives from the receiving user comprises:
means for soliciting the one or more conditional directives from the receiving user.

235. The computationally-implemented system of claim 124, further comprising:
means for storing the received communiqué; and
means for presenting the received communiqué in response to detecting occurrence of one or more triggering events associated with a receiving device executing the one or more conditional directives.

236.-241. (canceled)

242. The computationally-implemented system of claim 235, wherein said means for presenting the received communiqué in response to detecting occurrence of one or more triggering events associated with a receiving device executing the one or more conditional directives comprises:
means for presenting the received communiqué in response to detecting the receiving device being at one or more particular locations as specified by the one or more conditional directives.

243. The computationally-implemented system of claim 235, wherein said means for presenting the received communiqué in response to detecting occurrence of one or more triggering events associated with a receiving device executing the one or more conditional directives comprises:
means for presenting the received communiqué in response to detecting the receiving device being outside of one or more particular locations as specified by the one or more conditional directives.

244. The computationally-implemented system of claim 235, wherein said means for presenting the received communiqué in response to detecting occurrence of one or more triggering events associated with a receiving device executing the one or more conditional directives comprises:
means for presenting the received communiqué in response to detecting the receiving device being at one or more particular times of a day as specified by the one or more conditional directives.

245. The computationally-implemented system of claim 235, wherein said means for presenting the received communiqué in response to detecting occurrence of one or more triggering events associated with a receiving device executing the one or more conditional directives comprises:
means for presenting the received communiqué in response to detecting the receiving device being at one or more particular times of a calendar year as specified by the one or more conditional directives.

246. The computationally-implemented system of claim 235, wherein said means for presenting the received communiqué in response to detecting occurrence of one or more triggering events associated with a receiving device executing the one or more conditional directives comprises:
means for presenting the received communiqué in response to detecting that at least a particular third party is outside proximate vicinity of the receiving device as specified by the one or more conditional directives.

247.-248. (canceled)

249. A method for obfuscating reception of a communiqué, comprising:
receiving a communiqué that is affiliated with a source entity and that is directed to a receiving user; and
presenting, by a network communication device, a covert indicator that covertly indicates reception of the communiqué, the presenting of the covert indicator being in accordance with one or more conditional directives of the receiving user to conditionally obfuscate the reception of the communiqué affiliated with the source entity, the presenting of the covert indicator being in lieu of presenting indication of the reception of the communiqué.
